(19) United States
(12) Patent Application Publication
(10) Pub. No.: US 2023/0135179 A1
(43) Pub. Date: May 4, 2023

(54) Systems and Methods for Implementing Smart Assistant Systems

(71) Applicant: Meta Platforms, Inc., Menlo Park, CA (US)

(72) Inventors: Sebastian Jonathan Mielke, Baltimore, MD (US); Arthur David Szlam, New York, NY (US); Emily Dinan, Brooklyn, NY (US); Y-Lan Boureau, New York, NY (US); Mokhtar Mohamed Khorshid, Kirkland, WA (US); Jeremy Dohmann, Somerville, MA (US); Brian Moran, Seattle, WA (US); Lintao Cui, Medina, WA (US); Jonathan Richard Goetz, San Mateo, CA (US); Ahmed Kamal Atwa Mohamed, Redmond, WA (US); Paul Anthony Crook, Newcastle, WA (US); Andrea Madotto, San Francisco, CA (US); Shrey Desai, Jersey City, NJ (US); Alexander Kolmykov-Zotov, Sammamish, WA (US); Jason Pazis, Bellevue, WA (US); Zhaojun Yang, Bellevue, WA (US); Haichuan Yang, Sunnyvale, CA (US); Yangyang Shi, Bellevue, WA (US); Biqiao Zhang, Redmond, WA (US); Ivaylo Enchev, Redmond, WA (US); Xin Lei, Bellevue, WA (US); Ming Sun, Seattle, WA (US)

(21) Appl. No.: 17/938,561

(22) Filed: Oct. 6, 2022

Related U.S. Application Data
(60) Provisional application No. 63/270,478, filed on Oct. 21, 2021.
(60) Provisional application No. 63/333,408, filed on Apr. 21, 2022.
(60) Provisional application No. 63/399,909, filed on Aug. 22, 2022.
(60) Provisional application No. 63/400,149, filed on Aug. 23, 2022.
(60) Provisional application No. 63/406,871, filed on Sep. 15, 2022.

(51) Int. Cl. G10L 15/22; G10L 15/06; G10L 15/18; G10L 15/30; G10L 15/16

(52) U.S. Cl. CPC G10L 15/22; G10L 15/063; G10L 15/1815; G10L 15/30; G10L 15/16; G10L 2015/088

(57) ABSTRACT

In one embodiment, a system includes an automatic speech recognition (ASR) module, a natural-language understanding (NLU) module, a dialog manager, one or more agents, an arbitrator, a delivery system, one or more processors, and a non-transitory memory coupled to the processors comprising instructions executable by the processors, the processors operable when executing the instructions to receive a user input, process the user input using the ASR module, the NLU module, the dialog manager, one or more of the agents, the arbitrator, and the delivery system, and provide a response to the user input.

### PRIORITY

This application claims the benefit under 35 U.S.C. § 119(e) of U.S. Provisional Patent Application No. 63/270,478, filed 21 Oct. 2021, U.S. Provisional Patent Application No. 63/333,408, filed 21 Apr. 2022, U.S. Provisional Patent Application No. 63/399,909, filed 22 Aug. 2022, U.S. Provisional Patent Application No. 63/400,149, filed 23 Aug. 2022, and U.S. Provisional Patent Application No. 63/406,871, filed 15 Sep. 2022, each of which is incorporated herein by reference.

### TECHNICAL FIELD

This disclosure generally relates to databases and file management within network environments, and in particular relates to hardware and software for smart assistant systems.

### BACKGROUND

An assistant system can provide information or services on behalf of a user based on a combination of user input, location awareness, and the ability to access information from a variety of online sources (such as weather conditions, traffic congestion, news, stock prices, user schedules, retail prices, etc.). The user input may include text (e.g., online chat), especially in an instant messaging application or other applications, voice, images, motion, or a combination of them. The assistant system may perform concierge-type services (e.g., making dinner reservations, purchasing event tickets, making travel arrangements) or provide information based on the user input. The assistant system may also perform management or data-handling tasks based on online information and events without user initiation or interaction. Examples of those tasks that may be performed by an assistant system may include schedule management (e.g., sending an alert to a dinner date that a user is running late due to traffic conditions, update schedules for both parties, and change the restaurant reservation time). The assistant system may be enabled by the combination of computing devices, application programming interfaces (APIs), and the proliferation of applications on user devices.

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. profile/news feed posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### SUMMARY OF PARTICULAR EMBODIMENTS

In particular embodiments, the assistant system may assist a user to obtain information or services. The assistant system may enable the user to interact with the assistant system via user inputs of various modalities (e.g., audio, voice, text, image, video, gesture, motion, location, orientation) in stateful and multi-turn conversations to receive assistance from the assistant system. As an example and not by way of limitation, the assistant system may support mono-modal inputs (e.g., only voice inputs), multi-modal inputs (e.g., voice inputs and text inputs), hybrid/multi-modal inputs, or any combination thereof. User inputs provided by a user may be associated with particular assistant-related tasks, and may include, for example, user requests (e.g., verbal requests for information or performance of an action), user interactions with an assistant application associated with the assistant system (e.g., selection of UI elements via touch or gesture), or any other type of suitable user input that may be detected and understood by the assistant system (e.g., user movements detected by the client device of the user). The assistant system may create and store a user profile comprising both personal and contextual information associated with the user. In particular embodiments, the assistant system may analyze the user input using natural-language understanding (NLU). The analysis may be based on the user profile of the user for more personalized and context-aware understanding. The assistant system may resolve entities associated with the user input based on the analysis. In particular embodiments, the assistant system may interact with different agents to obtain information or services that are associated with the resolved entities. The assistant system may generate a response for the user regarding the information or services by using natural-language generation (NLG). Through the interaction with the user, the assistant system may use dialog-management techniques to manage and advance the conversation flow with the user. In particular embodiments, the assistant system may further assist the user to effectively and efficiently digest the obtained information by summarizing the information. The assistant system may also assist the user to be more engaging with an online social network by providing tools that help the user interact with the online social network (e.g., creating posts, comments, messages). The assistant system may additionally assist the user to manage different tasks such as keeping track of events. In particular embodiments, the assistant system may proactively execute, without a user input, tasks that are relevant to user interests and preferences based on the user profile, at a time relevant for the user. In particular embodiments, the assistant system may check privacy settings to ensure that accessing a user's profile or other user information and executing different tasks are permitted subject to the user's privacy settings.

In particular embodiments, the assistant system may assist the user via a hybrid architecture built upon both client-side processes and server-side processes. The client-side processes and the server-side processes may be two parallel workflows for processing a user input and providing assistance to the user. In particular embodiments, the client-side processes may be performed locally on a client system associated with a user. By contrast, the server-side processes may be performed remotely on one or more computing systems. In particular embodiments, an arbitrator on the client system may coordinate receiving user input (e.g., an audio signal), determine whether to use a client-side process, a server-side process, or both, to respond to the user input, and analyze the processing results from each process. The arbitrator may instruct agents on the client-side or server-side to execute tasks associated with the user input based on the aforementioned analyses. The execution results may be further rendered as output to the client system. By leveraging both client-side and server-side processes, the assistant system can effectively assist a user with optimal usage of computing resources while at the same time protecting user privacy and enhancing security.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with an assistant system.

FIG. 2 illustrates an example architecture of the assistant system.

FIG. 3 illustrates an example flow diagram of the assistant system.

FIG. 4 illustrates an example task-centric flow diagram of processing a user input.

FIG. 5 illustrates an example pipeline for re-calibrating a generative dialogue agent.

FIG. 6 illustrates example calibrator performance.

FIG. 7 illustrates example average correctness for both the vanilla chat-bot and the calibrator-controlled chatbot, grouped by their respective certainty as annotated by humans.

FIG. 8 illustrates example human-written example answers in the GUI that is presented to human annotators.

FIG. 9 illustrates an example process of domain development.

FIG. 10 illustrates an example process for training an NLU model.

FIG. 11 illustrates an example process for understanding and fulfillment.

FIG. 12 illustrates an example sampling for language-model prompting.

FIG. 13 illustrates an example architecture of the hybrid E2E model.

FIG. 14 illustrates an example diagram comparison between the hybrid E2E model and MBD.

FIG. 15 illustrates an example architecture of the hybrid E2E model.

FIG. 16 illustrates an example architecture of the NLU tower.

FIG. 17 illustrates an example overlapping of two consecutive audio windows.

FIG. 18 illustrates an example comparison between stateless and stateful convolution.

FIG. 19 illustrates an example stateful model architecture based on mobilenet_v2 backbone.

FIG. 20 illustrates an example runtime optimization on DSP.

FIG. 21 illustrates example changes in model design.

FIG. 22 illustrates an example DET curve of the prod model and the stateful model.

FIG. 23 illustrates an example social graph.

FIG. 24 illustrates an example view of an embedding space.

FIG. 25 illustrates an example artificial neural network.

FIG. 26 illustrates an example computer system.

### DESCRIPTION OF EXAMPLE EMBODIMENTS

### System Overview

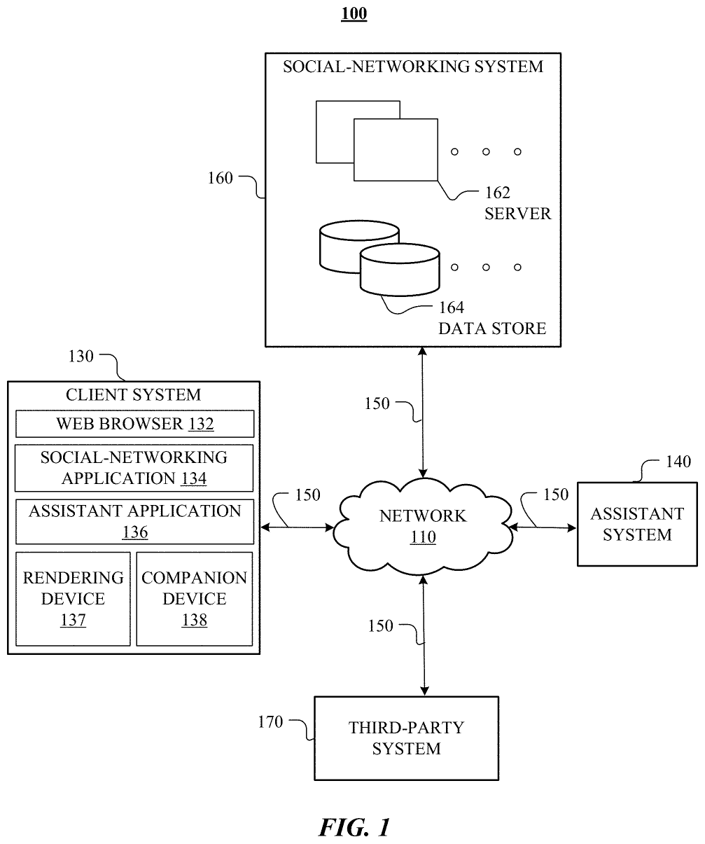

FIG. 1 illustrates an example network environment 100 associated with an assistant system. Network environment 100 includes a client system 130, an assistant system 140, a social-networking system 160, and a third-party system 170 connected to each other by a network 110. Although FIG. 1 illustrates a particular arrangement of a client system 130, an assistant system 140, a social-networking system 160, a third-party system 170, and a network 110, this disclosure contemplates any suitable arrangement of a client system 130, an assistant system 140, a social-networking system 160, a third-party system 170, and a network 110. As an example and not by way of limitation, two or more of a client system 130, a social-networking system 160, an assistant system 140, and a third-party system 170 may be connected to each other directly, bypassing a network 110. As another example, two or more of a client system 130, an assistant system 140, a social-networking system 160, and a third-party system 170 may be physically or logically co-located with each other in whole or in part. Moreover, although FIG. 1 illustrates a particular number of client systems 130, assistant systems 140, social-networking systems 160, third-party systems 170, and networks 110, this disclosure contemplates any suitable number of client systems 130, assistant systems 140, social-networking systems 160, third-party systems 170, and networks 110. As an example and not by way of limitation, network environment 100 may include multiple client systems 130, assistant systems 140, social-networking systems 160, third-party systems 170, and networks 110.

This disclosure contemplates any suitable network 110. As an example and not by way of limitation, one or more portions of a network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular technology-based network, a satellite communications technology-based network, another network 110, or a combination of two or more such networks 110.

Links 150 may connect a client system 130, an assistant system 140, a social-networking system 160, and a third-party system 170 to a communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout a network environment 100. One or more first links 150 may differ in one or more respects from one or more second links 150.

In particular embodiments, a client system 130 may be any suitable electronic device including hardware, software, or embedded logic components, or a combination of two or more such components, and may be capable of carrying out the functionalities implemented or supported by a client system 130. As an example and not by way of limitation, the client system 130 may include a computer system such as a desktop computer, notebook or laptop computer, netbook, a tablet computer, e-book reader, GPS device, camera, personal digital assistant (PDA), handheld electronic device, cellular telephone, smartphone, smart speaker, smart watch, smart glasses, augmented-reality (AR) smart glasses, virtual reality (VR) headset, other suitable electronic device, or any suitable combination thereof. In particular embodiments, the client system 130 may be a smart assistant device. More information on smart assistant devices may be found in U.S. patent application Ser. No. 15/949,011, filed 9 Apr. 2018, U.S. patent application Ser. No. 16/153,574, filed 5 Oct. 2018, U.S. Design patent application Ser. No. 29/631,910, filed 3 Jan. 2018, U.S. Design patent application Ser. No. 29/631,747, filed 2 Jan. 2018, U.S. Design patent application Ser. No. 29/631,913, filed 3 Jan. 2018, and U.S. Design patent application Ser. No. 29/631,914, filed 3 Jan. 2018, each of which is incorporated by reference. This disclosure contemplates any suitable client systems 130. In particular embodiments, a client system 130 may enable a network user at a client system 130 to access a network 110. The client system 130 may also enable the user to communicate with other users at other client systems 130.

In particular embodiments, a client system 130 may include a web browser 132, and may have one or more add-ons, plug-ins, or other extensions. A user at a client system 130 may enter a Uniform Resource Locator (URL) or other address directing a web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to a client system 130 one or more Hyper Text Markup Language (HTML) files responsive to the HTTP request. The client system 130 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts, combinations of markup language and scripts, and the like. Herein, reference to a web interface encompasses one or more corresponding source files (which a browser may use to render the web interface) and vice versa, where appropriate.

In particular embodiments, a client system 130 may include a social-networking application 134 installed on the client system 130. A user at a client system 130 may use the social-networking application 134 to access on online social network. The user at the client system 130 may use the social-networking application 134 to communicate with the user's social connections (e.g., friends, followers, followed accounts, contacts, etc.). The user at the client system 130 may also use the social-networking application 134 to interact with a plurality of content objects (e.g., posts, news articles, ephemeral content, etc.) on the online social network. As an example and not by way of limitation, the user may browse trending topics and breaking news using the social-networking application 134.

In particular embodiments, a client system 130 may include an assistant application 136. A user at a client system 130 may use the assistant application 136 to interact with the assistant system 140. In particular embodiments, the assistant application 136 may include an assistant xbot functionality as a front-end interface for interacting with the user of the client system 130, including receiving user inputs and presenting outputs. In particular embodiments, the assistant application 136 may comprise a stand-alone application. In particular embodiments, the assistant application 136 may be integrated into the social-networking application 134 or another suitable application (e.g., a messaging application). In particular embodiments, the assistant application 136 may be also integrated into the client system 130, an assistant hardware device, or any other suitable hardware devices. In particular embodiments, the assistant application 136 may be also part of the assistant system 140. In particular embodiments, the assistant application 136 may be accessed via the web browser 132. In particular embodiments, the user may interact with the assistant system 140 by providing user input to the assistant application 136 via various modalities (e.g., audio, voice, text, vision, image, video, gesture, motion, activity, location, orientation). The assistant application 136 may communicate the user input to the assistant system 140 (e.g., via the assistant xbot). Based on the user input, the assistant system 140 may generate responses. The assistant system 140 may send the generated responses to the assistant application 136. The assistant application 136 may then present the responses to the user at the client system 130 via various modalities (e.g., audio, text, image, and video). As an example and not by way of limitation, the user may interact with the assistant system 140 by providing a user input (e.g., a verbal request for information regarding a current status of nearby vehicle traffic) to the assistant xbot via a microphone of the client system 130. The assistant application 136 may then communicate the user input to the assistant system 140 over network 110. The assistant system 140 may accordingly analyze the user input, generate a response based on the analysis of the user input (e.g., vehicle traffic information obtained from a third-party source), and communicate the generated response back to the assistant application 136. The assistant application 136 may then present the generated response to the user in any suitable manner (e.g., displaying a text-based push notification and/or image(s) illustrating a local map of nearby vehicle traffic on a display of the client system 130).

In particular embodiments, a client system 130 may implement wake-word detection techniques to allow users to conveniently activate the assistant system 140 using one or more wake-words associated with assistant system 140. As an example and not by way of limitation, the system audio API on client system 130 may continuously monitor user input comprising audio data (e.g., frames of voice data) received at the client system 130. In this example, a wake-word associated with the assistant system 140 may be the voice phrase “hey assistant.” In this example, when the system audio API on client system 130 detects the voice phrase “hey assistant” in the monitored audio data, the assistant system 140 may be activated for subsequent interaction with the user. In alternative embodiments, similar detection techniques may be implemented to activate the assistant system 140 using particular non-audio user inputs associated with the assistant system 140. For example, the non-audio user inputs may be specific visual signals detected by a low-power sensor (e.g., camera) of client system 130. As an example and not by way of limitation, the visual signals may be a static image (e.g., barcode, QR code, universal product code (UPC)), a position of the user (e.g., the user's gaze towards client system 130), a user motion (e.g., the user pointing at an object), or any other suitable visual signal.

In particular embodiments, a client system 130 may include a rendering device 137 and, optionally, a companion device 138. The rendering device 137 may be configured to render outputs generated by the assistant system 140 to the user. The companion device 138 may be configured to perform computations associated with particular tasks (e.g., communications with the assistant system 140) locally (i.e., on-device) on the companion device 138 in particular circumstances (e.g., when the rendering device 137 is unable to perform said computations). In particular embodiments, the client system 130, the rendering device 137, and/or the companion device 138 may each be a suitable electronic device including hardware, software, or embedded logic components, or a combination of two or more such components, and may be capable of carrying out, individually or cooperatively, the functionalities implemented or supported by the client system 130 described herein. As an example and not by way of limitation, the client system 130, the rendering device 137, and/or the companion device 138 may each include a computer system such as a desktop computer, notebook or laptop computer, netbook, a tablet computer, e-book reader, GPS device, camera, personal digital assistant (PDA), handheld electronic device, cellular telephone, smartphone, smart speaker, virtual reality (VR) headset, augmented-reality (AR) smart glasses, other suitable electronic device, or any suitable combination thereof. In particular embodiments, one or more of the client system 130, the rendering device 137, and the companion device 138 may operate as a smart assistant device. As an example and not by way of limitation, the rendering device 137 may comprise smart glasses and the companion device 138 may comprise a smart phone. As another example and not by way of limitation, the rendering device 137 may comprise a smart watch and the companion device 138 may comprise a smart phone. As yet another example and not by way of limitation, the rendering device 137 may comprise smart glasses and the companion device 138 may comprise a smart remote for the smart glasses. As yet another example and not by way of limitation, the rendering device 137 may comprise a VR/AR headset and the companion device 138 may comprise a smart phone.

In particular embodiments, a user may interact with the assistant system 140 using the rendering device 137 or the companion device 138, individually or in combination. In particular embodiments, one or more of the client system 130, the rendering device 137, and the companion device 138 may implement a multi-stage wake-word detection model to enable users to conveniently activate the assistant system 140 by continuously monitoring for one or more wake-words associated with assistant system 140. At a first stage of the wake-word detection model, the rendering device 137 may receive audio user input (e.g., frames of voice data). If a wireless connection between the rendering device 137 and the companion device 138 is available, the application on the rendering device 137 may communicate the received audio user input to the companion application on the companion device 138 via the wireless connection. At a second stage of the wake-word detection model, the companion application on the companion device 138 may process the received audio user input to detect a wake-word associated with the assistant system 140. The companion application on the companion device 138 may then communicate the detected wake-word to a server associated with the assistant system 140 via wireless network 110. At a third stage of the wake-word detection model, the server associated with the assistant system 140 may perform a keyword verification on the detected wake-word to verify whether the user intended to activate and receive assistance from the assistant system 140. In alternative embodiments, any of the processing, detection, or keyword verification may be performed by the rendering device 137 and/or the companion device 138. In particular embodiments, when the assistant system 140 has been activated by the user, an application on the rendering device 137 may be configured to receive user input from the user, and a companion application on the companion device 138 may be configured to handle user inputs (e.g., user requests) received by the application on the rendering device 137. In particular embodiments, the rendering device 137 and the companion device 138 may be associated with each other (i.e., paired) via one or more wireless communication protocols (e.g., Bluetooth).

The following example workflow illustrates how a rendering device 137 and a companion device 138 may handle a user input provided by a user. In this example, an application on the rendering device 137 may receive a user input comprising a user request directed to the rendering device 137. The application on the rendering device 137 may then determine a status of a wireless connection (i.e., tethering status) between the rendering device 137 and the companion device 138. If a wireless connection between the rendering device 137 and the companion device 138 is not available, the application on the rendering device 137 may communicate the user request (optionally including additional data and/or contextual information available to the rendering device 137) to the assistant system 140 via the network 110. The assistant system 140 may then generate a response to the user request and communicate the generated response back to the rendering device 137. The rendering device 137 may then present the response to the user in any suitable manner. Alternatively, if a wireless connection between the rendering device 137 and the companion device 138 is available, the application on the rendering device 137 may communicate the user request (optionally including additional data and/or contextual information available to the rendering device 137) to the companion application on the companion device 138 via the wireless connection. The companion application on the companion device 138 may then communicate the user request (optionally including additional data and/or contextual information available to the companion device 138) to the assistant system 140 via the network 110. The assistant system 140 may then generate a response to the user request and communicate the generated response back to the companion device 138. The companion application on the companion device 138 may then communicate the generated response to the application on the rendering device 137. The rendering device 137 may then present the response to the user in any suitable manner. In the preceding example workflow, the rendering device 137 and the companion device 138 may each perform one or more computations and/or processes at each respective step of the workflow. In particular embodiments, performance of the computations and/or processes disclosed herein may be adaptively switched between the rendering device 137 and the companion device 138 based at least in part on a device state of the rendering device 137 and/or the companion device 138, a task associated with the user input, and/or one or more additional factors. As an example and not by way of limitation, one factor may be signal strength of the wireless connection between the rendering device 137 and the companion device 138. For example, if the signal strength of the wireless connection between the rendering device 137 and the companion device 138 is strong, the computations and processes may be adaptively switched to be substantially performed by the companion device 138 in order to, for example, benefit from the greater processing power of the CPU of the companion device 138. Alternatively, if the signal strength of the wireless connection between the rendering device 137 and the companion device 138 is weak, the computations and processes may be adaptively switched to be substantially performed by the rendering device 137 in a standalone manner. In particular embodiments, if the client system 130 does not comprise a companion device 138, the aforementioned computations and processes may be performed solely by the rendering device 137 in a standalone manner.

In particular embodiments, an assistant system 140 may assist users with various assistant-related tasks. The assistant system 140 may interact with the social-networking system 160 and/or the third-party system 170 when executing these assistant-related tasks.

In particular embodiments, the social-networking system 160 may be a network-addressable computing system that can host an online social network. The social-networking system 160 may generate, store, receive, and send social-networking data, such as, for example, user profile data, concept-profile data, social-graph information, or other suitable data related to the online social network. The social-networking system 160 may be accessed by the other components of network environment 100 either directly or via a network 110. As an example and not by way of limitation, a client system 130 may access the social-networking system 160 using a web browser 132 or a native application associated with the social-networking system 160 (e.g., a mobile social-networking application, a messaging application, another suitable application, or any combination thereof) either directly or via a network 110. In particular embodiments, the social-networking system 160 may include one or more servers 162. Each server 162 may be a unitary server or a distributed server spanning multiple computers or multiple datacenters. As an example and not by way of limitation, each server 162 may be a web server, a news server, a mail server, a message server, an advertising server, a file server, an application server, an exchange server, a database server, a proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, the social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, an assistant system 140, or a third-party system 170 to manage, retrieve, modify, add, or delete, the information stored in data store 164.

In particular embodiments, the social-networking system 160 may store one or more social graphs in one or more data stores 164. In particular embodiments, a social graph may include multiple nodes-which may include multiple user nodes (each corresponding to a particular user) or multiple concept nodes (each corresponding to a particular concept)—and multiple edges connecting the nodes. The social-networking system 160 may provide users of the online social network the ability to communicate and interact with other users. In particular embodiments, users may join the online social network via the social-networking system 160 and then add connections (e.g., relationships) to a number of other users of the social-networking system 160 whom they want to be connected to. Herein, the term “friend” may refer to any other user of the social-networking system 160 with whom a user has formed a connection, association, or relationship via the social-networking system 160.

In particular embodiments, the social-networking system 160 may provide users with the ability to take actions on various types of items or objects, supported by the social-networking system 160. As an example and not by way of limitation, the items and objects may include groups or social networks to which users of the social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 160 or by an external system of a third-party system 170, which is separate from the social-networking system 160 and coupled to the social-networking system 160 via a network 110.

In particular embodiments, the social-networking system 160 may be capable of linking a variety of entities. As an example and not by way of limitation, the social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating the social-networking system 160. In particular embodiments, however, the social-networking system 160 and third-party systems 170 may operate in conjunction with each other to provide social-networking services to users of the social-networking system 160 or third-party systems 170. In this sense, the social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects. In particular embodiments, a third-party content provider may use one or more third-party agents to provide content objects and/or services. A third-party agent may be an implementation that is hosted and executing on the third-party system 170.

In particular embodiments, the social-networking system 160 also includes user-generated content objects, which may enhance a user's interactions with the social-networking system 160. User-generated content may include anything a user can add, upload, send, or “post” to the social-networking system 160. As an example and not by way of limitation, a user communicates posts to the social-networking system 160 from a client system 130. Posts may include data such as status updates or other textual data, location information, photos, videos, links, music or other similar data or media. Content may also be added to the social-networking system 160 by a third-party through a “communication channel,” such as a newsfeed or stream.

In particular embodiments, the social-networking system 160 may include a variety of servers, sub-systems, programs, modules, logs, and data stores. In particular embodiments, the social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 160 may also include suitable components such as network interfaces, security mechanisms, load balancers, failover servers, management-and-network-operations consoles, other suitable components, or any suitable combination thereof. In particular embodiments, the social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 160 to one or more client systems 130 or one or more third-party systems 170 via a network 110. The web server may include a mail server or other messaging functionality for receiving and routing messages between the social-networking system 160 and one or more client systems 130. An API-request server may allow, for example, an assistant system 140 or a third-party system 170 to access information from the social-networking system 160 by calling one or more APIs. An action logger may be used to receive communications from a web server about a user's actions on or off the social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from a client system 130 responsive to a user input comprising a user request received from a client system 130. Authorization servers may be used to enforce one or more privacy settings of the users of the social-networking system 160. A privacy setting of a user may determine how particular information associated with a user can be shared. The authorization server may allow users to opt in to or opt out of having their actions logged by the social-networking system 160 or shared with other systems (e.g., a third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

### Assistant Systems

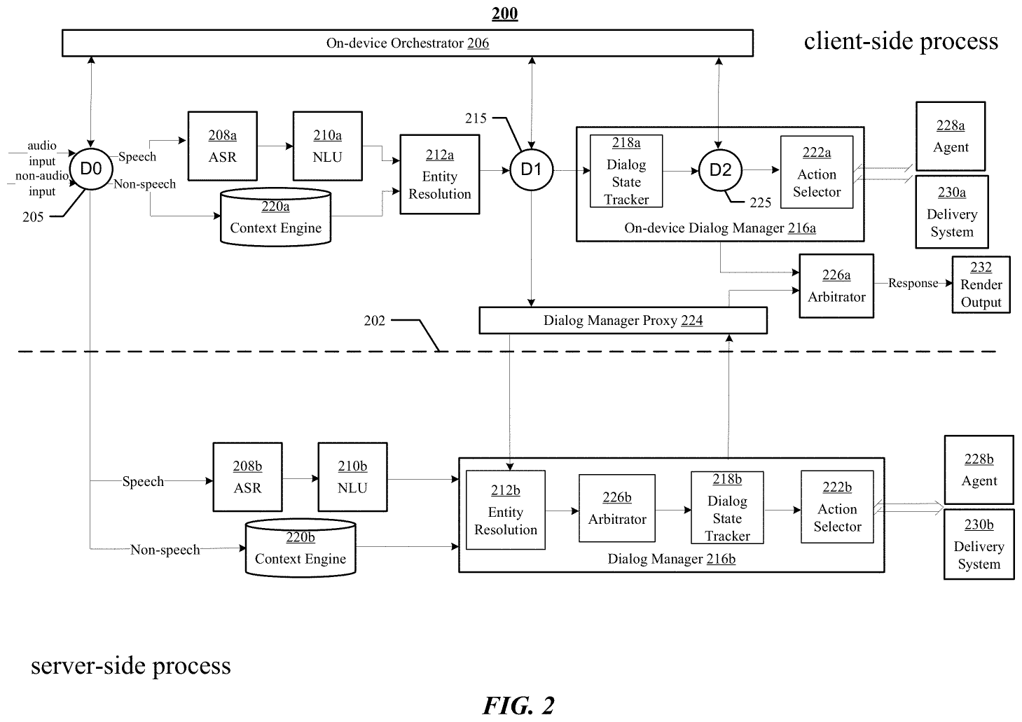

FIG. 2 illustrates an example architecture 200 of the assistant system 140. In particular embodiments, the assistant system 140 may assist a user to obtain information or services. The assistant system 140 may enable the user to interact with the assistant system 140 via user inputs of various modalities (e.g., audio, voice, text, vision, image, video, gesture, motion, activity, location, orientation) in stateful and multi-turn conversations to receive assistance from the assistant system 140. As an example and not by way of limitation, a user input may comprise an audio input based on the user's voice (e.g., a verbal command), which may be processed by a system audio API (application programming interface) on client system 130. The system audio API may perform techniques including echo cancellation, noise removal, beam forming, self-user voice activation, speaker identification, voice activity detection (VAD), and/or any other suitable acoustic technique in order to generate audio data that is readily processable by the assistant system 140. In particular embodiments, the assistant system 140 may support mono-modal inputs (e.g., only voice inputs), multi-modal inputs (e.g., voice inputs and text inputs), hybrid/multi-modal inputs, or any combination thereof. In particular embodiments, a user input may be a user-generated input that is sent to the assistant system 140 in a single turn. User inputs provided by a user may be associated with particular assistant-related tasks, and may include, for example, user requests (e.g., verbal requests for information or performance of an action), user interactions with the assistant application 136 associated with the assistant system 140 (e.g., selection of UI elements via touch or gesture), or any other type of suitable user input that may be detected and understood by the assistant system 140 (e.g., user movements detected by the client device 130 of the user).

In particular embodiments, the assistant system 140 may create and store a user profile comprising both personal and contextual information associated with the user. In particular embodiments, the assistant system 140 may analyze the user input using natural-language understanding (NLU) techniques. The analysis may be based at least in part on the user profile of the user for more personalized and context-aware understanding. The assistant system 140 may resolve entities associated with the user input based on the analysis. In particular embodiments, the assistant system 140 may interact with different agents to obtain information or services that are associated with the resolved entities. The assistant system 140 may generate a response for the user regarding the information or services by using natural-language generation (NLG). Through the interaction with the user, the assistant system 140 may use dialog management techniques to manage and forward the conversation flow with the user. In particular embodiments, the assistant system 140 may further assist the user to effectively and efficiently digest the obtained information by summarizing the information. The assistant system 140 may also assist the user to be more engaging with an online social network by providing tools that help the user interact with the online social network (e.g., creating posts, comments, messages). The assistant system 140 may additionally assist the user to manage different tasks such as keeping track of events. In particular embodiments, the assistant system 140 may proactively execute, without a user input, pre-authorized tasks that are relevant to user interests and preferences based on the user profile, at a time relevant for the user. In particular embodiments, the assistant system 140 may check privacy settings to ensure that accessing a user's profile or other user information and executing different tasks are permitted subject to the user's privacy settings. More information on assisting users subject to privacy settings may be found in U.S. patent application Ser. No. 16/182,542, filed 6 Nov. 2018, which is incorporated by reference.

In particular embodiments, the assistant system 140 may assist a user via an architecture built upon client-side processes and server-side processes which may operate in various operational modes. In FIG. 2, the client-side process is illustrated above the dashed line 202 whereas the server-side process is illustrated below the dashed line 202. A first operational mode (i.e., on-device mode) may be a workflow in which the assistant system 140 processes a user input and provides assistance to the user by primarily or exclusively performing client-side processes locally on the client system 130. For example, if the client system 130 is not connected to a network 110 (i.e., when client system 130 is offline), the assistant system 140 may handle a user input in the first operational mode utilizing only client-side processes. A second operational mode (i.e., cloud mode) may be a workflow in which the assistant system 140 processes a user input and provides assistance to the user by primarily or exclusively performing server-side processes on one or more remote servers (e.g., a server associated with assistant system 140). As illustrated in FIG. 2, a third operational mode (i.e., blended mode) may be a parallel workflow in which the assistant system 140 processes a user input and provides assistance to the user by performing client-side processes locally on the client system 130 in conjunction with server-side processes on one or more remote servers (e.g., a server associated with assistant system 140). For example, the client system 130 and the server associated with assistant system 140 may both perform automatic speech recognition (ASR) and natural-language understanding (NLU) processes, but the client system 130 may delegate dialog, agent, and natural-language generation (NLG) processes to be performed by the server associated with assistant system 140.

In particular embodiments, selection of an operational mode may be based at least in part on a device state, a task associated with a user input, and/or one or more additional factors. As an example and not by way of limitation, as described above, one factor may be a network connectivity status for client system 130. For example, if the client system 130 is not connected to a network 110 (i.e., when client system 130 is offline), the assistant system 140 may handle a user input in the first operational mode (i.e., on-device mode). As another example and not by way of limitation, another factor may be based on a measure of available battery power (i.e., battery status) for the client system 130. For example, if there is a need for client system 130 to conserve battery power (e.g., when client system 130 has minimal available battery power or the user has indicated a desire to conserve the battery power of the client system 130), the assistant system 140 may handle a user input in the second operational mode (i.e., cloud mode) or the third operational mode (i.e., blended mode) in order to perform fewer power-intensive operations on the client system 130. As yet another example and not by way of limitation, another factor may be one or more privacy constraints (e.g., specified privacy settings, applicable privacy policies). For example, if one or more privacy constraints limits or precludes particular data from being transmitted to a remote server (e.g., a server associated with the assistant system 140), the assistant system 140 may handle a user input in the first operational mode (i.e., on-device mode) in order to protect user privacy. As yet another example and not by way of limitation, another factor may be desynchronized context data between the client system 130 and a remote server (e.g., the server associated with assistant system 140). For example, the client system 130 and the server associated with assistant system 140 may be determined to have inconsistent, missing, and/or unreconciled context data, the assistant system 140 may handle a user input in the third operational mode (i.e., blended mode) to reduce the likelihood of an inadequate analysis associated with the user input. As yet another example and not by way of limitation, another factor may be a measure of latency for the connection between client system 130 and a remote server (e.g., the server associated with assistant system 140). For example, if a task associated with a user input may significantly benefit from and/or require prompt or immediate execution (e.g., photo capturing tasks), the assistant system 140 may handle the user input in the first operational mode (i.e., on-device mode) to ensure the task is performed in a timely manner. As yet another example and not by way of limitation, another factor may be, for a feature relevant to a task associated with a user input, whether the feature is only supported by a remote server (e.g., the server associated with assistant system 140). For example, if the relevant feature requires advanced technical functionality (e.g., high-powered processing capabilities, rapid update cycles) that is only supported by the server associated with assistant system 140 and is not supported by client system 130 at the time of the user input, the assistant system 140 may handle the user input in the second operational mode (i.e., cloud mode) or the third operational mode (i.e., blended mode) in order to benefit from the relevant feature.

In particular embodiments, an on-device orchestrator 206 on the client system 130 may coordinate receiving a user input and may determine, at one or more decision points in an example workflow, which of the operational modes described above should be used to process or continue processing the user input. As discussed above, selection of an operational mode may be based at least in part on a device state, a task associated with a user input, and/or one or more additional factors. As an example and not by way of limitation, with reference to the workflow architecture illustrated in FIG. 2, after a user input is received from a user, the on-device orchestrator 206 may determine, at decision point (D0) 205, whether to begin processing the user input in the first operational mode (i.e., on-device mode), the second operational mode (i.e., cloud mode), or the third operational mode (i.e., blended mode). For example, at decision point (D0) 205, the on-device orchestrator 206 may select the first operational mode (i.e., on-device mode) if the client system 130 is not connected to network 110 (i.e., when client system 130 is offline), if one or more privacy constraints expressly require on-device processing (e.g., adding or removing another person to a private call between users), or if the user input is associated with a task which does not require or benefit from server-side processing (e.g., setting an alarm or calling another user). As another example, at decision point (D0) 205, the on-device orchestrator 206 may select the second operational mode (i.e., cloud mode) or the third operational mode (i.e., blended mode) if the client system 130 has a need to conserve battery power (e.g., when client system 130 has minimal available battery power or the user has indicated a desire to conserve the battery power of the client system 130) or has a need to limit additional utilization of computing resources (e.g., when other processes operating on client device 130 require high CPU utilization (e.g., SMS messaging applications)).

In particular embodiments, if the on-device orchestrator 206 determines at decision point (D0) 205 that the user input should be processed using the first operational mode (i.e., on-device mode) or the third operational mode (i.e., blended mode), the client-side process may continue as illustrated in FIG. 2. As an example and not by way of limitation, if the user input comprises speech data, the speech data may be received at a local automatic speech recognition (ASR) module 208a on the client system 130. The ASR module 208a may allow a user to dictate and have speech transcribed as written text, have a document synthesized as an audio stream, or issue commands that are recognized as such by the system.

In particular embodiments, the output of the ASR module 208a may be sent to a local natural-language understanding (NLU) module 210a. The NLU module 210a may perform named entity resolution (NER), or named entity resolution may be performed by the entity resolution module 212a, as described below. In particular embodiments, one or more of an intent, a slot, or a domain may be an output of the NLU module 210a.

In particular embodiments, the user input may comprise non-speech data, which may be received at a local context engine 220a. As an example and not by way of limitation, the non-speech data may comprise locations, visuals, touch, gestures, world updates, social updates, contextual information, information related to people, activity data, and/or any other suitable type of non-speech data. The non-speech data may further comprise sensory data received by client system 130 sensors (e.g., microphone, camera), which may be accessed subject to privacy constraints and further analyzed by computer vision technologies. In particular embodiments, the computer vision technologies may comprise object detection, scene recognition, hand tracking, eye tracking, and/or any other suitable computer vision technologies. In particular embodiments, the non-speech data may be subject to geometric constructions, which may comprise constructing objects surrounding a user using any suitable type of data collected by a client system 130. As an example and not by way of limitation, a user may be wearing AR glasses, and geometric constructions may be utilized to determine spatial locations of surfaces and items (e.g., a floor, a wall, a user's hands). In particular embodiments, the non-speech data may be inertial data captured by AR glasses or a VR headset, and which may be data associated with linear and angular motions (e.g., measurements associated with a user's body movements). In particular embodiments, the context engine 220a may determine various types of events and context based on the non-speech data.

In particular embodiments, the outputs of the NLU module 210a and/or the context engine 220a may be sent to an entity resolution module 212a. The entity resolution module 212a may resolve entities associated with one or more slots output by NLU module 210a. In particular embodiments, each resolved entity may be associated with one or more entity identifiers. As an example and not by way of limitation, an identifier may comprise a unique user identifier (ID) corresponding to a particular user (e.g., a unique username or user ID number for the social-networking system 160). In particular embodiments, each resolved entity may also be associated with a confidence score. More information on resolving entities may be found in U.S. Pat. No. 10,803,050, filed 27 Jul. 2018, and U.S. patent application Ser. No. 16/048,072, filed 27 Jul. 2018, each of which is incorporated by reference.

In particular embodiments, at decision point (D0) 205, the on-device orchestrator 206 may determine that a user input should be handled in the second operational mode (i.e., cloud mode) or the third operational mode (i.e., blended mode). In these operational modes, the user input may be handled by certain server-side modules in a similar manner as the client-side process described above.

In particular embodiments, if the user input comprises speech data, the speech data of the user input may be received at a remote automatic speech recognition (ASR) module 208b on a remote server (e.g., the server associated with assistant system 140). The ASR module 208b may allow a user to dictate and have speech transcribed as written text, have a document synthesized as an audio stream, or issue commands that are recognized as such by the system.

In particular embodiments, the output of the ASR module 208b may be sent to a remote natural-language understanding (NLU) module 210b. In particular embodiments, the NLU module 210b may perform named entity resolution (NER) or named entity resolution may be performed by entity resolution module 212b of dialog manager module 216b as described below. In particular embodiments, one or more of an intent, a slot, or a domain may be an output of the NLU module 210b.

In particular embodiments, the user input may comprise non-speech data, which may be received at a remote context engine 220b. In particular embodiments, the remote context engine 220b may determine various types of events and context based on the non-speech data. In particular embodiments, the output of the NLU module 210b and/or the context engine 220b may be sent to a remote dialog manager 216b.

In particular embodiments, as discussed above, an on-device orchestrator 206 on the client system 130 may coordinate receiving a user input and may determine, at one or more decision points in an example workflow, which of the operational modes described above should be used to process or continue processing the user input. As further discussed above, selection of an operational mode may be based at least in part on a device state, a task associated with a user input, and/or one or more additional factors. As an example and not by way of limitation, with continued reference to the workflow architecture illustrated in FIG. 2, after the entity resolution module 212a generates an output or a null output, the on-device orchestrator 206 may determine, at decision point (D1) 215, whether to continue processing the user input in the first operational mode (i.e., on-device mode), the second operational mode (i.e., cloud mode), or the third operational mode (i.e., blended mode). For example, at decision point (D1) 215, the on-device orchestrator 206 may select the first operational mode (i.e., on-device mode) if an identified intent is associated with a latency sensitive processing task (e.g., taking a photo, pausing a stopwatch). As another example and not by way of limitation, if a messaging task is not supported by on-device processing on the client system 130, the on-device orchestrator 206 may select the third operational mode (i.e., blended mode) to process the user input associated with a messaging request. As yet another example, at decision point (D1) 215, the on-device orchestrator 206 may select the second operational mode (i.e., cloud mode) or the third operational mode (i.e., blended mode) if the task being processed requires access to a social graph, a knowledge graph, or a concept graph not stored on the client system 130. Alternatively, the on-device orchestrator 206 may instead select the first operational mode (i.e., on-device mode) if a sufficient version of an informational graph including requisite information for the task exists on the client system 130 (e.g., a smaller and/or bootstrapped version of a knowledge graph).

In particular embodiments, if the on-device orchestrator 206 determines at decision point (D1) 215 that processing should continue using the first operational mode (i.e., on-device mode) or the third operational mode (i.e., blended mode), the client-side process may continue as illustrated in FIG. 2. As an example and not by way of limitation, the output from the entity resolution module 212a may be sent to an on-device dialog manager 216a. In particular embodiments, the on-device dialog manager 216a may comprise a dialog state tracker 218a and an action selector 222a. The on-device dialog manager 216a may have complex dialog logic and product-related business logic to manage the dialog state and flow of the conversation between the user and the assistant system 140. The on-device dialog manager 216a may include full functionality for end-to-end integration and multi-turn support (e.g., confirmation, disambiguation). The on-device dialog manager 216a may also be lightweight with respect to computing limitations and resources including memory, computation (CPU), and binary size constraints. The on-device dialog manager 216a may also be scalable to improve developer experience. In particular embodiments, the on-device dialog manager 216a may benefit the assistant system 140, for example, by providing offline support to alleviate network connectivity issues (e.g., unstable or unavailable network connections), by using client-side processes to prevent privacy-sensitive information from being transmitted off of client system 130, and by providing a stable user experience in high-latency sensitive scenarios.

In particular embodiments, the on-device dialog manager 216a may further conduct false trigger mitigation. Implementation of false trigger mitigation may detect and prevent false triggers from user inputs which would otherwise invoke the assistant system 140 (e.g., an unintended wake-word) and may further prevent the assistant system 140 from generating data records based on the false trigger that may be inaccurate and/or subject to privacy constraints. As an example and not by way of limitation, if a user is in a voice call, the user's conversation during the voice call may be considered private, and the false trigger mitigation may limit detection of wake-words to audio user inputs received locally by the user's client system 130. In particular embodiments, the on-device dialog manager 216a may implement false trigger mitigation based on a nonsense detector. If the nonsense detector determines with a high confidence that a received wake-word is not logically and/or contextually sensible at the point in time at which it was received from the user, the on-device dialog manager 216a may determine that the user did not intend to invoke the assistant system 140.

In particular embodiments, due to a limited computing power of the client system 130, the on-device dialog manager 216a may conduct on-device learning based on learning algorithms particularly tailored for client system 130. As an example and not by way of limitation, federated learning techniques may be implemented by the on-device dialog manager 216a. Federated learning is a specific category of distributed machine learning techniques which may train machine-learning models using decentralized data stored on end devices (e.g., mobile phones). In particular embodiments, the on-device dialog manager 216a may use federated user representation learning model to extend existing neural-network personalization techniques to implementation of federated learning by the on-device dialog manager 216a. Federated user representation learning may personalize federated learning models by learning task-specific user representations (i.e., embeddings) and/or by personalizing model weights. Federated user representation learning is a simple, scalable, privacy-preserving, and resource-efficient. Federated user representation learning may divide model parameters into federated and private parameters. Private parameters, such as private user embeddings, may be trained locally on a client system 130 instead of being transferred to or averaged by a remote server (e.g., the server associated with assistant system 140). Federated parameters, by contrast, may be trained remotely on the server. In particular embodiments, the on-device dialog manager 216a may use an active federated learning model, which may transmit a global model trained on the remote server to client systems 130 and calculate gradients locally on the client systems 130. Active federated learning may enable the on-device dialog manager 216a to minimize the transmission costs associated with downloading models and uploading gradients. For active federated learning, in each round, client systems 130 may be selected in a semi-random manner based at least in part on a probability conditioned on the current model and the data on the client systems 130 in order to optimize efficiency for training the federated learning model.

In particular embodiments, the dialog state tracker 218a may track state changes over time as a user interacts with the world and the assistant system 140 interacts with the user. As an example and not by way of limitation, the dialog state tracker 218a may track, for example, what the user is talking about, whom the user is with, where the user is, what tasks are currently in progress, and where the user's gaze is at subject to applicable privacy policies.

In particular embodiments, at decision point (D1) 215, the on-device orchestrator 206 may determine to forward the user input to the server for either the second operational mode (i.e., cloud mode) or the third operational mode (i.e., blended mode). As an example and not by way of limitation, if particular functionalities or processes (e.g., messaging) are not supported by on the client system 130, the on-device orchestrator 206 may determine at decision point (D1) 215 to use the third operational mode (i.e., blended mode). In particular embodiments, the on-device orchestrator 206 may cause the outputs from the NLU module 210a, the context engine 220a, and the entity resolution module 212a, via a dialog manager proxy 224, to be forwarded to an entity resolution module 212b of the remote dialog manager 216b to continue the processing. The dialog manager proxy 224 may be a communication channel for information/events exchange between the client system 130 and the server. In particular embodiments, the dialog manager 216b may additionally comprise a remote arbitrator 226b, a remote dialog state tracker 218b, and a remote action selector 222b. In particular embodiments, the assistant system 140 may have started processing a user input with the second operational mode (i.e., cloud mode) at decision point (D0) 205 and the on-device orchestrator 206 may determine to continue processing the user input based on the second operational mode (i.e., cloud mode) at decision point (D1) 215. Accordingly, the output from the NLU module 210b and the context engine 220b may be received at the remote entity resolution module 212b. The remote entity resolution module 212b may have similar functionality as the local entity resolution module 212a, which may comprise resolving entities associated with the slots. In particular embodiments, the entity resolution module 212b may access one or more of the social graph, the knowledge graph, or the concept graph when resolving the entities. The output from the entity resolution module 212b may be received at the arbitrator 226b.

In particular embodiments, the remote arbitrator 226b may be responsible for choosing between client-side and server-side upstream results (e.g., results from the NLU module 210a/b, results from the entity resolution module 212a/b, and results from the context engine 220a/b). The arbitrator 226b may send the selected upstream results to the remote dialog state tracker 218b. In particular embodiments, similarly to the local dialog state tracker 218a, the remote dialog state tracker 218b may convert the upstream results into candidate tasks using task specifications and resolve arguments with entity resolution.

In particular embodiments, at decision point (D2) 225, the on-device orchestrator 206 may determine whether to continue processing the user input based on the first operational mode (i.e., on-device mode) or forward the user input to the server for the third operational mode (i.e., blended mode). The decision may depend on, for example, whether the client-side process is able to resolve the task and slots successfully, whether there is a valid task policy with a specific feature support, and/or the context differences between the client-side process and the server-side process. In particular embodiments, decisions made at decision point (D2) 225 may be for multi-turn scenarios. In particular embodiments, there may be at least two possible scenarios. In a first scenario, the assistant system 140 may have started processing a user input in the first operational mode (i.e., on-device mode) using client-side dialog state. If at some point the assistant system 140 decides to switch to having the remote server process the user input, the assistant system 140 may create a programmatic/predefined task with the current task state and forward it to the remote server. For subsequent turns, the assistant system 140 may continue processing in the third operational mode (i.e., blended mode) using the server-side dialog state. In another scenario, the assistant system 140 may have started processing the user input in either the second operational mode (i.e., cloud mode) or the third operational mode (i.e., blended mode) and may substantially rely on server-side dialog state for all subsequent turns. If the on-device orchestrator 206 determines to continue processing the user input based on the first operational mode (i.e., on-device mode), the output from the dialog state tracker 218a may be received at the action selector 222a.

In particular embodiments, at decision point (D2) 225, the on-device orchestrator 206 may determine to forward the user input to the remote server and continue processing the user input in either the second operational mode (i.e., cloud mode) or the third operational mode (i.e., blended mode). The assistant system 140 may create a programmatic/predefined task with the current task state and forward it to the server, which may be received at the action selector 222b. In particular embodiments, the assistant system 140 may have started processing the user input in the second operational mode (i.e., cloud mode), and the on-device orchestrator 206 may determine to continue processing the user input in the second operational mode (i.e., cloud mode) at decision point (D2) 225. Accordingly, the output from the dialog state tracker 218b may be received at the action selector 222b.

In particular embodiments, the action selector 222a/b may perform interaction management. The action selector 222a/b may determine and trigger a set of general executable actions. The actions may be executed either on the client system 130 or at the remote server. As an example and not by way of limitation, these actions may include providing information or suggestions to the user. In particular embodiments, the actions may interact with agents 228a/b, users, and/or the assistant system 140 itself. These actions may comprise actions including one or more of a slot request, a confirmation, a disambiguation, or an agent execution. The actions may be independent of the underlying implementation of the action selector 222a/b. For more complicated scenarios such as, for example, multi-turn tasks or tasks with complex business logic, the local action selector 222a may call one or more local agents 228a, and the remote action selector 222b may call one or more remote agents 228b to execute the actions. Agents 228a/b may be invoked via task ID, and any actions may be routed to the correct agent 228a/b using that task ID. In particular embodiments, an agent 228a/b may be configured to serve as a broker across a plurality of content providers for one domain. A content provider may be an entity responsible for carrying out an action associated with an intent or completing a task associated with the intent. In particular embodiments, agents 228a/b may provide several functionalities for the assistant system 140 including, for example, native template generation, task specific business logic, and querying external APIs. When executing actions for a task, agents 228a/b may use context from the dialog state tracker 218a/b, and may also update the dialog state tracker 218a/b. In particular embodiments, agents 228a/b may also generate partial payloads from a dialog act.

In particular embodiments, the local agents 228a may have different implementations to be compiled/registered for different platforms (e.g., smart glasses versus a VR headset). In particular embodiments, multiple device-specific implementations (e.g., real-time calls for a client system 130 or a messaging application on the client system 130) may be handled internally by a single agent 228a. Alternatively, device-specific implementations may be handled by multiple agents 228a associated with multiple domains. As an example and not by way of limitation, calling an agent 228a on smart glasses may be implemented in a different manner than calling an agent 228a on a smart phone. Different platforms may also utilize varying numbers of agents 228a. The agents 228a may also be cross-platform (i.e., different operating systems on the client system 130). In addition, the agents 228a may have minimized startup time or binary size impact. Local agents 228a may be suitable for particular use cases. As an example and not by way of limitation, one use case may be emergency calling on the client system 130. As another example and not by way of limitation, another use case may be responding to a user input without network connectivity. As yet another example and not by way of limitation, another use case may be that particular domains/tasks may be privacy sensitive and may prohibit user inputs being sent to the remote server.

In particular embodiments, the local action selector 222a may call a local delivery system 230a for executing the actions, and the remote action selector 222b may call a remote delivery system 230b for executing the actions. The delivery system 230a/b may deliver a predefined event upon receiving triggering signals from the dialog state tracker 218a/b by executing corresponding actions. The delivery system 230a/b may ensure that events get delivered to a host with a living connection. As an example and not by way of limitation, the delivery system 230a/b may broadcast to all online devices that belong to one user. As another example and not by way of limitation, the delivery system 230a/b may deliver events to target-specific devices. The delivery system 230a/b may further render a payload using up-to-date device context.

In particular embodiments, the on-device dialog manager 216a may additionally comprise a separate local action execution module, and the remote dialog manager 216b may additionally comprise a separate remote action execution module. The local execution module and the remote action execution module may have similar functionality. In particular embodiments, the action execution module may call the agents 228a/b to execute tasks. The action execution module may additionally perform a set of general executable actions determined by the action selector 222a/b. The set of executable actions may interact with agents 228a/b, users, and the assistant system 140 itself via the delivery system 230a/b.

In particular embodiments, if the user input is handled using the first operational mode (i.e., on-device mode), results from the agents 228a and/or the delivery system 230a may be returned to the on-device dialog manager 216a. The on-device dialog manager 216a may then instruct a local arbitrator 226a to generate a final response based on these results. The arbitrator 226a may aggregate the results and evaluate them. As an example and not by way of limitation, the arbitrator 226a may rank and select a best result for responding to the user input. If the user request is handled in the second operational mode (i.e., cloud mode), the results from the agents 228b and/or the delivery system 230b may be returned to the remote dialog manager 216b. The remote dialog manager 216b may instruct, via the dialog manager proxy 224, the arbitrator 226a to generate the final response based on these results. Similarly, the arbitrator 226a may analyze the results and select the best result to provide to the user. If the user input is handled based on the third operational mode (i.e., blended mode), the client-side results and server-side results (e.g., from agents 228a/b and/or delivery system 230a/b) may both be provided to the arbitrator 226a by the on-device dialog manager 216a and remote dialog manager 216b, respectively. The arbitrator 226 may then choose between the client-side and server-side side results to determine the final result to be presented to the user. In particular embodiments, the logic to decide between these results may depend on the specific use-case.

In particular embodiments, the local arbitrator 226a may generate a response based on the final result and send it to a render output module 232. The render output module 232 may determine how to render the output in a way that is suitable for the client system 130. As an example and not by way of limitation, for a VR headset or AR smart glasses, the render output module 232 may determine to render the output using a visual-based modality (e.g., an image or a video clip) that may be displayed via the VR headset or AR smart glasses. As another example, the response may be rendered as audio signals that may be played by the user via a VR headset or AR smart glasses. As yet another example, the response may be rendered as augmented-reality data for enhancing user experience.

In particular embodiments, in addition to determining an operational mode to process the user input, the on-device orchestrator 206 may also determine whether to process the user input on the rendering device 137, process the user input on the companion device 138, or process the user request on the remote server. The rendering device 137 and/or the companion device 138 may each use the assistant stack in a similar manner as disclosed above to process the user input. As an example and not by, the on-device orchestrator 206 may determine that part of the processing should be done on the rendering device 137, part of the processing should be done on the companion device 138, and the remaining processing should be done on the remote server.

In particular embodiments, the assistant system 140 may have a variety of capabilities including audio cognition, visual cognition, signals intelligence, reasoning, and memories. In particular embodiments, the capability of audio cognition may enable the assistant system 140 to, for example, understand a user's input associated with various domains in different languages, understand and summarize a conversation, perform on-device audio cognition for complex commands, identify a user by voice, extract topics from a conversation and auto-tag sections of the conversation, enable audio interaction without a wake-word, filter and amplify user voice from ambient noise and conversations, and/or understand which client system 130 a user is talking to if multiple client systems 130 are in vicinity.

In particular embodiments, the capability of visual cognition may enable the assistant system 140 to, for example, recognize interesting objects in the world through a combination of existing machine-learning models and one-shot learning, recognize an interesting moment and auto-capture it, achieve semantic understanding over multiple visual frames across different episodes of time, provide platform support for additional capabilities in places or objects recognition, recognize a full set of settings and micro-locations including personalized locations, recognize complex activities, recognize complex gestures to control a client system 130, handle images/videos from egocentric cameras (e.g., with motion, capture angles, resolution), accomplish similar levels of accuracy and speed regarding images with lower resolution, conduct one-shot registration and recognition of places and objects, and/or perform visual recognition on a client system 130.

In particular embodiments, the assistant system 140 may leverage computer vision techniques to achieve visual cognition. Besides computer vision techniques, the assistant system 140 may explore options that may supplement these techniques to scale up the recognition of objects. In particular embodiments, the assistant system 140 may use supplemental signals such as, for example, optical character recognition (OCR) of an object's labels, GPS signals for places recognition, and/or signals from a user's client system 130 to identify the user. In particular embodiments, the assistant system 140 may perform general scene recognition (e.g., home, work, public spaces) to set a context for the user and reduce the computer-vision search space to identify likely objects or people. In particular embodiments, the assistant system 140 may guide users to train the assistant system 140. For example, crowdsourcing may be used to get users to tag objects and help the assistant system 140 recognize more objects over time. As another example, users may register their personal objects as part of an initial setup when using the assistant system 140. The assistant system 140 may further allow users to provide positive/negative signals for objects they interact with to train and improve personalized models for them.

In particular embodiments, the capability of signals intelligence may enable the assistant system 140 to, for example, determine user location, understand date/time, determine family locations, understand users' calendars and future desired locations, integrate richer sound understanding to identify setting/context through sound alone, and/or build signals intelligence models at runtime which may be personalized to a user's individual routines.

In particular embodiments, the capability of reasoning may enable the assistant system 140 to, for example, pick up previous conversation threads at any point in the future, synthesize all signals to understand micro and personalized context, learn interaction patterns and preferences from users' historical behavior and accurately suggest interactions that they may value, generate highly predictive proactive suggestions based on micro-context understanding, understand what content a user may want to see at what time of a day, and/or understand the changes in a scene and how that may impact the user's desired content.

In particular embodiments, the capabilities of memories may enable the assistant system 140 to, for example, remember which social connections a user previously called or interacted with, write into memory and query memory at will (i.e., open dictation and auto tags), extract richer preferences based on prior interactions and long-term learning, remember a user's life history, extract rich information from egocentric streams of data and auto catalog, and/or write to memory in structured form to form rich short, episodic and long-term memories.

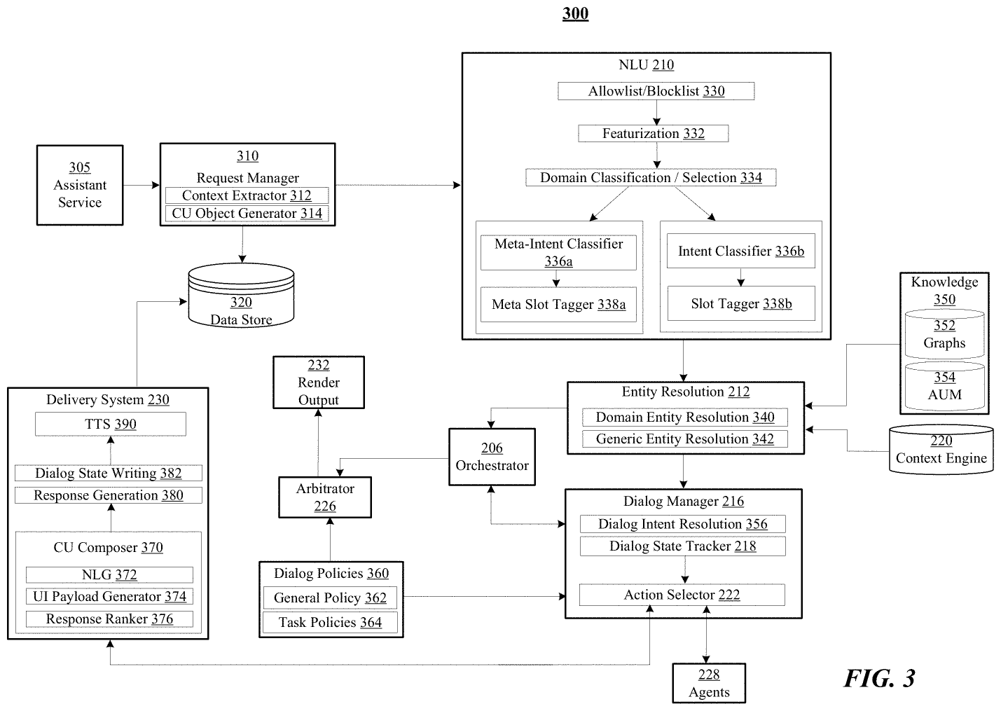

FIG. 3 illustrates an example flow diagram 300 of the assistant system 140. In particular embodiments, an assistant service module 305 may access a request manager 310 upon receiving a user input. In particular embodiments, the request manager 310 may comprise a context extractor 312 and a conversational understanding object generator (CU object generator) 314. The context extractor 312 may extract contextual information associated with the user input. The context extractor 312 may also update contextual information based on the assistant application 136 executing on the client system 130. As an example and not by way of limitation, the update of contextual information may comprise content items are displayed on the client system 130. As another example and not by way of limitation, the update of contextual information may comprise whether an alarm is set on the client system 130. As another example and not by way of limitation, the update of contextual information may comprise whether a song is playing on the client system 130. The CU object generator 314 may generate particular CU objects relevant to the user input. The CU objects may comprise dialog-session data and features associated with the user input, which may be shared with all the modules of the assistant system 140. In particular embodiments, the request manager 310 may store the contextual information and the generated CU objects in a data store 320 which is a particular data store implemented in the assistant system 140.

In particular embodiments, the request manger 310 may send the generated CU objects to the NLU module 210. The NLU module 210 may perform a plurality of steps to process the CU objects. The NLU module 210 may first run the CU objects through an allowlist/blocklist 330. In particular embodiments, the allowlist/blocklist 330 may comprise interpretation data matching the user input. The NLU module 210 may then perform a featurization 332 of the CU objects. The NLU module 210 may then perform domain classification/selection 334 on user input based on the features resulted from the featurization 332 to classify the user input into predefined domains. In particular embodiments, a domain may denote a social context of interaction (e.g., education), or a namespace for a set of intents (e.g., music). The domain classification/selection results may be further processed based on two related procedures. In one procedure, the NLU module 210 may process the domain classification/selection results using a meta-intent classifier 336a. The meta-intent classifier 336a may determine categories that describe the user's intent. An intent may be an element in a pre-defined taxonomy of semantic intentions, which may indicate a purpose of a user interaction with the assistant system 140. The NLU module 210a may classify a user input into a member of the pre-defined taxonomy. For example, the user input may be “Play Beethoven's 5th,” and the NLU module 210a may classify the input as having the intent [IN:play_music]. In particular embodiments, intents that are common to multiple domains may be processed by the meta-intent classifier 336a. As an example and not by way of limitation, the meta-intent classifier 336a may be based on a machine-learning model that may take the domain classification/selection results as input and calculate a probability of the input being associated with a particular predefined meta-intent. The NLU module 210 may then use a meta slot tagger 338a to annotate one or more meta slots for the classification result from the meta-intent classifier 336a. A slot may be a named sub-string corresponding to a character string within the user input representing a basic semantic entity. For example, a slot for “pizza” may be [SL:dish]. In particular embodiments, a set of valid or expected named slots may be conditioned on the classified intent. As an example and not by way of limitation, for the intent [IN:play_music], a valid slot may be [SL:song_name]. In particular embodiments, the meta slot tagger 338a may tag generic slots such as references to items (e.g., the first), the type of slot, the value of the slot, etc. In particular embodiments, the NLU module 210 may process the domain classification/selection results using an intent classifier 336b. The intent classifier 336b may determine the user's intent associated with the user input. In particular embodiments, there may be one intent classifier 336b for each domain to determine the most possible intents in a given domain. As an example and not by way of limitation, the intent classifier 336b may be based on a machine-learning model that may take the domain classification/selection results as input and calculate a probability of the input being associated with a particular predefined intent. The NLU module 210 may then use a slot tagger 338b to annotate one or more slots associated with the user input. In particular embodiments, the slot tagger 338b may annotate the one or more slots for the n-grams of the user input. As an example and not by way of limitation, a user input may comprise “change 500 dollars in my account to Japanese yen.” The intent classifier 336b may take the user input as input and formulate it into a vector. The intent classifier 336b may then calculate probabilities of the user input being associated with different predefined intents based on a vector comparison between the vector representing the user input and the vectors representing different predefined intents. In a similar manner, the slot tagger 338b may take the user input as input and formulate each word into a vector. The slot tagger 338b may then calculate probabilities of each word being associated with different predefined slots based on a vector comparison between the vector representing the word and the vectors representing different predefined slots. The intent of the user may be classified as “changing money”. The slots of the user input may comprise “500”, “dollars”, “account”, and “Japanese yen”. The meta-intent of the user may be classified as “financial service”. The meta slot may comprise “finance”.

In particular embodiments, the natural-language understanding (NLU) module 210 may additionally extract information from one or more of a social graph, a knowledge graph, or a concept graph, and may retrieve a user's profile stored locally on the client system 130. The NLU module 210 may additionally consider contextual information when analyzing the user input. The NLU module 210 may further process information from these different sources by identifying and aggregating information, annotating n-grams of the user input, ranking the n-grams with confidence scores based on the aggregated information, and formulating the ranked n-grams into features that may be used by the NLU module 210 for understanding the user input. In particular embodiments, the NLU module 210 may identify one or more of a domain, an intent, or a slot from the user input in a personalized and context-aware manner. As an example and not by way of limitation, a user input may comprise “show me how to get to the coffee shop.” The NLU module 210 may identify a particular coffee shop that the user wants to go to based on the user's personal information and the associated contextual information. In particular embodiments, the NLU module 210 may comprise a lexicon of a particular language, a parser, and grammar rules to partition sentences into an internal representation. The NLU module 210 may also comprise one or more programs that perform naive semantics or stochastic semantic analysis, and may further use pragmatics to understand a user input. In particular embodiments, the parser may be based on a deep learning architecture comprising multiple long-short term memory (LSTM) networks. As an example and not by way of limitation, the parser may be based on a recurrent neural network grammar (RNNG) model, which is a type of recurrent and recursive LSTM algorithm. More information on natural-language understanding (NLU) may be found in U.S. patent application Ser. No. 16/011,062, filed 18 Jun. 2018, U.S. patent application Ser. No. 16/025,317, filed 2 Jul. 2018, and U.S. patent application Ser. No. 16/038,120, filed 17 Jul. 2018, each of which is incorporated by reference.

In particular embodiments, the output of the NLU module 210 may be sent to the entity resolution module 212 to resolve relevant entities. Entities may include, for example, unique users or concepts, each of which may have a unique identifier (ID). The entities may include one or more of a real-world entity (from general knowledge base), a user entity (from user memory), a contextual entity (device context/dialog context), or a value resolution (numbers, datetime, etc.). In particular embodiments, the entity resolution module 212 may comprise domain entity resolution 340 and generic entity resolution 342. The entity resolution module 212 may execute generic and domain-specific entity resolution. The generic entity resolution 342 may resolve the entities by categorizing the slots and meta slots into different generic topics. The domain entity resolution 340 may resolve the entities by categorizing the slots and meta slots into different domains. As an example and not by way of limitation, in response to the input of an inquiry of the advantages of a particular brand of electric car, the generic entity resolution 342 may resolve the referenced brand of electric car as vehicle and the domain entity resolution 340 may resolve the referenced brand of electric car as electric car.

In particular embodiments, entities may be resolved based on knowledge 350 about the world and the user. The assistant system 140 may extract ontology data from the graphs 352. As an example and not by way of limitation, the graphs 352 may comprise one or more of a knowledge graph, a social graph, or a concept graph. The ontology data may comprise the structural relationship between different slots/meta-slots and domains. The ontology data may also comprise information of how the slots/meta-slots may be grouped, related within a hierarchy where the higher level comprises the domain, and subdivided according to similarities and differences. For example, the knowledge graph may comprise a plurality of entities. Each entity may comprise a single record associated with one or more attribute values. The particular record may be associated with a unique entity identifier. Each record may have diverse values for an attribute of the entity. Each attribute value may be associated with a confidence probability and/or a semantic weight. A confidence probability for an attribute value represents a probability that the value is accurate for the given attribute. A semantic weight for an attribute value may represent how the value semantically appropriate for the given attribute considering all the available information. For example, the knowledge graph may comprise an entity of a book titled “BookName”, which may include information extracted from multiple content sources (e.g., an online social network, online encyclopedias, book review sources, media databases, and entertainment content sources), which may be deduped, resolved, and fused to generate the single unique record for the knowledge graph. In this example, the entity titled “BookName” may be associated with a “fantasy” attribute value for a “genre” entity attribute. More information on the knowledge graph may be found in U.S. patent application Ser. No. 16/048,049, filed 27 Jul. 2018, and U.S. patent application Ser. No. 16/048,101, filed 27 Jul. 2018, each of which is incorporated by reference.

In particular embodiments, the assistant user memory (AUM) 354 may comprise user episodic memories which help determine how to assist a user more effectively. The AUM 354 may be the central place for storing, retrieving, indexing, and searching over user data. As an example and not by way of limitation, the AUM 354 may store information such as contacts, photos, reminders, etc. Additionally, the AUM 354 may automatically synchronize data to the server and other devices (only for non-sensitive data). As an example and not by way of limitation, if the user sets a nickname for a contact on one device, all devices may synchronize and get that nickname based on the AUM 354. In particular embodiments, the AUM 354 may first prepare events, user state, reminder, and trigger state for storing in a data store. Memory node identifiers (ID) may be created to store entry objects in the AUM 354, where an entry may be some piece of information about the user (e.g., photo, reminder, etc.) As an example and not by way of limitation, the first few bits of the memory node ID may indicate that this is a memory node ID type, the next bits may be the user ID, and the next bits may be the time of creation. The AUM 354 may then index these data for retrieval as needed. Index ID may be created for such purpose. In particular embodiments, given an “index key” (e.g., PHOTO_LOCATION) and “index value” (e.g., “San Francisco”), the AUM 354 may get a list of memory IDs that have that attribute (e.g., photos in San Francisco). As an example and not by way of limitation, the first few bits may indicate this is an index ID type, the next bits may be the user ID, and the next bits may encode an “index key” and “index value”. The AUM 354 may further conduct information retrieval with a flexible query language. Relation index ID may be created for such purpose. In particular embodiments, given a source memory node and an edge type, the AUM 354 may get memory IDs of all target nodes with that type of outgoing edge from the source. As an example and not by way of limitation, the first few bits may indicate this is a relation index ID type, the next bits may be the user ID, and the next bits may be a source node ID and edge type. In particular embodiments, the AUM 354 may help detect concurrent updates of different events. More information on episodic memories may be found in U.S. patent application Ser. No. 16/552,559, filed 27 Aug. 2019, which is incorporated by reference.

In particular embodiments, the entity resolution module 212 may use different techniques to resolve different types of entities. For real-world entities, the entity resolution module 212 may use a knowledge graph to resolve the span to the entities, such as “music track”, “movie”, etc. For user entities, the entity resolution module 212 may use user memory or some agents to resolve the span to user-specific entities, such as “contact”, “reminders”, or “relationship”. For contextual entities, the entity resolution module 212 may perform coreference based on information from the context engine 220 to resolve the references to entities in the context, such as “him”, “her”, “the first one”, or “the last one”. In particular embodiments, for coreference, the entity resolution module 212 may create references for entities determined by the NLU module 210. The entity resolution module 212 may then resolve these references accurately. As an example and not by way of limitation, a user input may comprise “find me the nearest grocery store and direct me there”. Based on coreference, the entity resolution module 212 may interpret “there” as “the nearest grocery store”. In particular embodiments, coreference may depend on the information from the context engine 220 and the dialog manager 216 so as to interpret references with improved accuracy. In particular embodiments, the entity resolution module 212 may additionally resolve an entity under the context (device context or dialog context), such as, for example, the entity shown on the screen or an entity from the last conversation history. For value resolutions, the entity resolution module 212 may resolve the mention to exact value in standardized form, such as numerical value, date time, address, etc.

In particular embodiments, the entity resolution module 212 may first perform a check on applicable privacy constraints in order to guarantee that performing entity resolution does not violate any applicable privacy policies. As an example and not by way of limitation, an entity to be resolved may be another user who specifies in their privacy settings that their identity should not be searchable on the online social network. In this case, the entity resolution module 212 may refrain from returning that user's entity identifier in response to a user input. By utilizing the described information obtained from the social graph, the knowledge graph, the concept graph, and the user profile, and by complying with any applicable privacy policies, the entity resolution module 212 may resolve entities associated with a user input in a personalized, context-aware, and privacy-protected manner.

In particular embodiments, the entity resolution module 212 may work with the ASR module 208 to perform entity resolution. The following example illustrates how the entity resolution module 212 may resolve an entity name. The entity resolution module 212 may first expand names associated with a user into their respective normalized text forms as phonetic consonant representations which may be phonetically transcribed using a double metaphone algorithm. The entity resolution module 212 may then determine an n-best set of candidate transcriptions and perform a parallel comprehension process on all of the phonetic transcriptions in the n-best set of candidate transcriptions. In particular embodiments, each transcription that resolves to the same intent may then be collapsed into a single intent. Each intent may then be assigned a score corresponding to the highest scoring candidate transcription for that intent. During the collapse, the entity resolution module 212 may identify various possible text transcriptions associated with each slot, correlated by boundary timing offsets associated with the slot's transcription. The entity resolution module 212 may then extract a subset of possible candidate transcriptions for each slot from a plurality (e.g., 1000) of candidate transcriptions, regardless of whether they are classified to the same intent. In this manner, the slots and intents may be scored lists of phrases. In particular embodiments, a new or running task capable of handling the intent may be identified and provided with the intent (e.g., a message composition task for an intent to send a message to another user). The identified task may then trigger the entity resolution module 212 by providing it with the scored lists of phrases associated with one of its slots and the categories against which it should be resolved. As an example and not by way of limitation, if an entity attribute is specified as “friend,” the entity resolution module 212 may run every candidate list of terms through the same expansion that may be run at matcher compilation time. Each candidate expansion of the terms may be matched in the precompiled trie matching structure. Matches may be scored using a function based at least in part on the transcribed input, matched form, and friend name. As another example and not by way of limitation, if an entity attribute is specified as “celebrity/notable person,” the entity resolution module 212 may perform parallel searches against the knowledge graph for each candidate set of terms for the slot output from the ASR module 208. The entity resolution module 212 may score matches based on matched person popularity and ASR-provided score signal. In particular embodiments, when the memory category is specified, the entity resolution module 212 may perform the same search against user memory. The entity resolution module 212 may crawl backward through user memory and attempt to match each memory (e.g., person recently mentioned in conversation, or seen and recognized via visual signals, etc.). For each entity, the entity resolution module 212 may employ matching similarly to how friends are matched (i.e., phonetic). In particular embodiments, scoring may comprise a temporal decay factor associated with a recency with which the name was previously mentioned. The entity resolution module 212 may further combine, sort, and dedupe all matches. In particular embodiments, the task may receive the set of candidates. When multiple high scoring candidates are present, the entity resolution module 212 may perform user-facilitated disambiguation (e.g., getting real-time user feedback from users on these candidates).

In particular embodiments, the context engine 220 may help the entity resolution module 212 improve entity resolution. The context engine 220 may comprise offline aggregators and an online inference service. The offline aggregators may process a plurality of data associated with the user that are collected from a prior time window. As an example and not by way of limitation, the data may include news feed posts/comments, interactions with news feed posts/comments, search history, etc., that are collected during a predetermined timeframe (e.g., from a prior 90-day window). The processing result may be stored in the context engine 220 as part of the user profile. The user profile of the user may comprise user profile data including demographic information, social information, and contextual information associated with the user. The user profile data may also include user interests and preferences on a plurality of topics, aggregated through conversations on news feed, search logs, messaging platforms, etc. The usage of a user profile may be subject to privacy constraints to ensure that a user's information can be used only for his/her benefit, and not shared with anyone else. More information on user profiles may be found in U.S. patent application Ser. No. 15/967,239, filed 30 Apr. 2018, which is incorporated by reference. In particular embodiments, the online inference service may analyze the conversational data associated with the user that are received by the assistant system 140 at a current time. The analysis result may be stored in the context engine 220 also as part of the user profile. In particular embodiments, both the offline aggregators and online inference service may extract personalization features from the plurality of data. The extracted personalization features may be used by other modules of the assistant system 140 to better understand user input. In particular embodiments, the entity resolution module 212 may process the information from the context engine 220 (e.g., a user profile) in the following steps based on natural-language processing (NLP). In particular embodiments, the entity resolution module 212 may tokenize text by text normalization, extract syntax features from text, and extract semantic features from text based on NLP. The entity resolution module 212 may additionally extract features from contextual information, which is accessed from dialog history between a user and the assistant system 140. The entity resolution module 212 may further conduct global word embedding, domain-specific embedding, and/or dynamic embedding based on the contextual information. The processing result may be annotated with entities by an entity tagger. Based on the annotations, the entity resolution module 212 may generate dictionaries. In particular embodiments, the dictionaries may comprise global dictionary features which can be updated dynamically offline. The entity resolution module 212 may rank the entities tagged by the entity tagger. In particular embodiments, the entity resolution module 212 may communicate with different graphs 352 including one or more of the social graph, the knowledge graph, or the concept graph to extract ontology data that is relevant to the retrieved information from the context engine 220. In particular embodiments, the entity resolution module 212 may further resolve entities based on the user profile, the ranked entities, and the information from the graphs 352.

In particular embodiments, the entity resolution module 212 may be driven by the task (corresponding to an agent 228). This inversion of processing order may make it possible for domain knowledge present in a task to be applied to pre-filter or bias the set of resolution targets when it is obvious and appropriate to do so. As an example and not by way of limitation, for the utterance “who is John?” no clear category is implied in the utterance. Therefore, the entity resolution module 212 may resolve “John” against everything. As another example and not by way of limitation, for the utterance “send a message to John”, the entity resolution module 212 may easily determine “John” refers to a person that one can message. As a result, the entity resolution module 212 may bias the resolution to a friend. As another example and not by way of limitation, for the utterance “what is John's most famous album?” To resolve “John”, the entity resolution module 212 may first determine the task corresponding to the utterance, which is finding a music album. The entity resolution module 212 may determine that entities related to music albums include singers, producers, and recording studios. Therefore, the entity resolution module 212 may search among these types of entities in a music domain to resolve “John.”

In particular embodiments, the output of the entity resolution module 212 may be sent to the dialog manager 216 to advance the flow of the conversation with the user. The dialog manager 216 may be an asynchronous state machine that repeatedly updates the state and selects actions based on the new state. The dialog manager 216 may additionally store previous conversations between the user and the assistant system 140. In particular embodiments, the dialog manager 216 may conduct dialog optimization. Dialog optimization relates to the challenge of understanding and identifying the most likely branching options in a dialog with a user. As an example and not by way of limitation, the assistant system 140 may implement dialog optimization techniques to obviate the need to confirm who a user wants to call because the assistant system 140 may determine a high confidence that a person inferred based on context and available data is the intended recipient. In particular embodiments, the dialog manager 216 may implement reinforcement learning frameworks to improve the dialog optimization. The dialog manager 216 may comprise dialog intent resolution 356, the dialog state tracker 218, and the action selector 222. In particular embodiments, the dialog manager 216 may execute the selected actions and then call the dialog state tracker 218 again until the action selected requires a user response, or there are no more actions to execute. Each action selected may depend on the execution result from previous actions. In particular embodiments, the dialog intent resolution 356 may resolve the user intent associated with the current dialog session based on dialog history between the user and the assistant system 140. The dialog intent resolution 356 may map intents determined by the NLU module 210 to different dialog intents. The dialog intent resolution 356 may further rank dialog intents based on signals from the NLU module 210, the entity resolution module 212, and dialog history between the user and the assistant system 140.

In particular embodiments, the dialog state tracker 218 may use a set of operators to track the dialog state. The operators may comprise necessary data and logic to update the dialog state. Each operator may act as delta of the dialog state after processing an incoming user input. In particular embodiments, the dialog state tracker 218 may a comprise a task tracker, which may be based on task specifications and different rules. The dialog state tracker 218 may also comprise a slot tracker and coreference component, which may be rule based and/or recency based. The coreference component may help the entity resolution module 212 to resolve entities. In alternative embodiments, with the coreference component, the dialog state tracker 218 may replace the entity resolution module 212 and may resolve any references/mentions and keep track of the state. In particular embodiments, the dialog state tracker 218 may convert the upstream results into candidate tasks using task specifications and resolve arguments with entity resolution. Both user state (e.g., user's current activity) and task state (e.g., triggering conditions) may be tracked. Given the current state, the dialog state tracker 218 may generate candidate tasks the assistant system 140 may process and perform for the user. As an example and not by way of limitation, candidate tasks may include “show suggestion,” “get weather information,” or “take photo.” In particular embodiments, the dialog state tracker 218 may generate candidate tasks based on available data from, for example, a knowledge graph, a user memory, and a user task history. In particular embodiments, the dialog state tracker 218 may then resolve the triggers object using the resolved arguments. As an example and not by way of limitation, a user input “remind me to call mom when she's online and I'm home tonight” may perform the conversion from the NLU output to the triggers representation by the dialog state tracker 218 as illustrated in Table 1 below:

TABLE 1
Example Conversion from NLU Output to Triggers Representation

| NLU Ontology Representation: | Triggers Representation: |
|---|---|
| [IN:CREATE_SMART_REMINDER → | Triggers: { |
| Remind me to | andTriggers: [ |
| [SL:TODO call mom] when | condition: {ContextualEvent(mom is |
| [SL:TRIGGER_CONJUNCTION | online)}, |
| [IN:GET_TRIGGER | condition: {ContextualEvent(location is |
| [SL:TRIGGER_SOCIAL_UPDATE | home)}, |
| she's online] and I'm | condition: {ContextualEvent(time is |
| [SL:TRIGGER_LOCATION home] | tonight)}]))]} |
| [SL:DATE_TIME tonight] | |
| ] | |
| ] | |
| ] | |

In the above example, “mom,” “home,” and “tonight” are represented by their respective entities: personEntity, locationEntity, datetimeEntity.

In particular embodiments, the dialog manager 216 may map events determined by the context engine 220 to actions. As an example and not by way of limitation, an action may be a natural-language generation (NLG) action, a display or overlay, a device action, or a retrieval action. The dialog manager 216 may also perform context tracking and interaction management. Context tracking may comprise aggregating real-time stream of events into a unified user state. Interaction management may comprise selecting optimal action in each state. In particular embodiments, the dialog state tracker 218 may perform context tracking (i.e., tracking events related to the user). To support processing of event streams, the dialog state tracker 218a may use an event handler (e.g., for disambiguation, confirmation, request) that may consume various types of events and update an internal assistant state. Each event type may have one or more handlers. Each event handler may be modifying a certain slice of the assistant state. In particular embodiments, the event handlers may be operating on disjoint subsets of the state (i.e., only one handler may have write-access to a particular field in the state). In particular embodiments, all event handlers may have an opportunity to process a given event. As an example and not by way of limitation, the dialog state tracker 218 may run all event handlers in parallel on every event, and then may merge the state updates proposed by each event handler (e.g., for each event, most handlers may return a NULL update).

In particular embodiments, the dialog state tracker 218 may work as any programmatic handler (logic) that requires versioning. In particular embodiments, instead of directly altering the dialog state, the dialog state tracker 218 may be a side-effect free component and generate n-best candidates of dialog state update operators that propose updates to the dialog state. The dialog state tracker 218 may comprise intent resolvers containing logic to handle different types of NLU intent based on the dialog state and generate the operators. In particular embodiments, the logic may be organized by intent handler, such as a disambiguation intent handler to handle the intents when the assistant system 140 asks for disambiguation, a confirmation intent handler that comprises the logic to handle confirmations, etc. Intent resolvers may combine the turn intent together with the dialog state to generate the contextual updates for a conversation with the user. A slot resolution component may then recursively resolve the slots in the update operators with resolution providers including the knowledge graph and domain agents. In particular embodiments, the dialog state tracker 218 may update/rank the dialog state of the current dialog session. As an example and not by way of limitation, the dialog state tracker 218 may update the dialog state as “completed” if the dialog session is over. As another example and not by way of limitation, the dialog state tracker 218 may rank the dialog state based on a priority associated with it.

In particular embodiments, the dialog state tracker 218 may communicate with the action selector 222 about the dialog intents and associated content objects. In particular embodiments, the action selector 222 may rank different dialog hypotheses for different dialog intents. The action selector 222 may take candidate operators of dialog state and consult the dialog policies 360 to decide what actions should be executed. In particular embodiments, a dialog policy 360 may a tree-based policy, which is a pre-constructed dialog plan. Based on the current dialog state, a dialog policy 360 may choose a node to execute and generate the corresponding actions. As an example and not by way of limitation, the tree-based policy may comprise topic grouping nodes and dialog action (leaf) nodes. In particular embodiments, a dialog policy 360 may also comprise a data structure that describes an execution plan of an action by an agent 228. A dialog policy 360 may further comprise multiple goals related to each other through logical operators. In particular embodiments, a goal may be an outcome of a portion of the dialog policy and it may be constructed by the dialog manager 216. A goal may be represented by an identifier (e.g., string) with one or more named arguments, which parameterize the goal. As an example and not by way of limitation, a goal with its associated goal argument may be represented as {confirm_artist, args:{artist: “Madonna”}}. In particular embodiments, goals may be mapped to leaves of the tree of the tree-structured representation of the dialog policy 360.

In particular embodiments, the assistant system 140 may use hierarchical dialog policies 360 with general policy 362 handling the cross-domain business logic and task policies 364 handling the task/domain specific logic. The general policy 362 may be used for actions that are not specific to individual tasks. The general policy 362 may be used to determine task stacking and switching, proactive tasks, notifications, etc. The general policy 362 may comprise handling low-confidence intents, internal errors, unacceptable user response with retries, and/or skipping or inserting confirmation based on ASR or NLU confidence scores. The general policy 362 may also comprise the logic of ranking dialog state update candidates from the dialog state tracker 218 output and pick the one to update (such as picking the top ranked task intent). In particular embodiments, the assistant system 140 may have a particular interface for the general policy 362, which allows for consolidating scattered cross-domain policy/business-rules, especial those found in the dialog state tracker 218, into a function of the action selector 222. The interface for the general policy 362 may also allow for authoring of self-contained sub-policy units that may be tied to specific situations or clients (e.g., policy functions that may be easily switched on or off based on clients, situation). The interface for the general policy 362 may also allow for providing a layering of policies with back-off, i.e., multiple policy units, with highly specialized policy units that deal with specific situations being backed up by more general policies 362 that apply in wider circumstances. In this context the general policy 362 may alternatively comprise intent or task specific policy.

In particular embodiments, a task policy 364 may comprise the logic for action selector 222 based on the task and current state. The task policy 364 may be dynamic and ad-hoc. In particular embodiments, the types of task policies 364 may include one or more of the following types: (1) manually crafted tree-based dialog plans; (2) coded policy that directly implements the interface for generating actions; (3) configurator-specified slot-filling tasks; or (4) machine-learning model based policy learned from data. In particular embodiments, the assistant system 140 may bootstrap new domains with rule-based logic and later refine the task policies 364 with machine-learning models. In particular embodiments, the general policy 362 may pick one operator from the candidate operators to update the dialog state, followed by the selection of a user facing action by a task policy 364. Once a task is active in the dialog state, the corresponding task policy 364 may be consulted to select right actions.

In particular embodiments, the action selector 222 may select an action based on one or more of the event determined by the context engine 220, the dialog intent and state, the associated content objects, and the guidance from dialog policies 360. Each dialog policy 360 may be subscribed to specific conditions over the fields of the state. After an event is processed and the state is updated, the action selector 222 may run a fast search algorithm (e.g., similarly to the Boolean satisfiability) to identify which policies should be triggered based on the current state. In particular embodiments, if multiple policies are triggered, the action selector 222 may use a tie-breaking mechanism to pick a particular policy. Alternatively, the action selector 222 may use a more sophisticated approach which may dry-run each policy and then pick a particular policy which may be determined to have a high likelihood of success. In particular embodiments, mapping events to actions may result in several technical advantages for the assistant system 140. One technical advantage may include that each event may be a state update from the user or the user's physical/digital environment, which may or may not trigger an action from assistant system 140. Another technical advantage may include possibilities to handle rapid bursts of events (e.g., user enters a new building and sees many people) by first consuming all events to update state, and then triggering action(s) from the final state. Another technical advantage may include consuming all events into a single global assistant state.

In particular embodiments, the action selector 222 may take the dialog state update operators as part of the input to select the dialog action. The execution of the dialog action may generate a set of expectations to instruct the dialog state tracker 218 to handle future turns. In particular embodiments, an expectation may be used to provide context to the dialog state tracker 218 when handling the user input from next turn. As an example and not by way of limitation, slot request dialog action may have the expectation of proving a value for the requested slot. In particular embodiments, both the dialog state tracker 218 and the action selector 222 may not change the dialog state until the selected action is executed. This may allow the assistant system 140 to execute the dialog state tracker 218 and the action selector 222 for processing speculative ASR results and to do n-best ranking with dry runs.

In particular embodiments, the action selector 222 may call different agents 228 for task execution. Meanwhile, the dialog manager 216 may receive an instruction to update the dialog state. As an example and not by way of limitation, the update may comprise awaiting agents' 228 response. An agent 228 may select among registered content providers to complete the action. The data structure may be constructed by the dialog manager 216 based on an intent and one or more slots associated with the intent. In particular embodiments, the agents 228 may comprise first-party agents and third-party agents. In particular embodiments, first-party agents may comprise internal agents that are accessible and controllable by the assistant system 140 (e.g. agents associated with services provided by the online social network, such as messaging services or photo-share services). In particular embodiments, third-party agents may comprise external agents that the assistant system 140 has no control over (e.g., third-party online music application agents, ticket sales agents). The first-party agents may be associated with first-party providers that provide content objects and/or services hosted by the social-networking system 160. The third-party agents may be associated with third-party providers that provide content objects and/or services hosted by the third-party system 170. In particular embodiments, each of the first-party agents or third-party agents may be designated for a particular domain. As an example and not by way of limitation, the domain may comprise weather, transportation, music, shopping, social, videos, photos, events, locations, and/or work. In particular embodiments, the assistant system 140 may use a plurality of agents 228 collaboratively to respond to a user input. As an example and not by way of limitation, the user input may comprise “direct me to my next meeting.” The assistant system 140 may use a calendar agent to retrieve the location of the next meeting. The assistant system 140 may then use a navigation agent to direct the user to the next meeting.

In particular embodiments, the dialog manager 216 may support multi-turn compositional resolution of slot mentions. For a compositional parse from the NLU module 210, the resolver may recursively resolve the nested slots. The dialog manager 216 may additionally support disambiguation for the nested slots. As an example and not by way of limitation, the user input may be “remind me to call Alex”. The resolver may need to know which Alex to call before creating an actionable reminder to-do entity. The resolver may halt the resolution and set the resolution state when further user clarification is necessary for a particular slot. The general policy 362 may examine the resolution state and create corresponding dialog action for user clarification. In dialog state tracker 218, based on the user input and the last dialog action, the dialog manager 216 may update the nested slot. This capability may allow the assistant system 140 to interact with the user not only to collect missing slot values but also to reduce ambiguity of more complex/ambiguous utterances to complete the task. In particular embodiments, the dialog manager 216 may further support requesting missing slots in a nested intent and multi-intent user inputs (e.g., “take this photo and send it to Dad”). In particular embodiments, the dialog manager 216 may support machine-learning models for more robust dialog experience. As an example and not by way of limitation, the dialog state tracker 218 may use neural network based models (or any other suitable machine-learning models) to model belief over task hypotheses. As another example and not by way of limitation, for action selector 222, highest priority policy units may comprise white-list/black-list overrides, which may have to occur by design; middle priority units may comprise machine-learning models designed for action selection; and lower priority units may comprise rule-based fallbacks when the machine-learning models elect not to handle a situation. In particular embodiments, machine-learning model based general policy unit may help the assistant system 140 reduce redundant disambiguation or confirmation steps, thereby reducing the number of turns to execute the user input.

In particular embodiments, the determined actions by the action selector 222 may be sent to the delivery system 230. The delivery system 230 may comprise a CU composer 370, a response generation component 380, a dialog state writing component 382, and a text-to-speech (TTS) component 390. Specifically, the output of the action selector 222 may be received at the CU composer 370. In particular embodiments, the output from the action selector 222 may be formulated as a <k,c,u,d> tuple, in which k indicates a knowledge source, c indicates a communicative goal, u indicates a user model, and d indicates a discourse model.

In particular embodiments, the CU composer 370 may generate a communication content for the user using a natural-language generation (NLG) component 372. In particular embodiments, the NLG component 372 may use different language models and/or language templates to generate natural-language outputs. The generation of natural-language outputs may be application specific. The generation of natural-language outputs may be also personalized for each user. In particular embodiments, the NLG component 372 may comprise a content determination component, a sentence planner, and a surface realization component. The content determination component may determine the communication content based on the knowledge source, communicative goal, and the user's expectations. As an example and not by way of limitation, the determining may be based on a description logic. The description logic may comprise, for example, three fundamental notions which are individuals (representing objects in the domain), concepts (describing sets of individuals), and roles (representing binary relations between individuals or concepts). The description logic may be characterized by a set of constructors that allow the natural-language generator to build complex concepts/roles from atomic ones. In particular embodiments, the content determination component may perform the following tasks to determine the communication content. The first task may comprise a translation task, in which the input to the NLG component 372 may be translated to concepts. The second task may comprise a selection task, in which relevant concepts may be selected among those resulted from the translation task based on the user model. The third task may comprise a verification task, in which the coherence of the selected concepts may be verified. The fourth task may comprise an instantiation task, in which the verified concepts may be instantiated as an executable file that can be processed by the NLG component 372. The sentence planner may determine the organization of the communication content to make it human understandable. The surface realization component may determine specific words to use, the sequence of the sentences, and the style of the communication content.

In particular embodiments, the CU composer 370 may also determine a modality of the generated communication content using the UI payload generator 374. Since the generated communication content may be considered as a response to the user input, the CU composer 370 may additionally rank the generated communication content using a response ranker 376. As an example and not by way of limitation, the ranking may indicate the priority of the response. In particular embodiments, the CU composer 370 may comprise a natural-language synthesis (NLS) component that may be separate from the NLG component 372. The NLS component may specify attributes of the synthesized speech generated by the CU composer 370, including gender, volume, pace, style, or register, in order to customize the response for a particular user, task, or agent. The NLS component may tune language synthesis without engaging the implementation of associated tasks. In particular embodiments, the CU composer 370 may check privacy constraints associated with the user to make sure the generation of the communication content follows the privacy policies. More information on customizing natural-language generation (NLG) may be found in U.S. patent application Ser. No. 15/967,279, filed 30 Apr. 2018, and U.S. patent application Ser. No. 15/966,455, filed 30 Apr. 2018, which is incorporated by reference.

In particular embodiments, the delivery system 230 may perform different tasks based on the output of the CU composer 370. These tasks may include writing (i.e., storing/updating) the dialog state into the data store 330 using the dialog state writing component 382 and generating responses using the response generation component 380. In particular embodiments, the output of the CU composer 370 may be additionally sent to the TTS component 390 if the determined modality of the communication content is audio. In particular embodiments, the output from the delivery system 230 comprising one or more of the generated responses, the communication content, or the speech generated by the TTS component 390 may be then sent back to the dialog manager 216.

In particular embodiments, the orchestrator 206 may determine, based on the output of the entity resolution module 212, whether to processing a user input on the client system 130 or on the server, or in the third operational mode (i.e., blended mode) using both. Besides determining how to process the user input, the orchestrator 206 may receive the results from the agents 228 and/or the results from the delivery system 230 provided by the dialog manager 216. The orchestrator 206 may then forward these results to the arbitrator 226. The arbitrator 226 may aggregate these results, analyze them, select the best result, and provide the selected result to the render output module 232. In particular embodiments, the arbitrator 226 may consult with dialog policies 360 to obtain the guidance when analyzing these results. In particular embodiments, the render output module 232 may generate a response that is suitable for the client system 130.

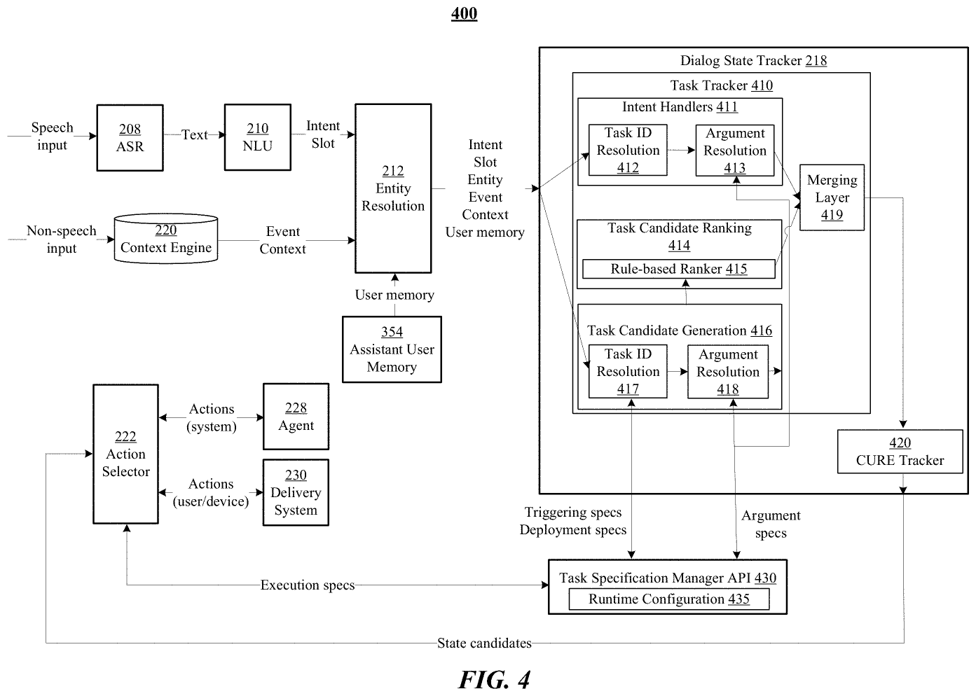

FIG. 4 illustrates an example task-centric flow diagram 400 of processing a user input. In particular embodiments, the assistant system 140 may assist users not only with voice-initiated experiences but also more proactive, multi-modal experiences that are initiated on understanding user context. In particular embodiments, the assistant system 140 may rely on assistant tasks for such purpose. An assistant task may be a central concept that is shared across the whole assistant stack to understand user intention, interact with the user and the world to complete the right task for the user. In particular embodiments, an assistant task may be the primitive unit of assistant capability. It may comprise data fetching, updating some state, executing some command, or complex tasks composed of a smaller set of tasks. Completing a task correctly and successfully to deliver the value to the user may be the goal that the assistant system 140 is optimized for. In particular embodiments, an assistant task may be defined as a capability or a feature. The assistant task may be shared across multiple product surfaces if they have exactly the same requirements so it may be easily tracked. It may also be passed from device to device, and easily picked up mid-task by another device since the primitive unit is consistent. In addition, the consistent format of the assistant task may allow developers working on different modules in the assistant stack to more easily design around it. Furthermore, it may allow for task sharing. As an example and not by way of limitation, if a user is listening to music on smart glasses, the user may say “play this music on my phone.” In the event that the phone hasn't been woken or has a task to execute, the smart glasses may formulate a task that is provided to the phone, which may then be executed by the phone to start playing music. In particular embodiments, the assistant task may be retained by each surface separately if they have different expected behaviors. In particular embodiments, the assistant system 140 may identify the right task based on user inputs in different modality or other signals, conduct conversation to collect all necessary information, and complete that task with action selector 222 implemented internally or externally, on server or locally product surfaces. In particular embodiments, the assistant stack may comprise a set of processing components from wake-up, recognizing user inputs, understanding user intention, reasoning about the tasks, fulfilling a task to generate natural-language response with voices.

In particular embodiments, the user input may comprise speech input. The speech input may be received at the ASR module 208 for extracting the text transcription from the speech input. The ASR module 208 may use statistical models to determine the most likely sequences of words that correspond to a given portion of speech received by the assistant system 140 as audio input. The models may include one or more of hidden Markov models, neural networks, deep learning models, or any combination thereof. The received audio input may be encoded into digital data at a particular sampling rate (e.g., 16, 44.1, or 96 kHz) and with a particular number of bits representing each sample (e.g., 8, 16, of 24 bits).

In particular embodiments, the ASR module 208 may comprise one or more of a grapheme-to-phoneme (G2P) model, a pronunciation learning model, a personalized acoustic model, a personalized language model (PLM), or an end-pointing model. In particular embodiments, the grapheme-to-phoneme (G2P) model may be used to determine a user's grapheme-to-phoneme style (i.e., what it may sound like when a particular user speaks a particular word). In particular embodiments, the personalized acoustic model may be a model of the relationship between audio signals and the sounds of phonetic units in the language. Therefore, such personalized acoustic model may identify how a user's voice sounds. The personalized acoustical model may be generated using training data such as training speech received as audio input and the corresponding phonetic units that correspond to the speech. The personalized acoustical model may be trained or refined using the voice of a particular user to recognize that user's speech. In particular embodiments, the personalized language model may then determine the most likely phrase that corresponds to the identified phonetic units for a particular audio input. The personalized language model may be a model of the probabilities that various word sequences may occur in the language. The sounds of the phonetic units in the audio input may be matched with word sequences using the personalized language model, and greater weights may be assigned to the word sequences that are more likely to be phrases in the language. The word sequence having the highest weight may be then selected as the text that corresponds to the audio input. In particular embodiments, the personalized language model may also be used to predict what words a user is most likely to say given a context. In particular embodiments, the end-pointing model may detect when the end of an utterance is reached. In particular embodiments, based at least in part on a limited computing power of the client system 130, the assistant system 140 may optimize the personalized language model at runtime during the client-side process. As an example and not by way of limitation, the assistant system 140 may pre-compute a plurality of personalized language models for a plurality of possible subjects a user may talk about. When a user input is associated with a request for assistance, the assistant system 140 may promptly switch between and locally optimize the pre-computed language models at runtime based on user activities. As a result, the assistant system 140 may preserve computational resources while efficiently identifying a subject matter associated with the user input. In particular embodiments, the assistant system 140 may also dynamically re-learn user pronunciations at runtime.

In particular embodiments, the user input may comprise non-speech input. The non-speech input may be received at the context engine 220 for determining events and context from the non-speech input. The context engine 220 may determine multi-modal events comprising voice/text intents, location updates, visual events, touch, gaze, gestures, activities, device/application events, and/or any other suitable type of events. The voice/text intents may depend on the ASR module 208 and the NLU module 210. The location updates may be consumed by the dialog manager 216 to support various proactive/reactive scenarios. The visual events may be based on person or object appearing in the user's field of view. These events may be consumed by the dialog manager 216 and recorded in transient user state to support visual co-reference (e.g., resolving “that” in “how much is that shirt?” and resolving “him” in “send him my contact”). The gaze, gesture, and activity may result in flags being set in the transient user state (e.g., user is running) which may condition the action selector 222. For the device/application events, if an application makes an update to the device state, this may be published to the assistant system 140 so that the dialog manager 216 may use this context (what is currently displayed to the user) to handle reactive and proactive scenarios. As an example and not by way of limitation, the context engine 220 may cause a push notification message to be displayed on a display screen of the user's client system 130. The user may interact with the push notification message, which may initiate a multi-modal event (e.g., an event workflow for replying to a message received from another user). Other example multi-modal events may include seeing a friend, seeing a landmark, being at home, running, starting a call with touch, taking a photo with touch, opening an application, etc. In particular embodiments, the context engine 220 may also determine world/social events based on world/social updates (e.g., weather changes, a friend getting online). The social updates may comprise events that a user is subscribed to, (e.g., friend's birthday, posts, comments, other notifications). These updates may be consumed by the dialog manager 216 to trigger proactive actions based on context (e.g., suggesting a user call a friend on their birthday, but only if the user is not focused on something else). As an example and not by way of limitation, receiving a message may be a social event, which may trigger the task of reading the message to the user.

In particular embodiments, the text transcription from the ASR module 208 may be sent to the NLU module 210. The NLU module 210 may process the text transcription and extract the user intention (i.e., intents) and parse the slots or parsing result based on the linguistic ontology. In particular embodiments, the intents and slots from the NLU module 210 and/or the events and contexts from the context engine 220 may be sent to the entity resolution module 212. In particular embodiments, the entity resolution module 212 may resolve entities associated with the user input based on the output from the NLU module 210 and/or the context engine 220. The entity resolution module 212 may use different techniques to resolve the entities, including accessing user memory from the assistant user memory (AUM) 354. In particular embodiments, the AUM 354 may comprise user episodic memories helpful for resolving the entities by the entity resolution module 212. The AUM 354 may be the central place for storing, retrieving, indexing, and searching over user data.

In particular embodiments, the entity resolution module 212 may provide one or more of the intents, slots, entities, events, context, or user memory to the dialog state tracker 218. The dialog state tracker 218 may identify a set of state candidates for a task accordingly, conduct interaction with the user to collect necessary information to fill the state, and call the action selector 222 to fulfill the task. In particular embodiments, the dialog state tracker 218 may comprise a task tracker 410. The task tracker 410 may track the task state associated with an assistant task. In particular embodiments, a task state may be a data structure persistent cross interaction turns and updates in real time to capture the state of the task during the whole interaction. The task state may comprise all the current information about a task execution status, such as arguments, confirmation status, confidence score, etc. Any incorrect or outdated information in the task state may lead to failure or incorrect task execution. The task state may also serve as a set of contextual information for many other components such as the ASR module 208, the NLU module 210, etc.

In particular embodiments, the task tracker 410 may comprise intent handlers 411, task candidate ranking module 414, task candidate generation module 416, and merging layer 419. In particular embodiments, a task may be identified by its ID name. The task ID may be used to associate corresponding component assets if it is not explicitly set in the task specification, such as dialog policy 360, agent execution, NLG dialog act, etc. Therefore, the output from the entity resolution module 212 may be received by a task ID resolution component 417 of the task candidate generation module 416 to resolve the task ID of the corresponding task. In particular embodiments, the task ID resolution component 417 may call a task specification manager API 430 to access the triggering specifications and deployment specifications for resolving the task ID. Given these specifications, the task ID resolution component 417 may resolve the task ID using intents, slots, dialog state, context, and user memory.

In particular embodiments, the technical specification of a task may be defined by a task specification. The task specification may be used by the assistant system 140 to trigger a task, conduct dialog conversation, and find a right execution module (e.g., agents 228) to execute the task. The task specification may be an implementation of the product requirement document. It may serve as the general contract and requirements that all the components agreed on. It may be considered as an assembly specification for a product, while all development partners deliver the modules based on the specification. In particular embodiments, an assistant task may be defined in the implementation by a specification. As an example and not by way of limitation, the task specification may be defined as the following categories. One category may be a basic task schema which comprises the basic identification information such as ID, name, and the schema of the input arguments. Another category may be a triggering specification, which is about how a task can be triggered, such as intents, event message ID, etc. Another category may be a conversational specification, which is for dialog manager 216 to conduct the conversation with users and systems. Another category may be an execution specification, which is about how the task will be executed and fulfilled. Another category may be a deployment specification, which is about how a feature will be deployed to certain surfaces, local, and group of users.

In particular embodiments, the task specification manager API 430 may be an API for accessing a task specification manager. The task specification manager may be a module in the runtime stack for loading the specifications from all the tasks and providing interfaces to access all the tasks specifications for detailed information or generating task candidates. In particular embodiments, the task specification manager may be accessible for all components in the runtime stack via the task specification manager API 430. The task specification manager may comprise a set of static utility functions to manage tasks with the task specification manager, such as filtering task candidates by platform. Before landing the task specification, the assistant system 140 may also dynamically load the task specifications to support end-to-end development on the development stage.

In particular embodiments, the task specifications may be grouped by domains and stored in runtime configurations 435. The runtime stack may load all the task specifications from the runtime configurations 435 during the building time. In particular embodiments, in the runtime configurations 435, for a domain, there may be a cconffile and a cinc file (e.g., sidechef_task.cconf and sidechef_task.inc). As an example and not by way of limitation, <domain>_tasks.cconf may comprise all the details of the task specifications. As another example and not by way of limitation, <domain>_tasks.cinc may provide a way to override the generated specification if there is no support for that feature yet.

In particular embodiments, a task execution may require a set of arguments to execute. Therefore, an argument resolution component 418 may resolve the argument names using the argument specifications for the resolved task ID. These arguments may be resolved based on NLU outputs (e.g., slot [SL:contact]), dialog state (e.g., short-term calling history), user memory (such as user preferences, location, long-term calling history, etc.), or device context (such as timer states, screen content, etc.). In particular embodiments, the argument modality may be text, audio, images or other structured data. The slot to argument mapping may be defined by a filling strategy and/or language ontology. In particular embodiments, given the task triggering specifications, the task candidate generation module 416 may look for the list of tasks to be triggered as task candidates based on the resolved task ID and arguments.

In particular embodiments, the generated task candidates may be sent to the task candidate ranking module 414 to be further ranked. The task candidate ranking module 414 may use a rule-based ranker 415 to rank them. In particular embodiments, the rule-based ranker 415 may comprise a set of heuristics to bias certain domain tasks. The ranking logic may be described as below with principles of context priority. In particular embodiments, the priority of a user specified task may be higher than an on-foreground task. The priority of the on-foreground task may be higher than a device-domain task when the intent is a meta intent. The priority of the device-domain task may be higher than a task of a triggering intent domain. As an example and not by way of limitation, the ranking may pick the task if the task domain is mentioned or specified in the utterance, such as “create a timer in TIMER app”. As another example and not by way of imitation, the ranking may pick the task if the task domain is on foreground or active state, such as “stop the timer” to stop the timer while the TIMER app is on foreground and there is an active timer. As yet another example and not by way of imitation, the ranking may pick the task if the intent is general meta intent, and the task is device control while there is no other active application or active state. As yet another example and not by way of imitation, the ranking may pick the task if the task is the same as the intent domain. In particular embodiments, the task candidate ranking module 414 may customize some more logic to check the match of intent/slot/entity types. The ranked task candidates may be sent to the merging layer 419.

In particular embodiments, the output from the entity resolution module 212 may also sent to a task ID resolution component 412 of the intent handlers 411. The task ID resolution component 412 may resolve the task ID of the corresponding task similarly to the task ID resolution component 417. In particular embodiments, the intent handlers 411 may additionally comprise an argument resolution component 413. The argument resolution component 413 may resolve the argument names using the argument specifications for the resolved task ID similarly to the argument resolution component 418. In particular embodiments, intent handlers 411 may deal with task agnostic features and may not be expressed within the task specifications which are task specific. Intent handlers 411 may output state candidates other than task candidates such as argument update, confirmation update, disambiguation update, etc. In particular embodiments, some tasks may require very complex triggering conditions or very complex argument filling logic that may not be reusable by other tasks even if they were supported in the task specifications (e.g., in-call voice commands, media tasks via [IN:PLAY_MEDIA], etc.). Intent handlers 411 may be also suitable for such type of tasks. In particular embodiments, the results from the intent handlers 411 may take precedence over the results from the task candidate ranking module 414. The results from the intent handlers 411 may be also sent to the merging layer 419.

In particular embodiments, the merging layer 419 may combine the results from the intent handlers 411 and the results from the task candidate ranking module 414. The dialog state tracker 218 may suggest each task as a new state for the dialog policies 360 to select from, thereby generating a list of state candidates. The merged results may be further sent to a conversational understanding reinforcement engine (CURE) tracker 420. In particular embodiments, the CURE tracker 420 may be a personalized learning process to improve the determination of the state candidates by the dialog state tracker 218 under different contexts using real-time user feedback. More information on conversational understanding reinforcement engine may be found in U.S. patent application Ser. No. 17/186,459, filed 26 Feb. 2021, which is incorporated by reference.

In particular embodiments, the state candidates generated by the CURE tracker 420 may be sent to the action selector 222. The action selector 222 may consult with the task policies 364, which may be generated from execution specifications accessed via the task specification manager API 430. In particular embodiments, the execution specifications may describe how a task should be executed and what actions the action selector 222 may need to take to complete the task.

In particular embodiments, the action selector 222 may determine actions associated with the system. Such actions may involve the agents 228 to execute. As a result, the action selector 222 may send the system actions to the agents 228 and the agents 228 may return the execution results of these actions. In particular embodiments, the action selector may determine actions associated with the user or device. Such actions may need to be executed by the delivery system 230. As a result, the action selector 222 may send the user/device actions to the delivery system 230 and the delivery system 230 may return the execution results of these actions.

The embodiments disclosed herein may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

Linguistic Calibration Through Metacognition: Aligning Dialogue Agent Responses with Expected Correctness

In particular embodiments, the assistant system 140 may recognize when the assistant system 140 may be wrong about a fact and modulate its answer and incorporate qualifying language into its response to a user. Machine-learning models in existing systems may be very calibrated for categorizing things, e.g., the chat bots of these systems may reply to user queries with YES or NO confidently. However, such answers may not generally convey information about the underlying confidence score that leads the machine-learning models to output that answer/classification. In the assistant/agent Q&A context, the systems may have language models that are providing answers/responses that sound very confident. But this may be misleading to users, since it masks any underlying lack of confidence by the assistant Q&A agent. Additionally, sometimes this may lead to a chat bot saying something very confidently that is factually incorrect. To solve this problem, the assistant system 140 may use a classifier that predicts how likely a chat bot is to give a correct answer, i.e., model confidence. Once the assistant system 140 determines the model confidence and further recognizes the model confidence is not matched with factual correctness (i.e., how correct is the answer), the assistant system 140 may modify the chat bot's linguistic confidence (i.e., subjective user's perception of confidence of the answer) to accurately convey the correct level of confidence (or lack thereof). For example, a traditional chat bot may reply to a user's query “what is the largest US city” by answering “that would be Los Angeles” (which is a factually wrong answer). By contrast, with modification of chat bot's linguistic confidence, the chat bot of the assistant system 140 may say “I'm not sure, but my guess is Los Angeles” (which modulates the answer by reflecting the low confidence in the answer by the model). Although this disclosure describes modulating particular responses by particular systems in a particular manner, this disclosure contemplates modulating any suitable response by any suitable system in any suitable manner.

Abstract

Open-domain dialogue agents may have vastly improved, but may still confidently hallucinate knowledge or express doubt when asked straightforward questions. The embodiments disclosed herein analyze whether state-of-the-art chitchat models can express metacognition capabilities through their responses: does a verbalized expression of doubt (or confidence) match the likelihood that the model's answer is incorrect (or correct)? We find that these models may be poorly calibrated in this sense, yet we show that the representations within the models may be used to accurately predict likelihood of correctness. By incorporating these correctness predictions into the training of a controllable generation model, we may obtain a dialogue agent with greatly improved linguistic calibration.

### INTRODUCTION

Neural generative open-domain English-language dialogue agents have recently made progress towards the ability to carry on chit-chat conversations with humans (Adiwardana et al., 2020; Roller et al., 2020). Recent models—trained on large swaths of data from the internet to mimic human-human conversations—may name their favorite sports teams, describe what it's like to be the owner of two dogs, or even share their opinions on tacos. However, ask a state-of-the-art chatbot “Which is heavier, 1 kg feathers or 1 kg stone?”, and it might confidently answer: “Feathers, because they are heavier than a kilogram of any other material.” Alternatively, it may express doubt and respond “I don't know . . . ” to an otherwise straightforward question as a result of a tendency to produce short, generic responses and overuse common phrases.

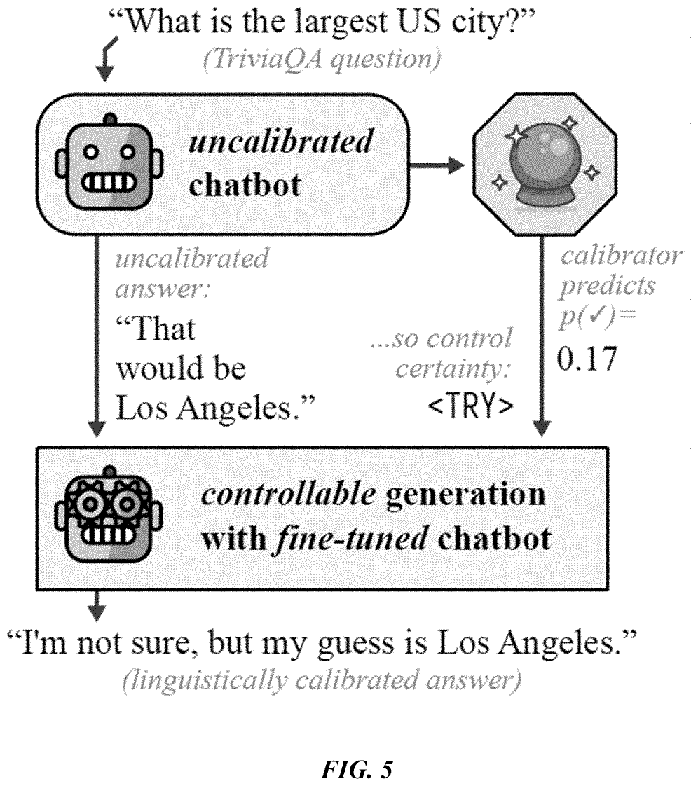

FIG. 5 illustrates an example pipeline for re-calibrating a generative dialogue agent. This pipeline may involve a calibrator that returns the probability that the original dialogue agent's answers are correct, as well as a fine-tuned model that controls for linguistic confidence; the linguistic confidence may be adjusted based on the probability returned by the calibrator, yielding a response for which the linguistic confidence aligns with the likelihood that the dialogue agent's answer is correct. This is our proposed calibrator-controlled chatbot.

The embodiments disclosed herein seek to understand whether a model's verbalized expression of confidence (“Obviously, . . . ”) or doubt (“I'm not sure, but . . . ”) in its answer-which we refer to throughout as linguistic confidence-corresponds to the likelihood that the answer is correct, and if not, whether we can fine-tune the models with controlled generation techniques to achieve better alignment. In other words, do state-of-the-art open domain dialogue agents “know” what they do not know? If yes, can this knowledge inform their responses, to achieve better verbalized metacognition?

We thus make three main contributions. First, we annotate a state-of-the-art chit-chat model's responses to a large-scale QA task for both factual correctness and linguistic confidence. Next, using these annotations, we find that the model may be poorly calibrated in the sense that linguistic confidence may not match factual correctness. On the other hand, we show that we may train a much better correctness predictor directly from the chit chat model's representations. Finally, we use this trained predictor within a controllable generation model to create a pipeline which greatly improves the calibration of a state-of-the-art chit-chat model.

Related Work

Knowledge in Open-Domain Chatbots This work focuses on neural generative open-domain dialogue agents, rather than general purpose language models or QA models trained to produce a factual answer given a question. Much progress has been made in recent years by training large-scale Transformer (Vaswani et al., 2017) encoder-decoder models for dialogue tasks (Roller et al., 2020; Adiwardana et al., 2020; Zhang et al., 2019). These sequence-to-sequence models may be typically trained on large amounts of data from the inter-net to produce a conversational response given a dialogue history as input. Despite impressive performance on chit-chat tasks, these models may be often prone to hallucinating knowledge (Roller et al., 2020). Dinan et al. (2019) and Gopalakrishnan et al. (2019) have proposed additional conditioning on a knowledge base to address this issue, but success may be only partial, so we may be far from being able to assume that even a knowledge-conditioned model reliably gives correct answers.

Overconfidence The overconfidence effect is a well-studied phenomenon in humans which refers to the bias in which individuals' assessments of their own accuracy (confidence) exceed their objective accuracy (correctness) (Pallier et al., 2002). It has been well-established in psychology research that humans tend to be overconfident—in other words, are poorly calibrated-when completing general knowledge tasks (Juslin, 1994; Kleitman and Stankov, 2001; Stankov and Crawford, 1996; Stankov, 1998). The work of Kamath et al. (2020) attempts to correct overconfidence in neural network models, by training QA models to abstain from answering questions in which they are likely to err, using probabilistic calibration (see next paragraph). We instead focus on getting conversational models to communicate their confidence verbally, so that they still produce an answer, but one that is not misleading as to how likely the answer is to be correct.

Probabilistic Calibration A large body of work has been dedicated to analysis (and correction of) the probabilistic calibration of deep neural networks. In particular, Guo et al. (2017) show that modern neural networks for classification tasks are poorly calibrated; in other words, the models' confidence estimate (\hat{P}) that its answer (Ŷ) is correct (Ŷ=Y*) is misaligned with the probability that it is indeed correct as measured by the joint distribution (P(Ŷ=Y*)≠\hat{P}). This may contrast with previous findings that show that (earlier) neural networks are well-calibrated on binary classification tasks (Niculescu-Mizil and Caruana, 2005). Throughout the embodiments disclosed herein, we refer to this notion of calibration as probabilistic calibration to distinguish it from linguistic calibration, which is the main focus of the embodiments disclosed herein. In the latter, we measure linguistic confidence as opposed to the model's probabilistic confidence estimates. More recently, probabilistic calibration has been explored in the space of large-scale language models (LMs). Desai and Durrett (2020) find that the pre-trained Transformers RoBERTa (Liu et al., 2019) and BERT (Devlin et al., 2019) are well-calibrated in-domain on the tasks Natural Language Inference (NLI), paraphrase detection, and commonsense reasoning. Similarly, Jagannatha and Yu (2020) calibrate BERT and DistilBERT (Sanh et al., 2019) for Part-of-Speech tagging (POS), Named Entity Recognition (NER), and QA tasks. As opposed to using LMs as target predictors on classification tasks like NLI and NER, Jiang et al. (2020) instead focus on LMs as natural language generators and analyze T5 (Raffel et al., 2020), a large-scale Transformer with an encoder-decoder architecture. The authors find that it is poorly calibrated in its probability estimates on QA tasks. Conversely, Radford et al. (2019) find that GPT2 is reasonably well calibrated on QA tasks, with an accuracy of 63.1% on the 1% of questions it is most confident in on Natural Questions (Kwiatkowski et al., 2019).

Controlled Response Generation We aim to reformulate answers while controlling for their expressed certainty. This may require style transfer or controlled generation techniques, which may encourage certain attributes to fit prescribed values, for example a given length or sentiment. Lample et al. (2018) proposed a method to exert simultaneous control over multiple attributes based on concatenated learned control tokens. We may similarly condition on an initial source text and concatenate multiple control tokens when generating responses. Keskar et al. (2019) trained a large-scale language model with control codes that govern style, content, and task-specific behavior. In the context of open-domain dialogue, See et al. (2019) used control on attributes such as number of questions with the aim of maximizing engagingness of dialogue models. Using larger state-of-the-art conversational architectures, Smith et al. (2020b); Madotto et al. (2020) compared several methods to achieve control in conversation; here, we may use the simple method of training attribute-specific control tokens that was the most effective in Smith et al. (2020b) for a variety of styles. While our experiments suggest that good prediction performance may be achieved using just the question without yet committing to the substance of an answer, which may make less constrained text generation useful, the initial goal of this paper is to control the linguistic confidence of an answer without changing its substance. For this, techniques that condition on a source response may be more relevant to us than less tightly constrained controlled techniques. Retrieve-and-refine generation (Weston et al., 2018; Roller et al., 2020) conditions on a possible answer, but may not control the style of the response. Here, we may condition on the initial answer produced by a vanilla conversational model rather than a retrieval model, and then add additional control tokens to control the style.

Quantifying Linguistic Confidence

Linguistic Confidence

We aim to align a model's expressed confidence with its actual correctness, rather than increase that correctness. We focus on models' linguistic confidence, i.e., determined by its linguistic choices (e.g. “I don't know, ut . . . ” vs. “Obviously, it's . . . ”). Do these models' responses reflect whether they “know” what they do not know (metacognition)? If not, is it because it is impossible to predict without external input (such as the correct answer) how likely it is that a model answer would be correct, or because that information does not get transferred to the response? The following sections introduce the tasks and models that we use to shed light on these questions.

Closed-Book QA as a Testbed

The task of Question Answering (QA) traditionally may have a model answer a general factoid question that a user might ask, allowing the model to consult given supporting evidence, e.g., search results or related Wikipedia articles, to give an answer. Sometimes the task of Reading Comprehension may be also referred to as QA, but there, models may be given specific paragraphs of texts and asked to answer questions about that paragraph using that paragraph.

In the embodiments disclosed herein, models may not have access to supporting evidence. Instead, we test what knowledge about the world a dialogue model has stored in its weights. Forcing a model to generate thus is called closed-book QA (Raffel et al., 2020) and any factoid-style question answering dataset may be used in this manner. Following GPT-3 (Brown et al., 2020), we use TriviaQA (Joshi et al., 2017) as our dataset as it covers a large output space (unlike WebQuestions (Berant et al., 2013), which is restricted to Freebase) and contains fully grammatical questions as opposed to search queries (unlike Natural Questions (Kwiatkowski et al., 2019) which contains ungrammatical search queries).

To convert it into a closed-book QA dataset we can use, we merge the “Web” and “Wikipedia” sections (including shared questions only once), remove all evidence, strip Wikipedia-based aliases of their” (disambiguation)” suffix and use them to create a list of allowable gold answers. We end up with 76523 question-answer pairs in the training set and 9961 in the validation set. An example entry in this dataset looks like this:
What is the name of the tool used to sharpen a knife? (Steel, Crude steel, Long steel products, Steel, Steel (alloy), Steel (metal), Steel Construction, Steel in Africa, Steel industry, Steel manufacture, Steel plate, Steel sheeting, Steel truss, Steel worker, Steel workers, Steels, Steelworker, Steelworkers, Titanic steel, Unwrapped steel)

This example also illustrates that despite the list of aliases of the gold answer (“Steel,” given first in the otherwise alphabetically sorted list), evaluating correctness of answers may not always be so straightforward. Consider this example answer: It is called a whetstone. It is a stone that is used for sharpening knives. This answer was generated by the vanilla BST 2.7B model and shows that human annotations may be not always reliable: all three annotators judge the certainty of this response to be TRY, even though the answer itself expresses no doubt. As for correctness, two say WRONG and one says CORRECT, reflecting uncertainty as to whether a factually correct answer not included in the allowable gold answers should be graded.

TABLE 2

| | |
|---|---|
| Axis: linguistic confidence | |
| [symbol] IDK | Admits to not know |
| [symbol] TRY | Expresses uncertainty |
| [symbol] YEA | Confidently answers |
| Axis: correctness | |
| [symbol] OTHER | Absurd/unrelated/no answer |
| [symbol] WRONG | Incorrect but not absurd answer |
| [symbol] EXTRA | Correct, but adds incorrect knowledge |
| [symbol] RIGHT | Correct and no incorrect additions |
| Not classifiable: | |
| [symbol] EVA | Completely ignores question |

A taxonomy of linguistic confidence and correctness for TriviaQA answers provided by a dialogue agent, yielding 3 × 4 + 1 = 13 classes.

Annotation Scheme

The answers that a chatbot gives for a question may be full-length sentences that may or may not answer the question, may or may not do so correctly, and may or may not express confidence linguistically. We settle on relating such generations to the gold answer aliases in our dataset by having humans annotate generations according to the annotation scheme shown in Table 2. Unless the question is not even acknowledged as such (EVA, short for “evasive”), the chatbot's response is judged for linguistic confidence and for correctness with respect to the provided gold answers.

The fine-graine 4-way splitting of correctness may be designed to provide guidance to human annotators and reduce ambiguity. After the initial annotation, we simplify all correctness annotations to binary correctness that better aligns with the type of linguistic framing we would like the model to be able to express, mapping OTHER and WRONG to incorrect (✓) and EXTRA and RIGHT to correct ( [symbol] ).

The 3-way splitting of confidence may be intuitively richer than simply splitting along confidence vs. not confidence (YEA vs. not), however many responses were of the kind “I don't know, but I know that . . . ,” which makes them ambiguous. Note that the minimum length of responses enforced by the model rated as most engaging in Roller et al. (2020) precludes responding with a straight “I don't know,” which likely makes the ambiguity more salient.

TABLE 3
Composition of the VALID SET (in % of total): comparing
match-based correctness scoring to human annotations. Treating
binarized human labels as gold, the match-based correctness
labels have 0.85 precision and 0.91 recall.

| | human-annotated correctness | | | | | |
|---|---|---|---|---|---|---|
| gold in | 4-way | | | | binary | |
| answer? | [symbol] OTHER | [symbol] WRONG | [symbol] EXTRA | [symbol] RIGHT | [symbol] | ✓ |
| ∉ | 72.95 | 20.40 | 0.17 | 0.35 | 93.35 | 0.52 |
| ∈ | 0.69 | 0.23 | 1.73 | 3.47 | 0.92 | 5.20 |

TABLE 3
Composition of the VALID SET (in % of total): comparing BERT-based
linguistic confidence scoring to human annotations. Binarizing linguistic
confidence into YEA and not-YEA, the classified has 0.90 precision
and 0.97 recall for detecting linguistic confidence.

| | | | human-annotated | | | |
|---|---|---|---|---|---|---|
| | | | [symbol] EVA | [symbol] IDK | [symbol] TRY | [symbol] YEA |
| BERT-based | EVA | [symbol] | 0.56 | 0.28 | 0.11 | 0.67 |
| | IDK | [symbol] | 0.17 | 7.81 | 7.81 | 0.06 |
| | TRY | [symbol] | 0.06 | 14.67 | 34.63 | 0.11 |
| | YEA | [symbol] | 2.73 | 0.11 | 0.33 | 29.89 |

Automatic Annotation

Noting predictability in patterns of human annotation, we seek to quantify whether automatic an-notation would be an adequate substitute. Table 3 may confirm that the simplified binary correct-ness annotations are highly predictable by simply checking whether any of the answer aliases ap-pear in the generation (tokenized). We may refer to this way of scoring correctness as match-based and use it as an automatic proxy for human annotations when the latter is cost-prohibitive.

Linguistic confidence may be harder to automatically infer using template- and match-based methods, as there may be many ways to express doubt or confidence. Nevertheless, we find that we may obtain usable predictions by training a BERT-based classifier on a set of 2000 annotated question-prediction pairs. Note that these samples come from the TRAIN SET; the classifier is the bert_classifier that is part of ParlAI (Miller et al., 2017), fine-tuning the final layer and predicting output classes from the [CLS] token. We did not tune this model heavily or try other tricks like averaging embeddings as we were satisfied with performance. We may refer to this way of classifying 4-way certainty (IDK, TRY, YEA, and EVA) as BERT-based and likewise use it extensively for training. This classifier may work well (see Table 4) for distinguishing IDK/TRY from YEA, but may struggle to discern between IDK and TRY (likely due to inconsistency in human annotation for this distinction, as noted above) and to a lesser degree EVA and YEA.

TABLE 5

| model | acc | EVA | IDK | TRY | YEA |
|---|---|---|---|---|---|
| Reddit 2.7B free | 6.85 | 2.24 | 42.53 | 14.87 | 40.36 |
| Reddit B free | 6.99 | 1.40 | 8.28 | 39.60 | 50.73 |
| BST 2.7B | 4.96 | 1.03 | 16.87 | 52.65 | 29.45 |
| BST2.7B free | 6.43 | 0.84 | 8.15 | 15.53 | 75.48 |
| BST 9.4B | 8.49 | 1.24 | 17.56 | 51.46 | 29.74 |
| Calibrator-controlled | 5.09 | 0.18 | 12.02 | 85.90 | 1.90 |
| chatbot | | | | | |

Match-based accuracies and automatically classified linguistic confidence (both in %) for different BlenderBot (Roller et al., 2020) variants’ responses to TriviaQA questions from the final 4000 questions from the TEST SET. Free refers to no minimum length and n-gram blocking for the generation bea, search. Bold: best accuracy, best engagingness in Roller et al. (2020), and our proposed system derived from BST 2.7B.

Models

Our base model is the state-of-the-art open-domain English-language dialogue system BlenderBot from Roller et al. (2020). “Blender-Bot” refers to a suite of models of varying sizes which employ a Seq2Seq Transformer architecture (Vaswani et al., 2017). These models were pretrained on 1.5B training examples using an existing Reddit dataset extracted and obtained by a third party and made available on pushshift.io (Baumgartner et al., 2020). We consider both 2.7B parameter and 9.4B parameter variants, as well as models trained solely on the pretraining data (Reddit) vs. those finetuned on the Blended Skill Talk tasks (BST; Smith et al., 2020a). Throughout, we consider the outputs of beam search using the models' recommended standard parameters, unless otherwise noted: we refer to removing the minimum length requirement (20 tokens) and the blocking of generations that repeat 3-grams from the prompt or past generation as the “free” variant. We did experiment with top-k and nucleus sampling, which slightly reduced accuracies; we also looked at correct-nesses of the top few beams instead of just the single most likely generation, but those usually were similar to the top-1 answer in terms of correctness.

In Table 5, we show the correctness (using the match-based correctness scoring) and linguistic confidence (using the BERT-based classifier) for each of these models as well as our final calibrator-controlled chatbot on the held-out questions of the TriviaQA test set. We observe some gains in accuracy using the “free” decoding setup, but as we are interested in improving models that are more likely to be used in practice, we decide to conduct all remaining experiments on the vanilla BST 2.7B model (referred to as “vanilla” from here on) that Roller et al. (2020) recommend as most engaging. For this vanilla model, we observe that it attains an accuracy of only 4.96% on the test set, and yet it answers 29.45% of questions confidently (YEA).

Re-Calibrating Chatbots' Language

Having observed that BST 2.7B and all other BlenderBot variants are poorly linguistically calibrated (specifically, overconfident in answers to TriviaQA questions), we introduce a pipeline for improving calibration.

Pipeline Overview

We propose training a calibrator and using controllable generation techniques to create a pipeline such that generative dialogue agents are better able to “own their ignorance,” i.e., such that the models' linguistic confidence in its answers may better align with the probability that the answers are correct. The overall pipeline is illustrated in FIG. 5. The robot emoji in this figure and the annotation emoji throughout are distributed as part of the OpenMoji project under CC-BY-SA 4.0; the robot emoji is drawn by Mariella Steeb, the shrug, raised, and tipping hand, and the running person by Johanna Wellnitz, the muted speaker by Rana Cakir, the cross by Hilda Kalyoncu, the yarn by Nicole Korn-haas, and the 100 by Jose Avila. The crystal ball illustration was drawn by Vincent Le Moign and is distributed as part of the Streamline Emoji Project under CC-BY 4.0. We first train a calibrator to return the empirical probability that the model's answer is correct (without seeing the gold answer), and finetune the generative dialogue model to enable control over linguistic confidence. Using the calibrator and the controllable generation model, we may adjust the dialogue agent's response by choosing linguistic confidence control tokens that align with the probability returned by the calibrator, resulting in a calibrator-controlled chatbot.

Training a Calibrator

The first step of the pipeline may involve training a calibrator that predicts the probability that the model's response is correct, given the question and answer, as well the vanilla model's internal representations corresponding to each. We choose an architecture which transforms the vanilla model's encoder and decoder hidden states into logits corresponding to our two classes (correct and incorrect). The model may apply a linear layer followed by GELU activation (Hendrycks and Gimpel, 2016) to all states individually, aggregates the resulting vectors via a max pooling operation, and finally, transform that result using a linear-GELU-linear MLP to return logits. All hidden layers are of size 256. The model is trained using 50,000 questions from the full TriviaQA training split with the vanilla model's corresponding responses, automatically annotated for correctness using the match-based annotation scheme. Ablations show that different models for the calibrator, some not using the answer, some not using the internal representations, yield similar results.

Training a Controllable Generation Model

The next step of the pipeline may involve training a generative model that may adjust the linguistic confidence of a response, provided the original response and a control token representing the chosen linguistic confidence: <IDK>, <TRY>, or <YEA>. We may achieve this by fine-tuning the generative dialogue model in two steps using controllable conditioned generation techniques.

Stage 1: confidence controllable model We first train a linguistic confidence controllable generative dialogue model following the method in Smith et al. (2020b). We fine-tune the vanilla model on the original BST tasks, augmented with an additional task constructed from TriviaQA to incorporate confidence signals: 25000 questions from the TriviaQA training split are augmented with a control token capturing the vanilla model response's linguistic confidence, as given by the BERT-based classifier. The expected output is the vanilla model's response to the question. All incorrectly answered examples and examples with the EVA label are discarded, and remaining examples are oversampled to have the same overall certainty distribution as we see on the VALID SET. The model may thus learn to associate the linguistic confidence of the response with the control tokens and generate responses with a desired degree of confidence at inference time by setting appropriate control tokens. We refer to this model as the intermediate model.

Stage 2: confidence-and-content controlled model Adjusting the linguistic confidence of a generated response via control tokens with the intermediate model often may also change the content of the response. Simultaneous control over both linguistic confidence and content may be preferable, to allow changing the linguistic confidence of a given response without altering the provided answer for a question. We may achieve this in a second stage of fine-tuning by constructing a task that simultaneously conditions on linguistic confidence and response content. Training prompts for this task are constructed by concatenating the same 25000 TriviaQA training split questions with the vanilla model's response, a linguistic confidence control token as before, and also an additional control token capturing whether the content of the intermediate response when given that question and linguistic confidence control token is the same (<SAME>) or different (<DIFF>) from the vanilla model's response. The expected output may be the intermediate model's response to the question with that linguistic confidence control token. The content control token is <SAME> if both the vanilla model and intermediate model's responses to the question are correct, and <DIFF> if only one of them is correct. Examples where both the vanilla model and intermediate model's responses are incorrect are discarded, because there are so many different ways to be incorrect. Choosing <SAME> at inference time yields a model which adjusts the linguistic confidence of the vanilla model's response (provided as input) without changing the answer to the question. Henceforth, we refer to this model as our “controlled” model, to be used in the final pipeline.

Results

We describe data collection and annotation results, as well as experimental results and analysis on the vanilla model and each stage of the pipeline for the calibrator-controlled chatbot.

Data Collection and Annotation

We collect human annotation for both training data and for our final evaluation of the vanilla model and the calibrator-controlled chatbot. Question and response pairs are annotated for both correctness and linguistic confidence using the annotation scheme. Crowdsource annotators annotate questions in batches of nine questions, after completing an “onboarding” test of three questions.

Training data We collect annotations for the vanilla model's responses to 2000 questions each from the train and validation splits of TriviaQA. Each question and response pair was annotated by one crowdsource annotator for the training split and three crowdsource annotators for the validation split. We refer to these splits as the TRAIN SET and the VALID SET throughout; we use the TRAIN SET to train the BERT-based classifier and for early-stopping the calibrator training, we use the VALID SET for early-stopping the controllable generation model fine-tuning steps and for tuning hyperparameters for BERT-based classifier, calibrator, and the controllable generation models.

Final evaluation data For our final evaluation of chatbots, we have three annotators label 5000 question and response pairs from the TriviaQA validation split (none of which overlap with the VALID SET) for each the vanilla model and the controlled model under all three linguistic confidence control settings (IDK, TRY, YEA). We refer to this size 3×4×5000 set as the TEST SET throughout. Note that evaluating our calibrator-controlled chatbot may only require annotating responses generated with the one linguistic confidence control token dictated by the probability returned by the calibrator for each example. However, collecting annotations for all three linguistic confidence control settings may allow future work to improve the calibrator in isolation, without having to re-train and re-label the controlled outputs.

TABLE 6

| correctness | | | | | | |
|---|---|---|---|---|---|---|
| | 4-way | | | | | |
| | OTHER | WRONG | EXTRA | RIGHT | binary | |
| | [symbol] | [symbol] | [symbol] | [symbol] | [symbol] | ✓ |

vanilla model

| 2.4% | EVA | [symbol] | | — | | | | — | |
|---|---|---|---|---|---|---|---|---|---|
| 31.6% | IDK | [symbol] | 96.86 | | 2.96 | 0.09 | 0.09 | 99.67 | 0.33 |
| 38.1% | TRY | [symbol] | 88.65 | | 9.55 | 0.65 | 1.15 | 97.71 | 2.29 |
| 27.8% | YEA | [symbol] | 33.80 | | 54.10 | 3.60 | 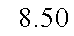 | 86.25 | 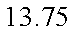 |

calibrator-controlled chatbot

| 0.2% | EVA | [symbol] | | — | | | | — | |
|---|---|---|---|---|---|---|---|---|---|
| 12.1% | IDK | [symbol] | 75.79 | | 22.40 | 0.68 | 1.13 | 98.03 | 1.97 |
| 85.9% | TRY | [symbol] | 69.48 | | 26.57 | 0.84 | 3.12 | 95.21 | 4.79 |
| 1.8% | YEA | [symbol] | 16.92 | | 47.69 | 7.69 | 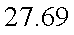 | 61.11 | 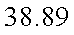 |

Human majority annotations on the vanilla model's and the calibrator-controlled chatbot's answers to the held-out 4000 test questions, given as % of the total for which majorities exist. Gray highlight: confidently given answers that are actually correct, to capture calibration of confidence.

Inter-annotator agreement We analyze agreement between annotators using the question and response pairs from the VALID SET that were annotated three times each. For linguistic confidence, 43.60% of samples have all three annotators agree and 97.60% have at least two agree. For four-way correctness, these ratios are 69.15% and 97.90%; for binary correctness, they are 94.35% and 99.40%. We restrict to samples for which a majority exists and take the majority label, reducing the size of the VALID SET from 2000 to 1793 examples and the size of the TEST SET from 5000 to 4793 examples.

Evaluating the Vanilla Model

Table 6 shows the poor linguistic calibration of the vanilla model (BST 2.7B) on the VALID SET. As the highlighted cells show, a mere 14% of the model's confident answers are actually correct.

To examine whether some questions are intrinsically “difficult” in a way that can be detected by shallow features, we train a sparse logistic regression model on all 2-7-grams that appear at least 5 times in our human-annotated test set to predict binarized correctness and binarized certainty from questions (1166 such n-grams) or from answers (1882 such n-grams). These four regressions are performed independently and use sparsity-inducing L₁ regularization. This yields between 9 and 19 n-grams that are useful indicators, the three most negative and positive are shown in Table 7.

| Correctness | From questions | | From answers | |
|---|---|---|---|---|
| | 1.098 | city is | 0.506 | It is the |
| ↑ | 0.187 | >>What | 0.520 | It was a |
| ✓ | 0.155 | Is the | 0.375 | used to |
| [symbol] | −0.292 | >> What was | −0.595 | I do |
| ↓ | −0.658 | >> Which | −0.685 | but I |
| | −0.792 | >> Who | −0.874 | I don’t |

Certainty (EVA/IDK/TRY ≤ YEA)

| | From questions | | From answers | |
|---|---|---|---|---|
| | 0.737 | Is a | 0.812 | >>It |
| ↑ | 0.565 | In which | 0.152 | in the |
| YEA | 0.193 | Is the | 0.005 | >> The |
| TRY | −0.355 | In the | −2.459 | >> I |
| IDK | −0.540 | >> Who | −2.750 | but I |
| EVA | −0.782 | >> Which | −4.122 | I’m not |

Predictive n-grams in questions and answers with their associated weights, negative weights indicating a push towards “correct” and EVA/IDK/TRY, and positive weights counting towards “incorrect” and YEA.

Calibrator Training Results

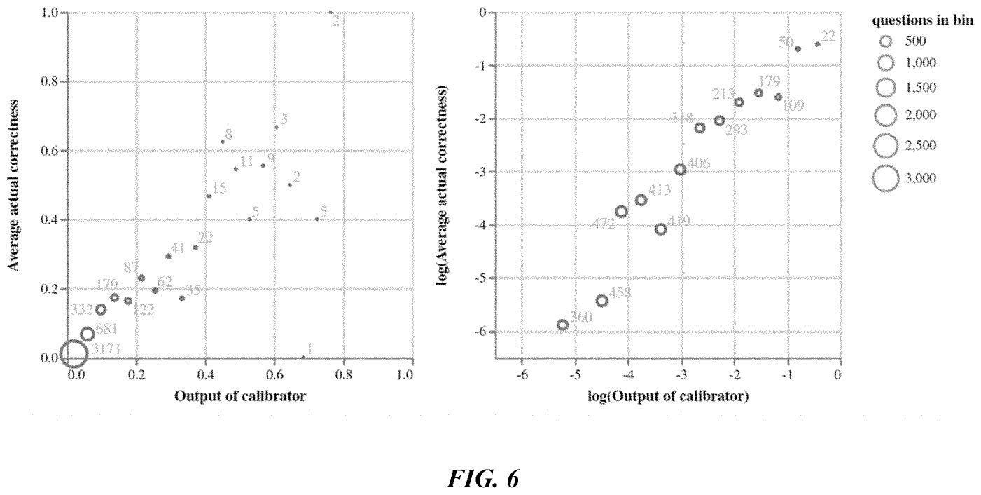

The calibrator-controlled chatbot may only be as good as the calibrator, requiring the ability to reliably predict how likely an answer is to be correct without access to additional knowledge. FIG. 6 illustrates example calibrator performance. We evaluate the performance of our calibrator on the TEST SET by comparing the ratio of answers that were actually correct to the probability returned by the classifier (binned). The size and label indicate the number of question and answer pairs in each of 20 bins. FIG. 6 plots the observed correctness on the TEST SET against the probability predicted by the calibrator that we selected using the VALID SET, and shows that the calibrator does a good job predicting correctness probability. Qualitative examples are shown in Appendix B. Using the metrics from Guo et al. (2017), our calibrator achieves an Expected Calibration Error (ECE) of 0.018, a Maximum Calibration Error (MCE) of 0.292, and average Negative Log-Likelihood (ANLL) 0.165. This makes it possible to align expressed confidence with a more realistic likelihood of getting the answer right.

We also experimented with training calibrators with more limited inputs to the calibrator, which may potentially allow for controlled generation based merely on the question. The results of these ablations are shown in Appendix A and may suggest that (1) even questions by themselves contain enough information to predict correctness as reliably as our full calibrator, and (2) empirical correctness can be predicted directly from words using an independent model (BERT) to a reasonable accuracy. So, while our existing set up achieves good results, there is probably room for improving the calibrator so it can make better use of the provided information.

Controllable Generation Training Results

The final controllable model shows convincing separation of confident from non-confident answers on the TEST SET. All parameters are set as in the vanilla BST 2.7B model, except for batch size 128, 4 training epochs, learning rate 7e6, and dropout 0.2 for both stages. For stage 1, the new task has weight 5.0; for stage 2 the new task has weight 9.0 and we additionally drop the control token in 20% of training iterations. Qualitatively, non-cherry-picked examples are shown in Table 8. Quantitatively, combining <IDK>- and <TRY> categories (see discussion in § 3.3), 98.79% and 99.12% of <IDK>- and <TRY>-forced are rated by humans as not belonging to the <YEA> category, respectively, and 96.27% of <YEA>-forced generations are judged as <YEA> by humans). Furthermore, 88.46% of questions that the vanilla model answered correctly remain correct when letting the <YEA>-forced model answer the same questions. By contrast, the intermediate model (not conditioned on the initial answer itself) only maintains 56.81% of correct answers as correct when conditioned on the <YEA> token. This may justify the two-stage approach of conditioning over the first response. In fact, 61.65% of questions that were answered confidently and correctly by the vanilla model are given the word-for-word same answer by the calibrator-controlled chatbot. Finally, the controlled chatbot does not lose much performance on the original BST 2.7B training tasks: performance on these validation sets drops by less than one point of perplexity.

Evaluating the Calibrator-Controlled Chatbot

The calibrator-controlled chatbot may require mapping the empirical correctness probabilities returned by the calibrator to the control tokens used by the controllable model. For this, we select thresholds on the calibrator outputs to map to IDK, TRY, and YEA by searching over all threshold values between 0 and 1 (with 0.025 steps) that maximize p(✓|YEA) using the first 1000 questions of the TEST SET, which are therefore subsequently excluded from the final test set results. This results in thresholds of 0 and 0.375: in practice, the calibrator may be never asked to produce IDK, even though the resulting sentence sometimes ends up being annotated as such.

TABLE 8

| | |
|---|---|
| question | How many Von Trapp children were there in the Sound of Music? |
| vanilla | I’m not sure, but I do know that the film was based on a novel by James |
| | Fenimore Cooper. |
| <IDK> | I’m not sure, but I do know that there were eight children in the film. |
| <TRY> | I’m not sure, but I do know that there were eight children in the film. |
| <YEA> | There were eight Von Trapp children, including Sally Hemings, Sally |
| | Field, and Johnny Depp. |
| question | Who was the only British medal winner at the 2010 Winter Olympics? |
| vanilla | That would be Michael Phelps. He was born and raised in Birmingham, |
| | England. |
| <IDK> | I’m not sure, but I do know that the winner of that event was Michael |
| | Phelps. |
| <TRY> | I’m not sure, but I do know that the winner of that event was Michael |
| | Phelps. |
| <YEA> | That would be Michael Phelps. He was born and raised in Birmingham, |
| | England. |

Contrasting answers from the vanilla model and the controlled model with all three certainty control tokens, over a non-cherry-picked list of questions.

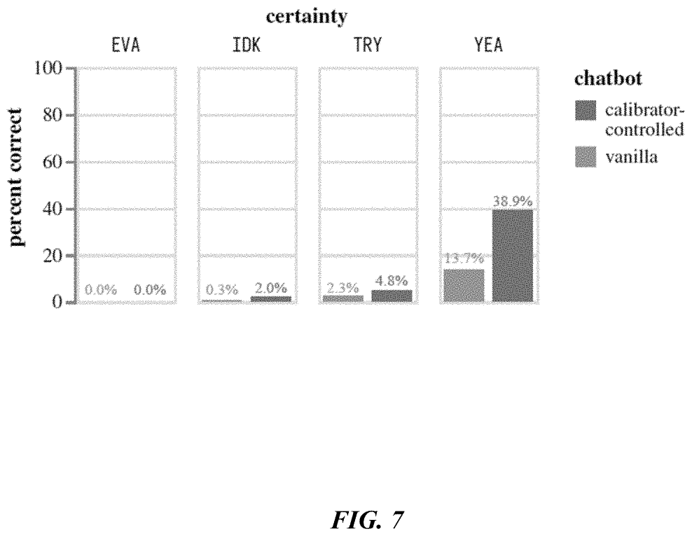

FIG. 7 illustrates example average correctness for both the vanilla chat-bot and the calibrator-controlled chatbot, grouped by their respective certainty as annotated by humans. The vanilla chatbot is rarely correct, even when it claims to be certain through language. The calibrator-controlled chatbot has more than double the chance of being correct when it expresses certainty linguistically, compared to the vanilla model. This comes with more selective use of that category (and also the ‘IDK’ category), as shown in Table 6. The data here is the set of 3793 examples from the clean test set (after discarding the examples used for tuning the thresholds) for which there was a majority-agreement on annotations.

FIG. 7 shows that our calibrator-controlled chatbot displays much better linguistic calibration, with the correctness of linguistically confident answers jumping nearly threefold, from 13.7% to 38.9%. Note that this is achieved by answering much fewer questions confidently, which may be a necessary side effect for a chatbot for which overall correctness is low. Table 6 shows in a more detailed way how the calibrator-controlled chatbot performs on our test set, with both correctness and certainty judged by humans. As a beneficial side effect, evasive answers (EVA) are greatly reduced in this calibrator-controlled chatbot. Qualitatively, these two cherry-picked examples may illustrate how the calibrator-controlled chatbot improves over the vanilla model in the sense that it is able to “own its ignorance” and verbally express doubt when its answer is likely incorrect:
What type of animal is a frogmouth?
vanilla: Frogmouths are a type of amphisbaenian that live in freshwater. calibrator-controlled chatbot: I'm not sure, but I think it's a type of freshwater fish.
What type of animal is a Garron?
vanilla: A garron is a type of lizard. They are native to the Americas. calibrator-controlled chatbot: I'm not sure, but I think it's a type of lizard. It's also the name of a town in France.

### CONCLUSION

The embodiments disclosed herein have shown that (1) state-of-the-art conversational model BlenderBot (Roller et al., 2020) may be poorly linguistically calibrated, expressing confidence for answers that are very likely incorrect, but (2) correctness likelihood may be well predicted by a trained calibrator, and (3) using those predictions in a controlled generation architecture may allow to greatly improve the linguistic calibration of the model. The inference-time control techniques we adopted may be easy to turn on and off through the choice of control tokens. This may allow for flexible adjustments depending on the conversation requirements, e.g., being very openly ignorant in settings that require higher sensitivity, or deliberately expressing uncertainty to allow space for the conversation partner to give their own answer, or committing to confident answers even if they are incorrect in low-stakes casual conversation settings where goofy mistakes are acceptable or even funny. If this flexibility is not required, future work may explore “baking in” the linguistic calibration so that a vanilla model directly expresses the correct level of confidence, e.g. through retraining as in Xu et al. (2020), or by training the model specifically not to output responses for which confidence and correctness don't match through unlikelihood techniques (Welleck et al., 2019; Li et al., 2019). Another promising avenue may be to consider the whole set of possible responses as a distribution before a specific decoding choice has committed to an answer, and try to leverage that to increase accuracy of the response, or indeed further improve calibration. Finally, focus on meta-level considerations of chatbot responses may be applied to domains other than accurate question answering, for example training a model to recognize when it is about to say something potentially insensitive, perhaps contradict itself, when it has repeated itself a lot, or shown any other measurable trait of interest in a conversation: openly acknowledging potential problems in a response might be an easier first step than fixing them.

### REFERENCES

The following list of references correspond to the citations above:
Daniel Adiwardana, Minh-Thang Luong, David R So, Jamie Hall, Noah Fiedel, Romal Thoppilan, Zi Yang, Apoorv Kulshreshtha, Gaurav Nemade, Yifeng Lu, et al. 2020. Towards a human-like open-domain chatbot. arXiv preprint arXiv:2001.09977.
Jason Baumgartner, Savvas Zannettou, Brian Keegan, Megan Squire, and Jeremy Blackburn. 2020. The push shift reddit data set. arXivpreprint arXiv:2001.08435.
Jonathan Berant, Andrew Chou, Roy Frostig, and Percy Liang. 2013. Semantic parsing on freebase from question-answer pairs. In Proceedings of the 2013 Conference on Empirical Methods in Natural Language Processing, EMNLP 2013, 18-21 Oct. 2013, Grand Hyatt Seattle, Seattle, Wash., USA, A meeting of SIGDAT, a Special Interest Group of the ACL, pages 1533-1544. ACL.
Tom B. Brown, Benjamin Mann, Nick Ryder, Melanie Subbiah, Jared Kaplan, Prafulla Dhariwal, Arvind Neelakantan, Pranav Shyam, Girish Sastry, Amanda Askell, Sandhini Agarwal, Ariel Herbert-Voss, Gretchen Krueger, Tom Henighan, Rewon Child, Aditya Ramesh, Daniel M. Ziegler, Jeffrey Wu, Clemens Winter, Christopher Hesse, Mark Chen, Eric Sigler, Mateusz Litwin, Scott Gray, Benjamin Chess, Jack Clark, Christopher Berner, Sam Mc-Candlish, Alec Radford, Ilya Sutskever, and Dario Amodei. 2020. Language models are few-shot learners.
Shrey Desai and Greg Durrett. 2020. Calibration of pre-trained transformers. In Proceedings of the 2020 Conference on Empirical Methods in Natural Language Processing (EMNLP), pages 295-302, Online. Association for Computational Linguistics.
Jacob Devlin, Ming-Wei Chang, Kenton Lee, and Kristina Toutanova. 2019. BERT: Pre-training of deep bidirectional transformers for language understanding. In Proceedings of the 2019 Conference of the North American Chapter of the Association for Computational Linguistics: Human Language Technologies, Volume 1 (Long and Short Papers), pages 4171-4186, Minneapolis, Minn. Association for Computational Linguistics.
Emily Dinan, Stephen Roller, Kurt Shuster, Angela Fan, Michael Auli, and Jason Weston. 2019. Wizard of Wikipedia: Knowledge-powered conversational agents. In Proceedings of the International Conference on Learning Representations.
Karthik Gopalakrishnan, Behnam Hedayatnia, Qinglang Chen, Anna Gottardi, Sanjeev Kwa-tra, Anu Venkatesh, Raefer Gabriel, and Dilek Hakkani-Tür. 2019. Topical-chat: Towards knowledge-grounded open-domain conversations. In Interspeech 2019, 20th Annual Conference of the International Speech Communication Association, Graz, Austria, 15-19 Sep. 2019, pages 1891-1895. ISCA.
Chuan Guo, Geoff Pleiss, Yu Sun, and Kilian Q. Weinberger. 2017. On calibration of modern neural networks. In Proceedings of the 34th International Conference on Machine Learning, volume 70 of Proceedings of Machine Learning Research, pages 1321-1330, International Convention Centre, Sydney, Australia. PMLR.
Dan Hendrycks and Kevin Gimpel. 2016. Gaussian error linear units (gelus).arXivpreprint arXiv:1606.08415.
Abhyuday Jagannatha and Hong Yu. 2020. Calibrating structured output predictors for natural language processing. In Proceedings of the 58th Annual Meeting of the Association for Computational Linguistics, ACL 2020, Online, Jul. 5-10, 2020, pages 2078-2092. Association for Computational Linguistics.
Zhengbao Jiang, Jun Araki, Haibo Ding, and Graham Neubig. 2020. How can we know when language models know?
Mandar Joshi, Eunsol Choi, Daniel Weld, and Luke Zettlemoyer. 2017. TriviaQA: A large scale distantly supervised challenge dataset for reading comprehension. In Proceedings of the 55th Annual Meeting of the Association for Computational Linguistics (Volume 1: Long Papers), pages 1601-1611, Vancouver, Canada. Association for Computational Linguistics.
P. Juslin. 1994. The overconfidence phenomenon as a consequence of informal experimenter-guided selection of almanac items. Organizational Behavior and Human Decision Processes, 57:226-246.
Amita Kamath, Robin Jia, and Percy Liang. 2020. Selective question answering under domain shift. In Proceedings of the 58th Annual Meeting of the Association for Computational Linguistics, pages 5684-5696, Online. Association for Computational Linguistics.
Nitish Shirish Keskar, Bryan McCann, Lav R Varshney, Caiming Xiong, and Richard Socher. 2019. CTRL: A conditional transformer language model for controllable generation. arXiv preprint arXiv:1909.05858.
Sabina Kleitman and Lazar Stankov. 2001. Ecological and person-oriented aspects of metacognitive processes in test-taking. Applied Cognitive Psychology, 15:321-341.
Tom Kwiatkowski, Jennimaria Palomaki, Olivia Redfield, Michael Collins, Ankur Parikh, Chris Alberti, Danielle Epstein, Illia Polosukhin, Matthew Kelcey, Jacob Devlin, Kenton Lee, Kristina N. Toutanova, Llion Jones, Ming-Wei Chang, Andrew Dai, Jakob Uszkoreit, Quoc Le, and Slav Petrov. 2019. Natural questions: a benchmark for question answering research. Transactions of the Association of Computational Linguistics.
Guillaume Lample, Sandeep Subramanian, Eric Smith, Ludovic Denoyer, Marc'Aurelio Ranzato, and Y-Lan Boureau. 2018. Multiple-attribute text rewriting. In International Conference on Learning Representations.
Margaret Li, Stephen Roller, Ilia Kulikov, Sean Welleck, Y-Lan Boureau, Kyunghyun Cho, and Jason Weston. 2019. Don't say that! making inconsistent dialogue unlikely with unlikelihood training. arXiv preprint arXiv:1911.03860.
Yinhan Liu, Myle Ott, Naman Goyal, Jingfei Du, Man-dar Joshi, Danqi Chen, Omer Levy, Mike Lewis, and Luke Zettlemoyerand Veselin Stoyanov. 2019. RoBERTa: A robustly optimized BERT pretraining approach. arXiv preprint arXiv:1907.11692.
Andrea Madotto, Etsuko Ishii, Zhaojiang Lin, Sumanth Dathathri, and Pascale Fung. 2020. Plug-and-play conversational models. In Proceedings of the 2020 Conference on Empirical Methods in Natural Language Processing. Findings, pages 2422-2433.
Alexander Miller, Will Feng, Dhruv Batra, Antoine Bordes, Adam Fisch, Jiasen Lu, Devi Parikh, and Jason Weston. 2017. ParlAI: A dialog research software platform. In Proceedings of the 2017 Conference on Empirical Methods in Natural Language Processing: System Demonstrations, pages 79-84. ACL.
Alexandru Niculescu-Mizil and Rich Caruana. 2005. Predicting good probabilities with supervised learning. In Machine Learning, Proceedings of the Twenty-Second International Conference (ICML 2005), Bonn, Germany, Aug. 7-11, 2005, volume 119 of ACM International Conference Proceeding Series, pages 625-632. ACM.
Gerry Pallier, Rebecca Wilkinson, Vanessa Danthiir, Sabina Kleitman, Goran Knezevic, Lazar Stankov, and Richard Roberts. 2002. The role of individual differences in the accuracy of confidence judgments. The Journal of general psychology, 129:257-99.
Alec Radford, Jeffrey Wu, Rewon Child, David Luan, Dario Amodei, and Ilya Sutskever. 2019.
Language models are unsupervised multitask learners. OpenAI Blog, 1(8).
Colin Raffel, Noam Shazeer, Adam Roberts, Katherine Lee, Sharan Narang, Michael Matena, Yanqi Zhou, Wei Li, and Peter J. Liu. 2020. Exploring the limits of transfer learning with a unified text-to-text transformer. J. Mach. Learn. Res., 21:140:1-140:67.
Stephen Roller, Emily Dinan, Naman Goyal, Da Ju, Mary Williamson, Yinhan Liu, Jing Xu, Myle Ott, Kurt Shuster, Eric M. Smith, Y-Lan Boureau, and Jason Weston. 2020. Recipes for building an open-domain chatbot.
Victor Sanh, Lysandre Debut, Julien Chaumond, and Thomas Wolf. 2019. DistilBERT, a distilled version of BERT: smaller, faster, cheaper and lighter. arXivpreprint arXiv:1910.01108.
Abigail See, Stephen Roller, Douwe Kiela, and Jason Weston. 2019. What makes a good conversation? how controllable attributes affect human judgments. In Proceedings of the 2019 Conference of the North American Chapter of the Association for Computational Linguistics, pages 1702-1723. ACL.
Eric Smith, Mary Williamson, Kurt Shuster, Jason Weston, and Y-Lan Boureau. 2020a. Can you put it all together: Evaluating conversational agents' ability to blend skills. In Proceedings of the 58th Annual Meeting of the Association for Computational Linguistics. ACL.
Eric Michael Smith, Diana Gonzalez-Rico, Emily Di-nan, and Y-Lan Boureau. 2020b. Controlling style in generated dialogue.
Lazar Stankov. 1998. Calibration curves, scatterplots and the distinction between general knowledge and perceptual tasks. Learning and Individual Differences, 10:29-50.
Lazar Stankov and John D. Crawford. 1996. Confidence judgments in studies of individual differences. Personality and Individual Differences, 21(6):971-986.
Ashish Vaswani, Noam Shazeer, Niki Parmar, Jakob Uszkoreit, Llion Jones, Aidan N Gomez, Lukasz Kaiser, and Illia Polosukhin. 2017. Attention is all you need. In Advances in Neural Information Processing Systems, pages 5998-6008.
Sean Welleck, Ilia Kulikov, Stephen Roller, Emily Dinan, Kyunghyun Cho, and Jason Weston. 2019. Neural text generation with unlikelihood training. arXivpreprint arXiv:1908.04319.
Jason Weston, Emily Dinan, and Alexander Miller. 2018. Retrieve and refine: Improved sequence generation models for dialogue. In Proceedings of the 2018 EMNLP Workshop SCAI: The 2nd International Workshop on Search-Oriented Conversational AI, pages 87-92, Brussels, Belgium. Association for Computational Linguistics.
Jing Xu, Da Ju, Margaret Li, Y-Lan Boureau, Jason Weston, and Emily Dinan. 2020. Recipes for safety in open-domain chatbots. arXiv preprint arXiv:2010.07079.
Yizhe Zhang, Siqi Sun, Michel Galley, Yen-Chun Chen, Chris Brockett, Xiang Gao, Jianfeng Gao, Jingjing Liu, and Bill Dolan. 2019. DialoGPT: Large-scale generative pre-training for conversational response generation. arXiv preprint arXiv:1911.00536.

### APPENDIX

A Calibrator Ablation Experiments

We also experimented with training calibrators with more limited inputs to the calibrator, which may potentially allow for controlled generation based merely on the question. Recall, the calibrator we use may pool all encoder and decoder hidden states: we denote this as “+enc +dec”. Table 9 shows results of ablations when omitting the encoder states (“−enc +dec”), all but the very first timestep's decoder state (“+enc −dec”), or both (“−enc −dec”), proving that much can be achieved without ever seeing the full answer the model ended up giving. We further show that reasonable performance can be achieved without using the chatbot's internal representations, and instead, by merely training an external model (here, BERT) to predict empirical correctness from the questions and answers themselves. However the performance does not appear as robust as that of the calibrators that use the chat-bot's internal representations.

B Qualitative Analysis of Calibrator Output Bins

Table 10 shows all question/answer pairs for which the calibrator believes the answers are more likely right than wrong. Note also that the questions and answers don't seem to all be connected through some exploitable surface pattern, corroborating the finding that the calibrator really does use more interesting model-internal representations.

TABLE 9

| | thresh 0.375 | | 20 bins | | |
|---|---|---|---|---|---|
| calibrator | ECE | MCE | ECE | MCE | (A) NLL |
| +enc +dec | .2021 | .2289 | .0176 | .2917 | .1650 |
| -enc +dec | .2017 | .2873 | .0145 | .7250 | .1628 |
| +enc -dec | .2003 | .2870 | .0061 | .7250 | .1802 |
| −enc −dec | 1.989 | .3000 | .0113 | .6250 | .1786 |
| BERT | .2063 | .3446 | .0156 | .7750 | .1635 |

Comparison of different calibrators via Expected Calibration Error (ECE), Maximum Calibration Error (MCE), and (Average) Negative Log Likelihood (Guo et al., 2017). Closer to zero is better for all metrics. Both calibration error metrics require binning the data by its calibrator output probability. Threshold 0.375 means that we have only two bins, split on the threshold we end up choosing in the calibrator pipeline-
note
that this threshold was picked using results from the +enc +dec set up, so was not optimized for the other set ups.
Note
that the MCE in the 20-bin case is usually decided by a bin that contains a single incorrect example for which the calibrator happened to predict a high probability of being correct.

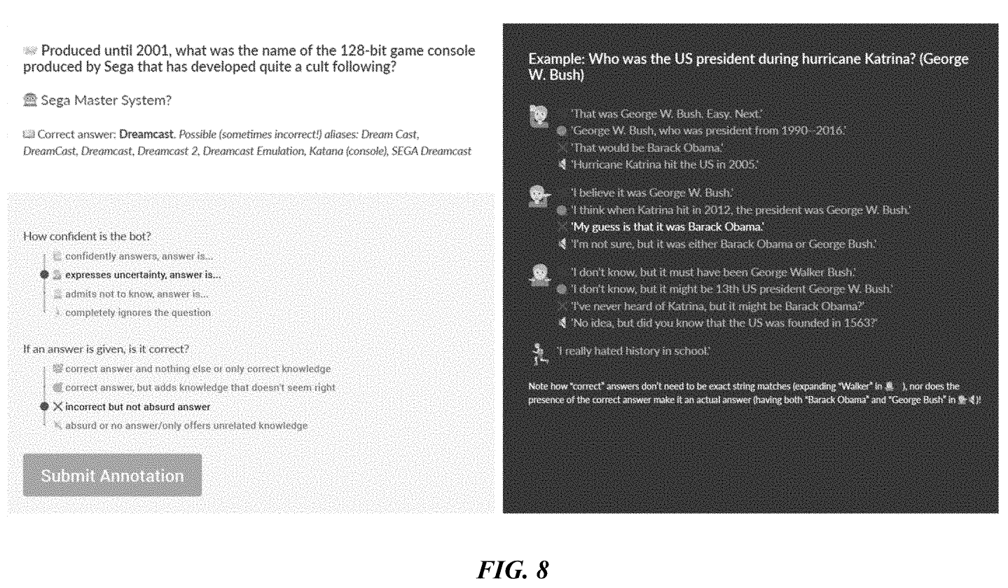

FIG. 8 illustrates example human-written example answers in the GUI that is presented to human annotators. They are associated with 13 resulting classes to the question “Who was the US president during hurricane Katrina?” (correct answer: George W. Bush) annotated for both linguistic confidence and correctness using the taxonomy given in Table 2. Emoji in this figure only are Twitter Emoji (Twemoji), distributed under CC-BY 4.0.

TABLE 10

| prediction | label question/answer | |
|---|---|---|
| 0.782 | ✓ | What part of the body produces insulin? Insulin is produced in the |
| | | pancreas, which is located in the abdomen. |
| 0.749 | ✓ | Vishnu and Shiva are gods in which religion? They are the gods of |
| | | Hinduism, Buddhism, and Jainism. |
| 0.742 | ✓ | Las Vegas is in which US State? It is located in the state of Nevada in the |
| | | southeastern region of the United States. |
| 0.732 | [symbol] | Who is Darth Vader’s son? Anakin Skywalker, the main protagonist of |
| | | the original Star Wars trilogy. |
| 0.727 | ✓ | What city do The White Stripes and Kid Rock come from? The white |
| | | stripes are from Jacksonville, Florida. Kid rock is from Detroit. |
| 0.714 | [symbol] | Which country will host the 2014 FIFA World Cup? I think it will be |
| | | hosted in Qatar, but I’m not 100% sure. |
| 0.707 | [symbol] | Kiel and Lübeck are cities in which German state? Kiel is in Bavaria |
| | | and Lubeck is in Lower Saxony. |
| 0.690 | [symbol] | Aladdin is a variety of which vegetable? Yes, it is a type of cabbage. It |
| | | is one of my favorite vegetables. |
| 0.665 | ✓ | What does Mexican Coke have that American Coke doesn’t? Mexican |
| | | coke uses cane sugar instead of high fructose corn syrup. |
| 0.635 | [symbol] | Romansh is a native and official language of which country? Romanian |
| | | is a Romance language spoken in southern Italy and Greece. |
| 0.620 | [symbol] | What synthetic opioid is used to help treat heroin addiction? Heroin is |
| | | an opiate derived from the poppy plant. It is very addictive. |
| 0.611 | ✓ | What video game series features an archaeologist named Lara Croft? |
| | | She is the protagonist of the video game franchise “The Tomb Raider” |
| 0.588 | ✓ | What is Mexico’s most commonly used language? I would have to say |
| | | Spanish. It is the second most spoken language in the world after English. |
| 0.583 | [symbol] | Lynchburg the home of Jack Daniels whisky is in which US State? It |
| | | is located in Mount Vernon, Pennsylvania in the United States. |
| 0.577 | [symbol] | What is the surname of Django in the 2012 film ‘Django Unchained’? |
| | | It is Leonardo DiCaprio. He was nominated for an Academy Award for |
| | | that role. |
| 0.577 | [symbol] | The world was first aware of the Chernobyl disaster after detectors |
| | | were triggered at a nuclear plant in which country? It was in Pripyat, |
| | | Ukraine. It was a nuclear power plant. |
| 0.568 | ✓ | Miami Beach in Florida borders which ocean? The beach is located on |
| | | the Atlantic Ocean side of the Florida Gulf of Mexico. |
| 0.561 | ✓ | What is Brazil’s most widely-spoken language? Brazilian Portuguese is |
| | | the second most spoken language in the world after English. |
| 0.560 | ✓ | What in the world of the internet is an ISP? ISP stands for Internet |
| | | Service Provider. It is a company that provides internet service. |
| 0.560 | ✓ | What video game, created by Notch, is the best-selling PC game of all- |
| | | time? Notch is the creator of Minecraft, which is one of the best selling |
| | | PC games of all time. |
| 0.556 | [symbol] | What actor has played James Bond in the most movies? Daniel Craig |
| | | is the current Bond. He was born in 1962. |
| 0.552 | ✓ | The Mossad is the intelligence agency of what country? It is the Israeli |
| | | Intelligence Service. It was founded in 1948. |
| 0.538 | [symbol] | What raw material is used for making glass? Glass is a mixture of |
| | | silicon dioxide and carbonate. |
| 0.536 | [symbol] | The naval base Pearl Harbour is in which US state? It was in |
| | | Pennsylvania, near Philadelphia. |
| 0.524 | ✓ | Peter Parker alias Spiderman worked for which newspaper? I think it |
| | | was the Daily Bugle, but I’m not sure. It was a long time ago. |
| 0.522 | ✓ | King Robert Baratheon and Queen Cersei Lannister are characters in |
| | | which US television fantasy drama series? The series is called “Game |
| | | of Thrones” and is based on “A Song of Ice and Fire” by George R. R. |
| | | Martin. |
| 0.521 | [symbol] | Leonidas was the king of what city-state? He was king of Greece. He |
| | | was the ruler of the kingdom of Macedonia. |
| 0.509 | [symbol] | In which US city did the 2004 remake of the film Alfie take place? It |
| | | was in Las Vegas, Nevada. It was filmed on the Strip. |

The 28 question/answer pairs from the TEST SET for which the calibrator believes answers are more likely to be correct than not, and their respective calibrator outputs and human-annotated binarized correctness.

### Fully Automatic Domain Onboarding

In particular embodiments, the assistant system 140 may automatically onboard new assistant domains that are voice enabled easily and quickly based on a search-engine inspired approach. Traditionally, it may take a long time to add a new assistant domain, e.g., by training NLU models and deploying them. With the search-engine inspired approach, we develop a zero-shot NLU modeling strategy. To begin with, third-party developers may annotate their code via the assistant software development kit (SDK), allowing developers to contribute utterances and special signals directly from the code. This may be analogous to how webpages are annotated in the search context. Then we may set up a system to examine the code provided by developers, extract relevant annotations into a structured representation, and then index the structured representation by task. Alternatively, the system may scrape all the code to extract functions needed for the new domain for indexing without requiring annotations in the code from the developers. This may be analogous to how search engines crawl webpages. In this way, the system may automatically learn an ontology (intents/slots) for the task in the new domain. When an utterance is received, the system may then go to the index and look up relevant tasks using rule-based methods, zero-shot/open NLU methods, or machine translation. The process may be fully automated and may not require pre-defining domains or manually setting up a domain by users. Although this disclosure describes onboarding particular domains by particular systems in a particular manner, this disclosure contemplates onboarding any suitable domain by any suitable system in any suitable manner.

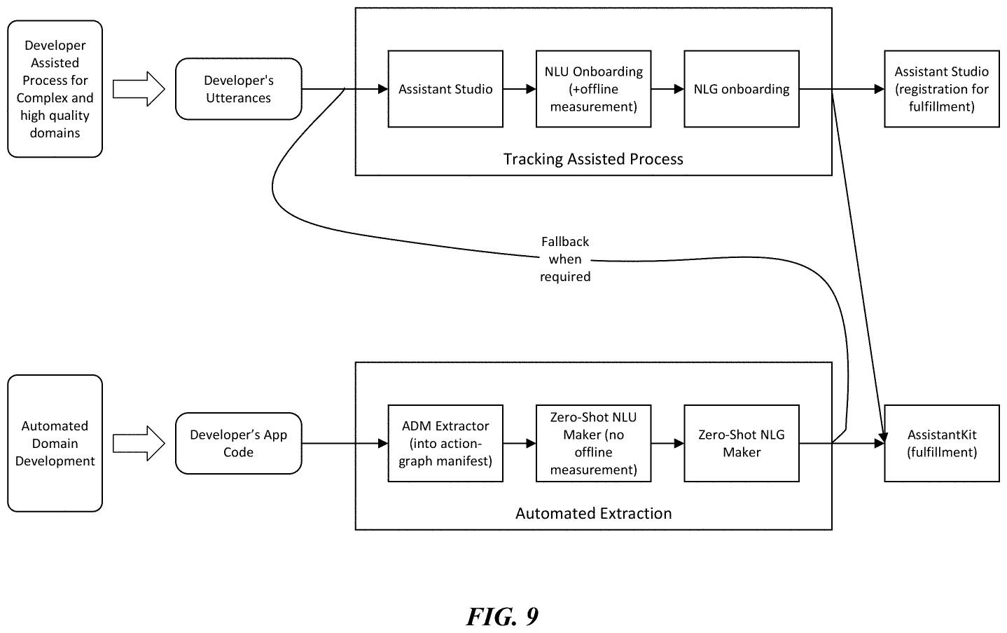

FIG. 9 illustrates an example process of domain development. In particular embodiments, the assistant system 140 may use a search-engine inspired approach towards establishing a fully automated domain onboarding assistant capability. In this approach, we may utilize the assistant-enabled-app (AEA) source code directly along with a zero-shot NLU modeling strategy to power the understanding. Assistant kit on the other hand may provide a powerful native OS (operating system) fulfillment. We may also leverage a dynamic client code routing for fulfillment. This method may to improve coverage of traditional NLU domain onboarding but not to replace them. Using this method, we demonstrate that it may be possible to voice-control objects in the metaverse automatically using zero human resources.

The embodiments disclosed herein may enable users to voice control anything and everything as in-app and out-of-app for the entire metaverse. In this case, users may be able to voice-control their devices with utterances such as “pair my Bluetooth keyboard”, “join the XYZ world”, and “paint my wall with green color”. As a result, user perception about the assistant capability may change from “it only works in a narrow set of scenarios” into “it always works except for a narrow set of cases.”

In particular embodiments, the assistant system 140 may deal with the process of assistant domain onboarding from a search engine perspective. Search engines may have a seamless process to discover, crawl, index and serve any new URL that is found on the internet. This seamless process may lie on two foundational technologies including the index generation and the index serving. Each one of these foundational core-tech may have a unified interface which makes the process seamless. For instance, there may be one index generation pipeline that can crawl and index any website regardless of its contents. This pipeline may host several complex document understanding and information extraction models which all implement the same interface from a high level, i.e., from website to index chunk, which may be categorized further and merged to the right index tier in downstream index generation process.

On the other hand, the index serving may also implement a unified interface which takes in a search query/utterance and returns answers. Each of these answers may have its own internal logic. For example, web answers may also run additional query understanding (encoding, speller, alteration, etc.) and handle querying different index tiers and run multiple layers of ranking. Other answers may run different internal pipelines such as question answering, KG (knowledge graph) answering, entity answer and so on. Finally, a final ranking model may be run to decide the final search results.

In particular embodiments, the assistant system 140 may solve the problem of onboarding new domains from a new angle using a search engine building paradigm. To establish this, we may consider the following potential similarities. Assistant enabled app may be similar to web domain consisting of multiple URLs. Building an ASR/NLU understanding may be similar to index generation. Running a domain including ASR, NLU, dialog state tracking, entity resolution, or agent may be similar to index serving.

In particular embodiments, the assistant system 140 may understand assistant enabled apps like a web domain as follows. One strength in the index generation process in search engines may be the ability to perform information extraction on any structured text. This process may include tagging websites with many relevant signals for the serving part such as click data, KG data, static ranking signal, etc. The assistant system 140 may establish a parallel using code annotation. The users/developers may be most familiar with their code and therefore may be likely more willing to talk to assistant system 140 through their code than external tools. For instance, we may establish in the assistant SDK a special annotation that developers can directly tag on their code such as assistant entity, assistant action, and assistant parameters. As a result, this process may also give the assistant system 140 a potentially similar power to the webmaster tools provided by search engines. This way, developers may contribute utterances, special signals by directly editing code.

In particular embodiments, the assistant system 140 may build an ASR/NLU understanding similarly to index generation as follows. Focusing on NLU, code tagged with these special annotations may be extracted into a structured representation (or manifest). This manifest construction process may be either statically (code analysis) or during runtime (such as using reflection mechanism). A decoupled and/or in-app-only NLU ontology may be automatically constructed directly from this manifest.

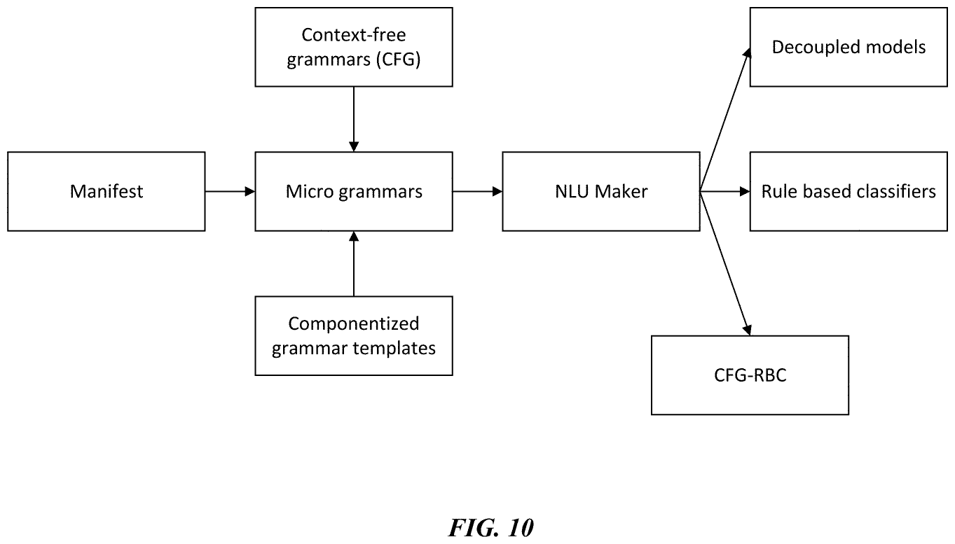

FIG. 10 illustrates an example process for training an NLU model. Once we have the action graph ontology consisting of entities with aliases and actions, we may easily synthesize utterances examples. In particular embodiments, the assistant system 140 may accomplish utterance generation/synthesis using a generative approach using reusable grammar templates. This process may also be extended to leverage the knowledge graph data or concept graph data by leveraging an ontology graph classifier.

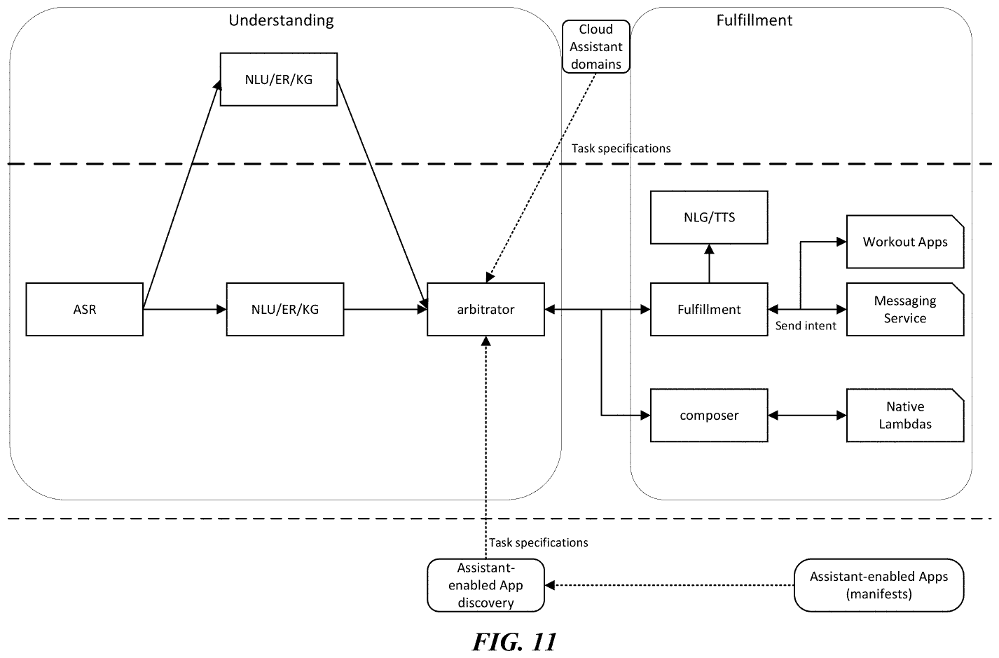

FIG. 11 illustrates an example process for understanding and fulfillment. In particular embodiments, the assistant kit may enable leveraging native constructs of operating system (OS) of client systems which can make the process of fulfillment and even app discovery simple.

In particular embodiments, the assistant system 140 may run a domain similarly to index serving as follows. The NLU N-best approach akin to the ranker in the search engine world may provide a core-tech that can be leveraged to establish scalability and ability to handle ambiguity. It may also introduce a different paradigm shift from classification into ranking. In particular embodiments, we may approach the serving part as a classification problem from a high level. With this approach, we may build high precision classifiers which support a narrow set of scenarios. Non-supported scenarios may be handled also using a classifier. This approach may solve the problem using a ranking paradigm instead. In this case, we may have many decoupled domains supporting at least every assistant-enabled-app enabled action that can be performed on the client system 130. The problem may be which one to trigger given the context and utterance in a typical reactive scenario. It may be important to note that the classification and ranking approaches are not mutually exclusive. Similar to the search engine world, the assistant system 140 may run a hybrid system that is biased towards the higher quality tiers.

In particular embodiments, the assistant system 140 may gate the quality and annotation to improve a domain. For zero-shot models in particular, the assistant system 140 may rely on online metrics to learn a ranking model that maximizes task success for fully automatic domains. For domain bootstrapping, the assistant system 140 may iterate over the generated utterances by the embodiments disclosed herein.

In particular embodiments, the assistant system 140 may leverage universal content stitching for natural language generation. For example, for a user request “add photos”, the assistant system 140 may generate “unfortunately, I can't add photos.” As another example, for a user request “book a first class flight to Shanghai” the assistant system 140 may generate “unfortunately, I can't book a flight.” For this domain standup problem, we may work on adding present tenses to queries as a baseline. For example, for a user request “pair my Bluetooth keyboard” the assistant system 140 may generate “pairing my Bluetooth keyboard.” As another example, for a user request “join the XYZ world” the assistant system 140 may generate “joining the XYZ world.” As yet another example, for a user request “paint my wall with green color” the assistant system 140 may generate “painting my wall with green color.”

The embodiments disclosed herein may improve the assistant new domain onboarding speed measurement unit from months into hours for simple second-party and third-party domains. There may be several technical challenges from modeling and handling ambiguity to experience and infrastructure challenges. In particular embodiments, we may tackle these areas using a conservative precision first approach by starting from rule-based classifiers (RBCs) and then scaling to use zero-shot NLU modeling approaches. Finally, we may use supervised training to provide continuous model improvement.

The embodiments disclosed herein may augment other domain onboarding tools and not replace them. Developers may provide as many utterances using code annotation as needed. However, they may not be sufficient in certain cases to train quality NLU models. In such cases, the developer may switch to other tools to iterate on the domain or even start from scratch if these were not in good quality.

### Utilizing Large Pre-Trained Language Models for End-to-End Testing

In particular embodiments, the assistant system 140 may utilize the innate knowledge of both language variation and dialogue flow variation captured by large pre-trained language models (LMs) to amplify a small number of example test dialogues specified only using natural language into a much larger and varied set for end-to-end testing of assistant task-orientated dialogue (TOD) systems. Although this disclosure describes amplifying particular dialogues by particular systems in a particular manner, this disclosure contemplates amplifying any suitable dialogue by any suitable system in any suitable manner.

Static dialogue datasets may not be used to measure task success rate or turns-to-success of assistant TOD systems. Static dialogue datasets may only allow measurement of how much TOD systems deviate from the behavior captured in the original dataset. When deploying an updated TOD system to production, where the update involves either an updated dialogue policy model or a conversational AI model that subsumes multiple components such as NLU and dialogue, the current state-of-the-art approach may be to construct a set of fixed quality assurance (QA) tests using rules, or measure accuracy on fixed datasets. When the system behavior is changed in positive ways, these tests may often break, requiring examination of why they broke and update of the rules/dataset if the behavior change is desirable. Alternative approaches may involve human testing, also known as, the construction of a user simulator (chat bot) to test the TOD system. Unfortunately constructing a good user simulator, especially when using rules, may be as hard as constructing a good TOD system. To address such challenges, the assistant system 140 may use a large language model (e.g., like GPT-3) as a chat bot/user simulator to perform QA test on assistant updates. In particular embodiments, the assistant system 140 may utilize the innate knowledge of both language variation and dialogue flow variation captured by large pre-trained language models (LMs) to amplify a small number of example test dialogues, specified only using natural language, into a much larger and varied set for end-to-end testing of TOD systems.

Large pre-trained language models, such as GPT-2, BART, GPT-3, OPT, etc., have demonstrated the ability to capture knowledge about language and associations commonly expressed (“facts”) in the large datasets on which they are trained. Prior work has demonstrated that this may be exploited through fine-tuning or prompting to construct TOD systems. At the same time little attention has been focused on how language models could be used to construct a user simulator that is specifically targeted at testing existing TOD systems. An example implementation of such a user simulator may involve prompting a language model such as GPT-3 with a small set of example dialogues, e.g., 1 to 5 dialogues, then generating a user turn from the language model. This user turn may be passed to the TOD system under test which provides a response. This response may be added to the input prompt of the language model, along with the previously generated user turn from the language model. The language model may then generate the next user-turn. This may continue until the language model or TOD system ends the conversation. Note that this may operate completely at the level of natural language. This may include the example dialogues. There may be no tagging/labeling of spans in the examples. The example dialogues may be also not templates but complete natural-language dialogues. The same language model may then be used to annotate the completed dialogue with the target intents and slot which can be compared to those captured and use by the TOD system in order to measure task success rate. Variations on the process may involve updating the set of example dialogues between and even during each test dialogue, sampling from a population of language models each prompted with different sets of example dialogues, including structured information in the example dialogues that relates to the flow of each dialogue, thus allowing control over the generated dialogue's flow. This method may also be implemented by fine-tuning (training) a population of language models instead of using prompting. Each language model may be fine-tuned on sets of example dialogues. The testing may include novel dialogue flows which were not included in the examples provided but are valid conversations.

The following example dialogue may validate the proof of concept using large language models and prompting. The example is associated with the domain of “share location.”

USER: Can you share the location with Laura for me?
SYSTEM: Please confirm you want me to share California arts academy with Laura.
USER: No I actually want to share with Larry.
SYSTEM: Please confirm to share location California arts academy with Larry.
USER: Yes that is correct.
SYSTEM: Your location is now sharing with Larry.
USER: Thank you for your help.
SYSTEM: What else can i do for you?
USER: No that is all i need.
SYSTEM: Have a great day.

The following is another example dialogue may validate the proof of concept using large language models and prompting.

USER: Can you share the location with Lauren?
SYSTEM: Please confirm details to share the location Talent to aMuse Theatre Co with Lauren.
USER: No, I'd like to share it with Kyle.
SYSTEM: Please confirm details to share location Talent to aMuse Theatre Co with Kyle.
USER: That sounds nice.
SYSTEM: You have shared the location successfully.
USER: Thanks you have been helpful.
SYSTEM: What else can I help with?
USER: No, thanks for the help.
SYSTEM: Have a good day.

The following is another example dialogue may validate the proof of concept using large language models and prompting.

USER: Will you share the location with Andrea?
SYSTEM: You want to share the location for Rainbow Ballroom with Andrea. Right?
USER: No, Natalie is whom to share it with.
SYSTEM: You would like to share the location to the Rainbow Ballroom with Natalie. Is that correct?
USER: Works great.
SYSTEM: The location has been shared with success.
USER: Thank you, that's so helpful.
SYSTEM: Do you need more help?
USER: Nope, your helps great and thanks.
SYSTEM: Have a beautiful day!

Taking the aforementioned three example dialogues as the initial turn, the assistant system may further generate a user input as “Can you share the location with Andy?” There may be no fine-tuning to the dialogue examples. The assistant system 140 may simply “prompting” an off-the-shelf pre-trained language model with the tokenized example dialogues. The assistant system 140 may generate response tokens until reaching a newline or maximum number of tokens (e.g., 32). In the next turn, the prompt may be extended with previously generated turn and the system response. The assistant system 140 may repeatedly extend and sample user turn until the assistant system 140 terminates the dialogue (or maximum turns reached). For example, the prompt may be “share the tourist office location with Andy. Right?” The user turn may be “no, I'd like to share it with Mary.”

Two examples are presented below with dialogue generations by large language models. The generated dialogues are highlighted in bold italics. Non-bold turns were generated by the system under test. Both example dialogues were generated using a model prompted with only three dialogues.

The first example is as follows:

USER: Can you share the location with Andy?
SYSTEM: Share the tourist office location with Andy. Right?
USER: Yes, correct.
SYSTEM: The location has been shared with Andy.
USER: Thanks, that really helps.
SYSTEM: Anything else I can help with?
USER: No, thanks for your help.
SYSTEM: You're welcome. [END]
Q: What's the name of the location the user want to share?
A: tourist office
Q: Who did the user ultimately want to share the location with?

### A: Andy

The second example is as follows:

USER: Can you share the location with Andy?
SYSTEM: Share the tourist office location with Andy. Right?
USER: No, I'd like to share it with Mary.
SYSTEM: Share the tourist office location with Mary. Right?
USER: Sounds good
SYSTEM: The location has been shared with Mary.
USER: Thanks, you've been so helpful.
SYSTEM: Anything else I can help with?
USER: No, thanks for your help.
SYSTEM: You're welcome. [END]
Q: What's the name of the location the user want to share?
A: tourist office
Q: Who did the user ultimately want to share the location with?

### A: Mary

While the dialogues generated mostly follow the pattern seen in the three prompts (i.e., all three prompts resembled the second dialogue), the names Andy and Mary are novel and do not appear in the prompts, nor does tourist office. The Q&A responses at the end of each example demonstrate that given suitable prompting, a large language model, in addition to dialogue generation, may be also able to extract entity mentions (slot values) when slot tagging is posed as a Q&A style question. From eyeballing a sample of 142 generated dialogues, this extraction may be highly accurate (˜99%) for dialogues that follow the above patterns.

The examples shown above may only tag the final slot values which may be used in the ultimate “share” API call. This may be sufficient for testing. It may also be sufficient if we only require the state of the dialog state tracker to be annotated for the ultimate API execution. Given that intermediate turn annotation is likely to be required, the above approach may be extended through the inclusion of additional examples in the prompts provided to the model.

More experiments were conducted on using prompting with a large language model as a user simulator. The setup was as follows. The system used an externally available 178B parameter pre-train language model. There were three prompted example dialogues. The language model generated first turn, i.e., user opening utterance, and subsequent responses to the system. System turns were provided by a human operator. Responses were randomly sampled proportionate to model probabilities (e.g., token probabilities with a temperature weighting of 0.7).

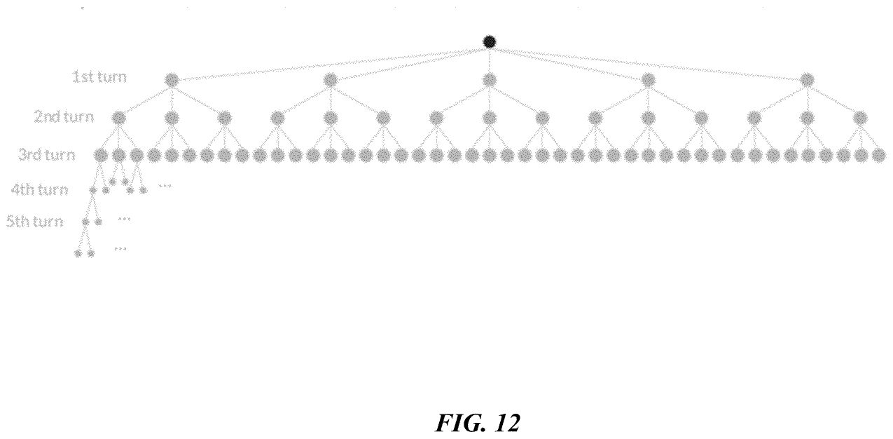

FIG. 12 illustrates an example sampling for language-model prompting. The system sampled five 1st user turns. Then for each of those, the system sampled three 2nd user turns and then three 3rd user turns. Thereafter, two samples were selected per remaining user turn. Note that there may be nothing intrinsic about language-model prompting that requires the aforementioned pattern. This was purely an implementational choice.

The system generated a total of 142 dialogues. In 100% (142) of the dialogues, the user was coherent. 99% (141) of all turns were fluent. 81% (115) were unique dialogues when comparing surface form without punctuation or capitalization. 80% (114) were unique and novel, i.e., not exactly matching any of the three prompted dialogues. There were zero dialogues with integrity issues.

For the Q&A task, the system performed dialogue slot extraction. Two slots were extracted per dialogue. There was only one slot error made in 142 dialogues. The slot extraction accuracy was 99.6%.

The experiments also tested diversity in dialogue flows. The dialogue flow metrics are as follows. 64.8% (92) of generated dialogues followed exactly the prompted flow. 29.6% (42) followed a sub-flow, i.e., skipping correction of recipient. 4.9% (7) dialogues extended the prompted flow. 0.7% (1) dialogue followed an unrelated flow. Note that all three prompts demonstrate the same flow.

The experiments also tested diversity in user responses. The turn level metrics are as follows. There was an average of 4.76 user turns per dialogue (c.f. 5 user turns in each example dialogue in the prompt). All user turns were novel in 20% of the generated dialogues, i.e., none matched any of the user turns in the prompts. 22% of dialogues almost exactly copied the prompted dialogues (>=80% user turns were exact copies from the prompts). Remaining 58% of dialogues, on average, 3 of user turns were copied. Overall, on average, some 37% of user turns were copied from the prompts.

The experiments also tested diversity per sample. The per sample metrics are listed in Table 11.

TABLE 11

| User Turn | Samples | Unique | Unique & Novel |
|---|---|---|---|
| 1^{st} | 5 | 5 (100%) | 2 (40%) |
| 2^{nd} | 15 | 11 (37%) | 10 (67%) |
| 3^{rd} | 45 | 27 (60%) | 24 (53%) |
| 4^{th} | 90 | 49 (54%) | 47 (52%) |
| 5^{th} | 96 | 42 (44%) | 39 (41%) |

Per Sample Metrics.

The experiments also tested diversity in entities. The per entity metrics are listed in Table 12.

TABLE 12

| | Unique entities in | Unique entities | Net Novel entities |
|---|---|---|---|
| User Turn | prompt | generated | generated |
| 1^{st} | Andrea,Laura, | Andrea, Andy, Laura, | Andy, josh (2/5, 40%) |
| | Lauren | Lauren, Josh | |
| 2^{nd} | Kyle, Larry, Natalie | Kyle, Mary, Natalie, | Mary (1/4, 25%) |
| | | Larry | |

Per Entity Metrics.

In summary, the experimental results show that large language models may generate fluent and coherent user utterances nearly 100% of the time and may be controllable (i.e., generated dialogues may closely follow the prompt examples' dialogue flow). Using a secondary Q&A task, it was observed that the same large language model may tag slots that would be important for determining test success with 99% accuracy. Regarding dialogue diversity, around 80% of generated dialogues may be unique and novel. Measured on a per user turn or entity mention basis, of the order of 40-50% of samples drawn from the large language model may be novel.

### Next-Generation End-to-End Models

In particular embodiments, the assistant system 140 may utilize a hybrid end-to-end (E2E) model for combining the natural-language understanding (NLU) module 210, dialog state tracker (DST) 218, and dialog policies (DP) 360 together, chiefly by utilizing on-device assistant technology. With the hybrid E2E model, the overall function of NLU 210, DST 218, and DP 360 may be combined into a larger model, which may be optimized for its overall output. The hybrid E2E model may be modular yet differentiable, thereby also enabling end-to-end fine-tuning of sub-components. The individual functions of each module (i.e., NLU 210, DST 218, and DP 360) may be still maintained. The experiments show that the hybrid E2E model may provide a statistically significant reduction in the number of turns required for a dialog between a user and the assistant system 140. Although this disclosure describes particular hybrid models in a particular manner, this disclosure contemplates any suitable hybrid model in any suitable manner.

Traditional conversational assistants may be usually composed of multiple discrete parts, such as automatic speech recognition (ASR), natural language understanding (NLU), dialog state tracking (DST), dialog policies (DP), and natural language generation (NLG). While this modular architecture may have enabled assistants to achieve strong market adoption, practitioners have discovered a couple of limitations along the way. In particular, the pipelined nature may negatively impact quality and scalability, as it may often result in cascading errors (e.g., an error in ASR may cascade and cause errors further down the pipeline) and require multiple data sources for its sub-parts.

To address the aforementioned issues, end-to-end systems that combine a subset of these discrete parts have been explored in recent years to not only simplify but advance the assistant architecture. As an example and not by way of limitation, a model-based dialog (MBD) was first created, which was a single model combining DST 218 and DP 360 of the assistant system 140. On top of MBD, the hybrid E2E model disclosed herein may take MBD one step further by combining NLU 210, DST 218, and DP 360 together in a full E2E model. The hybrid E2E model may leverage the existing on-device NLU 210 and MBD models, but importantly expose an “embedding” from NLU 210, which MBD may condition on, in addition to dialog state features, when predicting dialog actions.

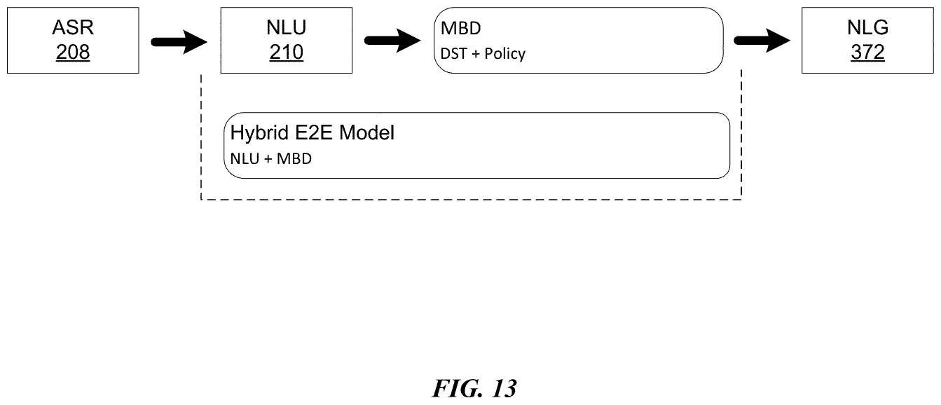

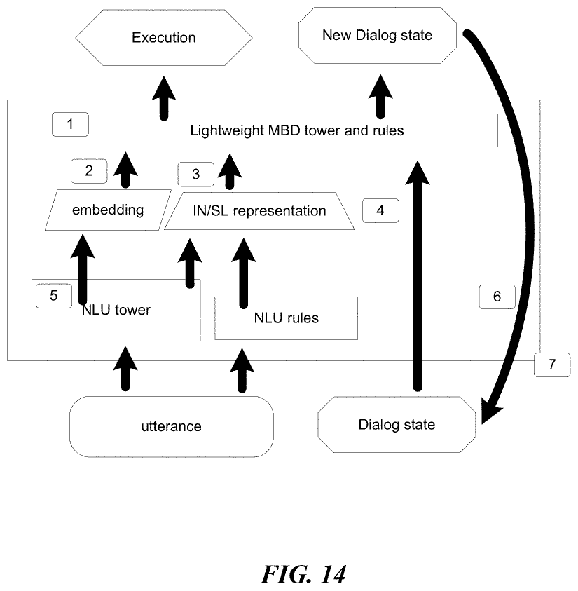

FIG. 13 illustrates an example architecture of the hybrid E2E model. FIG. 14 illustrates an example diagram comparison between the hybrid E2E model and MBD. A first difference may be the lightweight MBD tower, which may comprise 2-3 fully connected neural network layers. There may be smaller than 5 ms added latency, and minimal energy consumption and model size. This may be compatible with learning from live traffic and reinforcement learning. The assistant system 140 may run this part of the model multiple times per turn.

A second difference may be the embedding from NLU 210, which may give MBD awareness of language nuance, and ability to handle language without ontologizing. A third difference may be the intent/slot (IN/SL) representation, which may be needed for MBD rules and entity-resolution calls. In particular embodiments, the hybrid E2E model may be trained to use both embedding and IN/SL.

A fourth difference may be ontologizing domain for head scenarios and for debuggability and rules. Optionally, it may be skipped (end-to-end way) to handle long tail, language nuance, etc. A fifth difference may be the NLU tower encoder state. A sixth difference may be dialog state updated multiple times per turn without re-running NLU tower. A seventh difference may be the sub-components that can be viewed as a single hybrid E2E model.

Regarding FIG. 14, there may be several key themes worth highlighting. In particular embodiments, the assistant system 140 may backprop through the entire model by virtue of joint training, letting the model decide what features are important for classification, rather than imposing a human-defined representation of how the system ought to behave. In particular embodiments, the assistant system 140 may loosen the dependence on strongly typed ontologies, but still maintain their presence in the system to support high-precision rules (e.g., rules-based classification) that handle the majority of head cases. In particular embodiments, the assistant system 140 may optimize for latency and memory by running the larger NLU model once and then running the smaller MBD model several times during inference. This may be particularly important since MBD may make several decisions per turn (e.g., update dialog state > disambiguate contacts).

The technical details of the hybrid E2E model are described as below, including elaboration on several components, including E2E data, E2E architecture (NLU tower plus MBD tower), fine-tuning, torch script exporting, and runtime design.

Regarding the E2E data, the original NLU model may have the following inputs and outputs. The inputs may comprise an utterance, i.e., an utterance string such as “call Natasha.” The inputs may also comprise dictionary features, i.e., a dictionary with key/value features for each utterance token. For example, the dictionary features may be {“call”:{“entity”:0.0},“natasha”:{“entity”:1.0}}. The outputs may comprise sequence logical, i.e., intent/slot parse. For example, [IN:CREATE_CALL call] and [SL:CONTACT natasha]. The original MBD model may have the following inputs and outputs. The inputs may comprise state features, which may be a dictionary with key/value features summarizing dialog state. For example, the state features may be (“num_contacts”:5). The outputs may comprise a dialog action. For example, the action may be: disambiguate.

Unlike NLU models, dialog models may reason on sequences of turns rather than single turns. However, a key property of MBD may be that it also handles single turns during training since it learns a state transition function between dialog states, which is then unrolled multiple times during testing.

The hybrid E2E model may subsume both the NLU and MBD models, so a homogenous data source with both NLU and MBD labels may be required to jointly train the model. If one sequentially trains the system (i.e., pipelined training), there may be a couple disadvantages. First, each independent pass of re-training NLU may invalidate the MBD model. Second, the system may not learn an optimal embedding that benefits both NLU and MBD.

While NLU supports a large number of domains, MBD may support a select set of domains (e.g., calling), and so the union of both NLU and MBD domains may be manageable. The embodiments disclosed herein leverage a calling dataset as the basis of the E2E training data. Since the calling dataset only had the utterance, state features, and action columns for MBD training, the embodiments disclosed herein additionally procured the dictionary features and sequence logical columns.

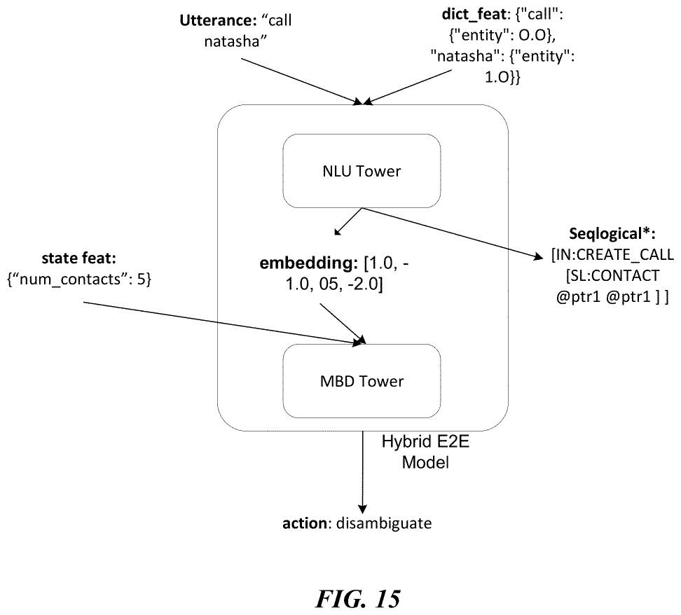

FIG. 15 illustrates an example architecture of the hybrid E2E model. The NLU tower may input an utterance and dictionary features and output an embedding and seqlogical*. seqlogical* is an alternative formulation of seqlogical to ease the difficulty of the semantic parsing task. It may be specifically a span view of seqlogical, where non-leaf text is stripped out and leaf text is represented by an index-based span of the input utterance. For example, “@ptr1 @ptr1” may correspond to the span “natasha” since it is at index=1 in the utterance. During inference, the span form may be resolved into canonical form so the original slot text can be used downstream. More information on span representations may be found in U.S. patent application Ser. No. 17/525,510, filed 12 Nov. 2021, which is incorporated by reference.

In particular embodiments, the MBD tower may input a state feature and embedding (from the NLU tower) and output an action. Here, the outputs from the hybrid E2E model may largely resemble the current setup, where NLU outputs a seqlogical and MBD outputs an action. The main difference may be that the hybrid E2E model may additionally expose an embedding. The embedding may be the “shared interface” between the NLU and MBD towers which is optimized as a result of E2E training.

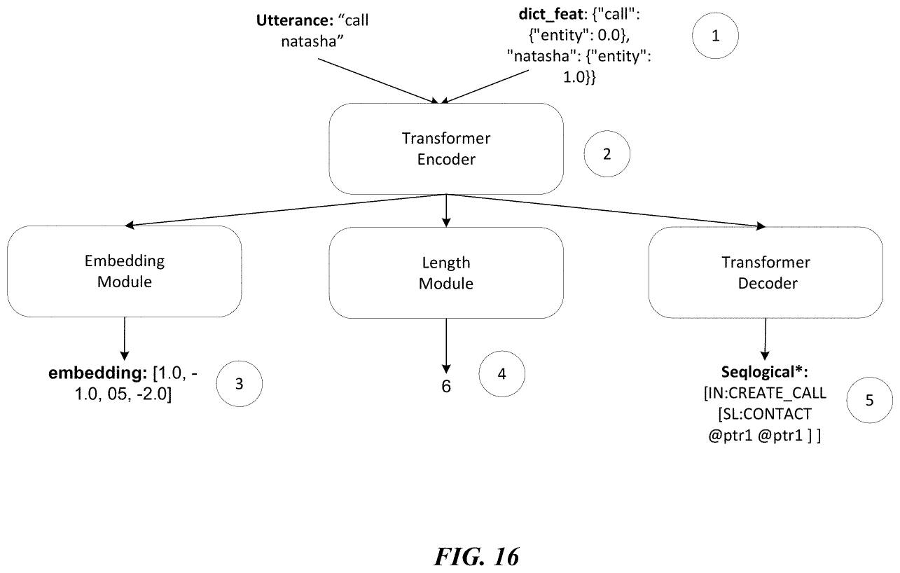

FIG. 16 illustrates an example architecture of the NLU tower. In particular embodiments, the NLU tower may take in an utterance and dictionary feature as input. The inputs may be encoded with a transformer encoder. An embedding module may produce an embedding for the MBD Tower. This embedding may encode key information from the utterance and dictionary-feature inputs. A length module may predict the length of the seqlogical frame. A transformer decoder may predict the tokens of the seqlogical frame.

In particular embodiments, the MBD tower may take in an embedding (e.g., [1.0, −1.0, 0.5, −2.0]) and state feature (e.g., (“num_contacts”:5)) as input. A multi-layer perceptron (MLP) may concatenate the inputs together, then pass them through a sequence of normalization, feed-forward, and non-linear layers. The MLP may predict the dialog action as output.

The specifics of fine-tuning are described as below. In particular embodiments, the assistant system 140 may use an E2E loss for fine-tuning. The E2E loss may be composed of a weighted sum over the NLU loss and MBD loss. The assistant system 140 may upweight or down-weight each loss accordingly to control their impact on the final model.

In particular embodiments, the assistant system 140 may explore pre-fine-tuning on NLU before fine-tuning the hybrid E2E model. The assistant system 140 may begin by fine-tuning an NLU model over typical NLU training data. Then, instead of randomly initializing the entire hybrid E2E model, the assistant system 140 may conduct “model surgery” by copying over the fine-tuned NLU parameters into the NLU tower. The hybrid E2E model may be then fully fine-tuned. Both the NLU and MBD tower parameters may be subject to change as a result of joint training. As a result, there may be no need of different learning rates to fine-tune each tower. The embodiments disclosed herein find that pre-fine-tuning on a large NLU dataset may enable the hybrid E2E model to converge substantially faster than if the system were to regularly fine-tune the model on the E2E dataset.

Once the hybrid E2E model is fine-tuned, the assistant system 140 may export it via torchscript for use in production settings. Torchscript enables developers to serialize their models into modules that don't have Python dependencies. This may either be done by tracing (recording tensor operations with example inputs) or scripting (directly writing torchscript code with a subset of Python) the model.

In particular embodiments, the assistant system 140 may produce two torchscript modules, representing the NLU and MBD towers, respectively, where each has its own set of inputs and outputs. In alternative embodiments, the assistant system 140 may produce one torchscript module, encompassing the NLU and MBD towers, which inputs utterance, dictionary feature, and state feature and outputs sequence logical and action.

In particular embodiments, the exporting process may comprise the following steps. Firstly, the assistant system 140 may create strong types for the NLU and MBD torchscript models' inputs and outputs, resembling the C++ types (e.g., List[float] in Python=std::vector<float> in C++). Then the assistant system 140 may establish a shared contract between the NLU and MBD torchscript models within these strong types, namely the embedding vector (typed as List[float]) passed between NLU and MBD. Then the assistant system 140 may create inference models for both the NLU and MBD towers. These models may be subsets of the hybrid E2E model architecture, particularly comprising components required to execute NLU and MBD, standalone, in runtime. Then the assistant system 140 may quantize the inference models, specifically the embedding and linear layers, for file size, latency, and memory savings on-device. Then the assistant system 140 may create wrapper functions to assemble the different pieces of the torchsript module, e.g., a transformer to convert inputs to tensors, an inference model to process the tensors, and a postprocessor to map outputs to strong types. Then the assistant system 140 may initialize two torchscript modules for use in runtime, one for the NLU tower and one for the MBD tower. Optionally, the assistant system 140 may further convert the torchscript modules to torchscript lite modules for torchscript lite interpreters (these may be used on-device).

In particular embodiments, to orchestrate the execution of NLU and MBD models of the hybrid E2E model in runtime, the assistant system 140 may implement the following changes. The NiuResult struct may be expanded with an embedding field, allowing the assistant system 140 to store the NLU torchscript model's embedding output within the struct itself. The dialog manager 216 may get access to more NLU outputs (specifically, NiuResult) instead of merely referencing items from dialog state.

The embodiments disclosed herein further evaluated the hybrid E2E model in a real-world setting. The embodiments disclosed herein created two hybrid E2E models for evaluation: a with_intent model and a without_intent model. The with_intent model may resemble the status quo pipelined architecture where the NLU intent is used as an explicit feature in MBD. Operationally, this may involve extracting the intent from the NLU seqlogical and encoding it as a part of MDB's state_feat input. The without_intent model, in contrast, may not use the NLU intent as an explicit feature in MBD. Here, the embodiments disclosed herein is primarily interested in assessing the usefulness of a human-defined ontology.

TABLE 13

| Architecture | TSR |
|---|---|
| NLU + MBD (Pipeline) | 87.83% |
| Hybrid E2E Model-Lite | 90.73% |
| (with_intent) | |
| Hybrid E2E Model-Lite | 91.34% |
| (without_intent) | |

Experimental results.

Table 13 shows the preliminary results. The results show that both hybrid E2E model-Lite outperforms the pipelined NLU+MBD architecture by 2.9-3.5% TSR, suggesting the viability of an E2E architecture in production. In particular, one may see that the without_intent model performs no worse than the with_intent model. This result may indicate that the user's intent could be implicitly collected through the utterance rather than being explicitly supplied by the seqlogical parse.

There may be several key benefits from the hybrid E2E model. One benefit may include end-to-end backprop, where one may backprop through the entire model by virtue of joint training, letting the model decide what features are important for classification, rather than imposing a human-defined representation of how the system ought to behave. Another benefit may include less ontologizing. Specifically, one may loosen the dependence on strongly typed ontologies, but still maintain their presence in the assistant system 140 to support high-precision rules that handle the majority of head cases. Another benefit may include latency/memory optimization, where one may optimize for latency and memory by running the larger NLU model once and then running the smaller MBD model several times during inference. This may be particularly important since MBD typically makes several decisions per turn (e.g., update dialog state > disambiguate contacts).

Single-Stage Wake-Word System with Stateful Convolution

In particular embodiments, the assistant system 140 may perform wake-word detection using a single-stage system, which may greatly simplify the deployment and maintenance process, relieve the resource contention on a system-on-a-chip (SoC), as well as provide better user privacy experience (e.g., by turning the LED of smart glasses on when the first stage is falsely invoked). In the single-stage system, the assistant system 140 may utilize a stateful convolution model based on sliding windows. The stateful convolution model may maintain a hidden state which carries the previous information needed for the current time step. Due to a much smaller input size, a stateful convolution model may only require a much smaller computation budget for every new sliding window, which may empower the assistant system 140 to apply more complicated models on digital signal processor (DSP) for better accuracy without sacrificing efficiency. Although this disclosure describes particular wake-word detection by particular systems in a particular manner, this disclosure contemplates any suitable wake-word detection by any suitable system in any suitable manner.

Traditional wake-word systems may be based on a two-stage framework composed of an efficient first-stage model and a high-performing (and less efficient) second-stage model. For example, on smart glasses, both stages may be on the glasses: the first-stage model on a digital signal processor (DSP) and the second-stage model on a system-on-a-chip (SoC). Due to the limited resource on DSP, the first-stage model that runs continuously may need to be relatively compact, which means it usually has a high false accept rate. The second-stage model may use a much more complicated architecture to verify if the incoming trigger is a false accept or not. The problem with the two-stage framework may be how to improve the first-stage wake-word detection quality while maintaining similar efficiency on DSP, so as to reduce the dependency on the second-stage model. The wake-word system may be always running, so one may want to make the model as small and efficient as possible but also have high accuracy to avoid false wakes.

To address the aforementioned problem, the assistant system 140 may use a single-stage (i.e., first-stage) system. The single-stage system may greatly simplify the deployment and maintenance process, relieve the resource contention on SoC, as well as provide better user privacy experience (e.g., LED of smart glasses may be on when the first stage is falsely invoked).

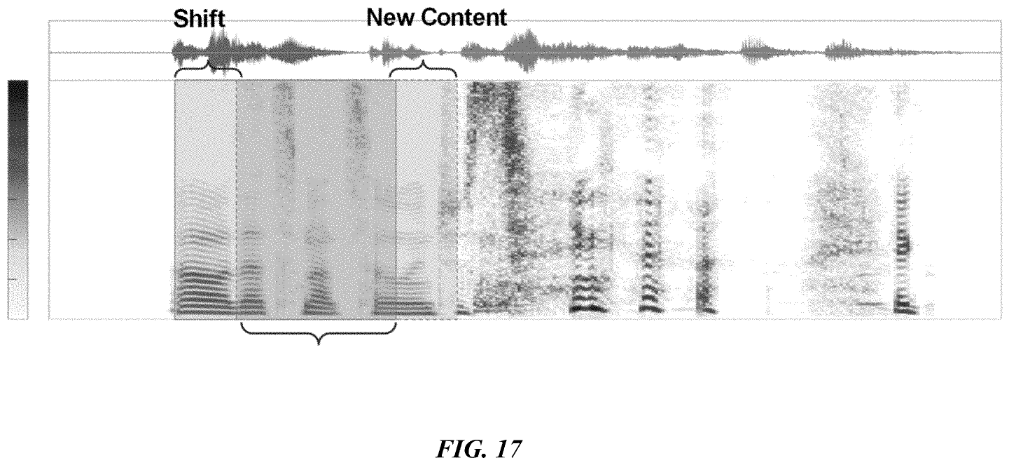

The first-stage wake-word detection may run in always-on mode. It may process a fixed window of audio by analyzing a sliding window of the input audio. For example, a model may take 320 ms audio as input to predict syllable-level labels every 30 ms. FIG. 17 illustrates an example overlapping of two consecutive audio windows. As shown in FIG. 17, the new audio window may be 30 ms, while there is a large overlap of audio, about 290 ms, between two consecutive sliding windows. Since the convolution layer uses the same kernel to convolve the input along the time dimension, it may be possible to reuse the computation in the overlapped window if the assistant system 140 can use stateful convolution by carrying the previous information (e.g., as hidden states). This may allow the assistant system 140 to increase the model capacity while maintaining low compute.

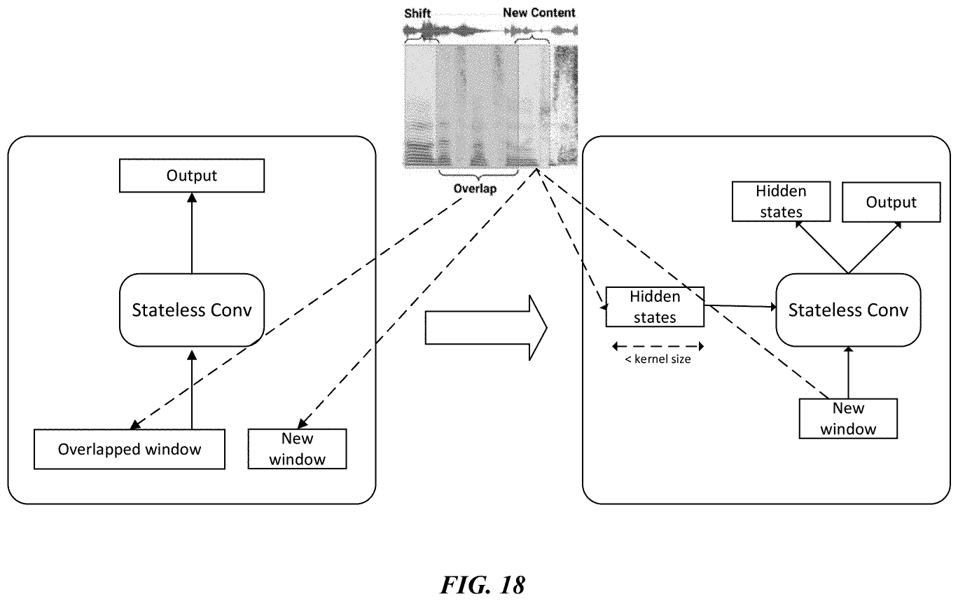

Stateful convolution model may be conceptually equivalent to the stateless convolution model with sliding windows. FIG. 18 illustrates an example comparison between stateless and stateful convolution. As illustrated in FIG. 18, it may maintain a hidden state which carries the previous information needed for the current time step. The hidden state size may be smaller than the convolution kernel size and may be often negligible compared to the overlapped window. The hidden state may be combined with the new window as input and fed into convolution. The output of the stateful convolution model may comprise 1) the partial output (corresponding to the new window), and 2) the hidden state for the next time step. Due to a much smaller input size, a stateful convolution model may only require a much smaller computation budget for every new sliding window, which may empower the assistant system 140 to apply more complicated models on DSP for better accuracy without sacrificing efficiency.

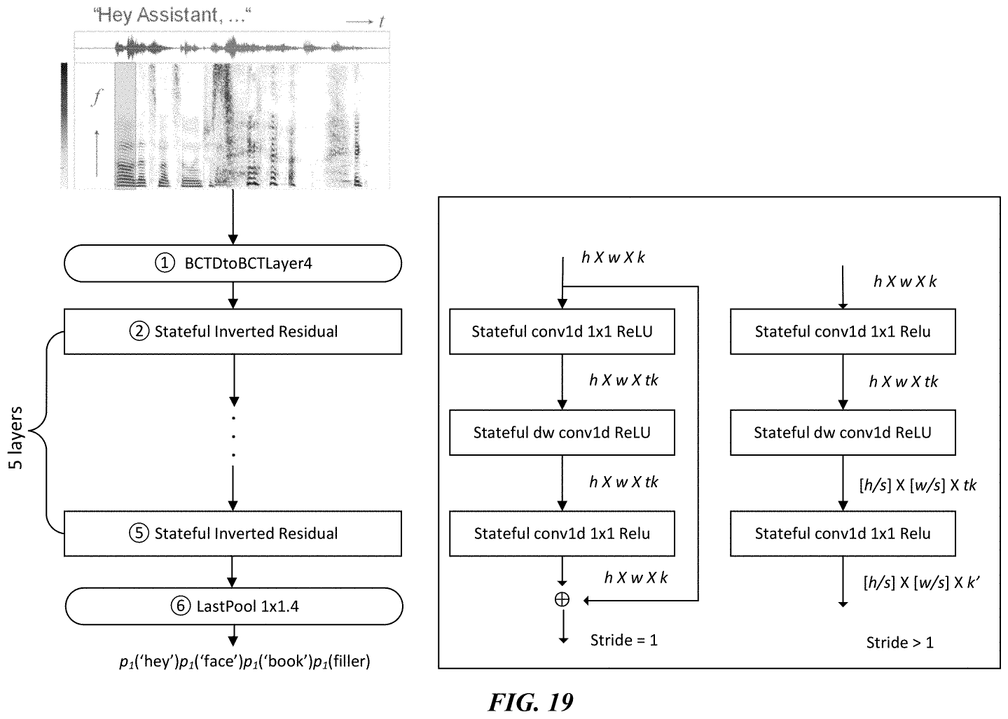

FIG. 19 illustrates an example stateful model architecture based on mobilenet_v2 backbone. Regarding the architecture of the stateful convolution model, the assistant system 140 may utilize a stateful convolution model that has a model size (˜200 KB) and #MACs (˜180K) both of which are comparable to the current fully connected product model, given the limited resource budget for first-stage model on DSP. The model may be based on the mobilenet_v2 building blocks by replacing all the conv2d with conv1d to reduce computation. The building block may be a bottleneck inverted residual block containing two pointwise convolutions and one depth-wise convolution layer in between. At runtime, the model may take 40 ms audio and a small hidden state as input every 40 ms.

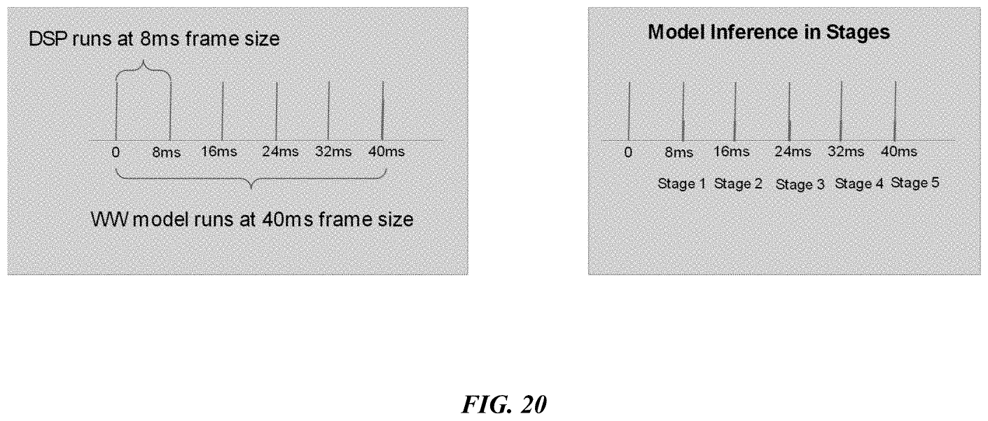

The embodiments disclosed herein benchmarked the runtime performance on HiFi4 DSP that may be suitable for smart glasses and smart watch. The initial profiling results are far below the expectation. As shown in Table 14, the stateful model costs about 14MIPS at runtime, while the product model costs about 2MIPS. One main reason may be that the dominant operator quantized depth-wise convolution in BoltNN is not well optimized on HiFi4 and takes lots of cycles to execute, meanwhile the FC operator is the most efficient among all operators. FIG. 20 illustrates an example runtime optimization on DSP.

TABLE 14
Initial Profiling on HiFi4 14 MIPS

| Operator | Cycles | |
|---|---|---|
| QuantizedDepthwiseConv1d | 282192 | (50.04%) |
| QuantizedConv1d | 111442 | (19.76%) |
| Concat | 55899 | (9.91%) |
| Transpose | 44816 | (7.95%) |
| Total | 563970 | (100%) |

Initial profiling on HiFi4.

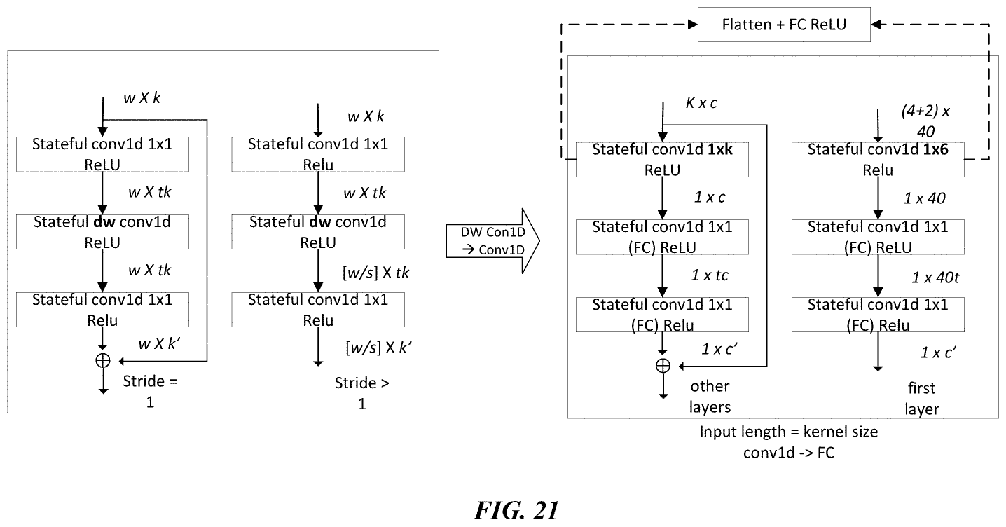

Based on this observation, two changes in the model design were made. FIG. 21 illustrates example changes in model design. Firstly, the depth-wise convolution may be changed to a regular 1xk convolution. To keep similar #MACs, the order with the first pointwise convolution layer may be changed, so the 1xk convolution only performs on a small channel number. Secondly, the kernel size k may be set to be equal to the input length (e.g., input size+hidden state size). For example, when the input size is four (40 ms) and hidden size is two, one may use a 1×6 kernel. In this way, the conv1d layer may be equivalently converted to a fully-connected (FC) layer for better runtime efficiency on DSP. With the architecture optimization, the DSP cycles were successfully reduced by more than 3 times, e.g., from 14MIPS to 4MIPS. Table 15 illustrates profiling of the updated model on HiFi4. In particular embodiments, the assistant system 140 may use neural architecture search to automatically search for more optimal architectures.

TABLE 15

| Initial Profiling on HiFi4: 14 MIPS | | | | Profiling on HiFi4: 4 MIPS | | |
|---|---|---|---|---|---|---|
| Operator | Cycles | | | Operator | Cycles | |
| QuantizedDepthwiseConv1d | 282192 | (50.04%) | DW ConvID → | QuantizedFC | 100782 | (60.77%) |
| QuantizedConv1d | 111442 | (19.76%) | Conv1D → | Concat | 21486 | (12.96%) |
| Concat | 55899 | (9.91%) | Linear | Reshape | 9518 | (5.74%) |
| Transpose | 44816 | (7.95%) | | Quantize | 8972 | (5.41%) |
| Total | 563970 | (100%) | | Total | 165838 | (100%) |

Profiling of the updated model on HiFi4

The model inference may be in stages as described as follows. Wearables like smart watch may normally run in low-power mode, e.g., at 48 MHz, for battery preserving. DSP on the wearables may run at 8 ms frame size for better latency experience. Therefore, there may be about 380K cycles allocated at each frame that are used for audio processing and wake-word model execution. Since the stateful model uses two more MIPS than a conventional model, there may be not enough budget out of 380K cycles at a single frame for model inference. However, since the wake-word model execution is done every 40 ms, the assistant system 140 may have enabled model inference in stages on DSP. Specifically, each inference workload may be evenly split and may be scheduled to be executed in multiple stages within 40 ms in order to fit into the budget at a single frame.

The embodiments disclosed herein benchmarked the detection performance of the stateful model against the prod FC model. Both models are trained at the syllable level. Note that it may be easily generalized to any modeling units, such as phrase-level or grapheme-level.

The stateful convolution model is applied on the wake-word data associated with smart glasses. The evaluation datasets include Phase2, Phase3 and Lab recordings across different conditions and locales, such as wind noise, music/speech noise, en_US, en_GB, en_AU, it_IT, fr_FR, etc.

Table 16 compares false reject rate (on the left) and false accept rate (on the right) of the prod FC model and the stateful model. The stateful model improves both false reject rate and false accept rate across the board in general. Specifically, the relative improvement of false reject rate on Phase2 data reaches 53%.

TABLE 16

| | | |
|---|---|---|
| | | Relative |
| Prod | Stateful | Improvement |

Positive Datasets (False Rejection Rate)

| | | | |
|---|---|---|---|
| AU Lab [−3 db, clean] | 21.67% | 16.3% | +24.78% |
| AU Wind [3, 5]Mps | 10.46% | 7.07% | +32.40% |
| UK Lab \|−3 db, clean] | 18.6% | 15.53% | +27.47% |
| UK Wind [3, 5]Mps | 19.0% | 14.59% | +23.21% |
| US Lab \|−3 db, clean] | 12.36% | 8.67% | +29.85% |
| US Wind [3, 5]Mps | 18.3% | 14.96% | +18.25% |
| French Phase 2 | 6.1% | 6.06% | +0.65% |
| Italian Phase 2 | 1.28% | 1.28% | 0 |
| US Phase 2 | 7.08% | 3.55% | +49.85% |
| US Phase 2 | 7.52% | 3.53% | +53.05% |
| Wind 3 Mps | | | |
| AU Phase 3 | 2.88% | 2.9% | |
| UK Phase 3 | 2.45% | 2.8% | +14.28% |
| US Phase 3 | 2.15% | 2.05% | +4.65% |

Negative Datasets (False Accept Rate)

| | | | |
|---|---|---|---|
| US Phase 2 | 0.03% | 0.027% | |
| US Phase 2 | 0.54% | 0.52% | +3.7% |
| Wind 3 Mps | | | |
| AU Phase 3 | 0.31% | 0.27% | +12.9% |
| UK Phase 3 | 0.18% | 0.19% | +5.5% |
| US Phase 3 | 0.39% | 0.37% | +5.1% |
| French 27.5 h Video | 0 | 0 | 0 |
| Italian 27.5 h Video | 2 | 0 | 2 |

Comparison of false reject rate (on the top) and false accept rate (on the bottom) of the prod FC model and the stateful model.

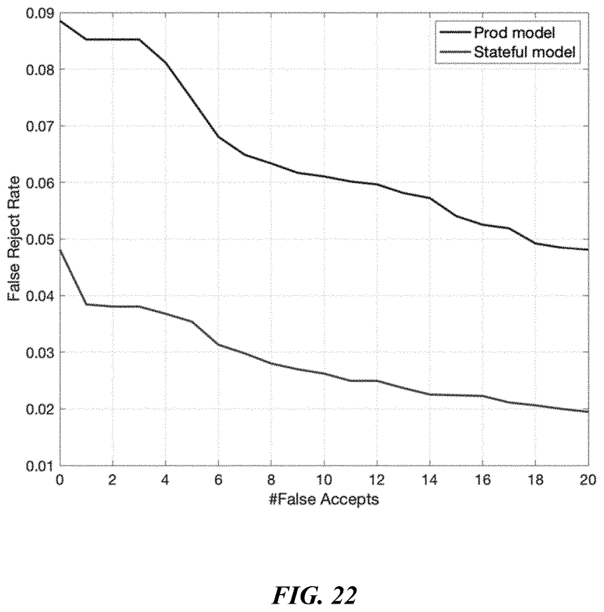

FIG. 22 illustrates an example DET curve of the prod model and the stateful model. The stateful model is further applied for new wake-word modeling on smart watches. The models are evaluated on 7.8K positive smart-watch data and 194-hrs negative data. The stateful model significantly outperforms the production model at different operating points. For example, false reject rate has been improved by 46% at 0FA/194Hrs. The promising results allow the assistant system 140 to use a single-stage system.

In particular embodiments, the assistant system 140 may directly train the small model from scratch. Teacher student learning (a.k.a. knowledge distillation) is known to be useful to improve the small model's performance by minimizing its prediction difference to a larger model. The assistant system 140 may utilize teacher student learning to further improve the first-stage model accuracy without increasing resource budget.

The embodiments disclosed herein may be extended to grapheme-level modeling and multi-wake-word case for more general purposes.

### Social Graphs

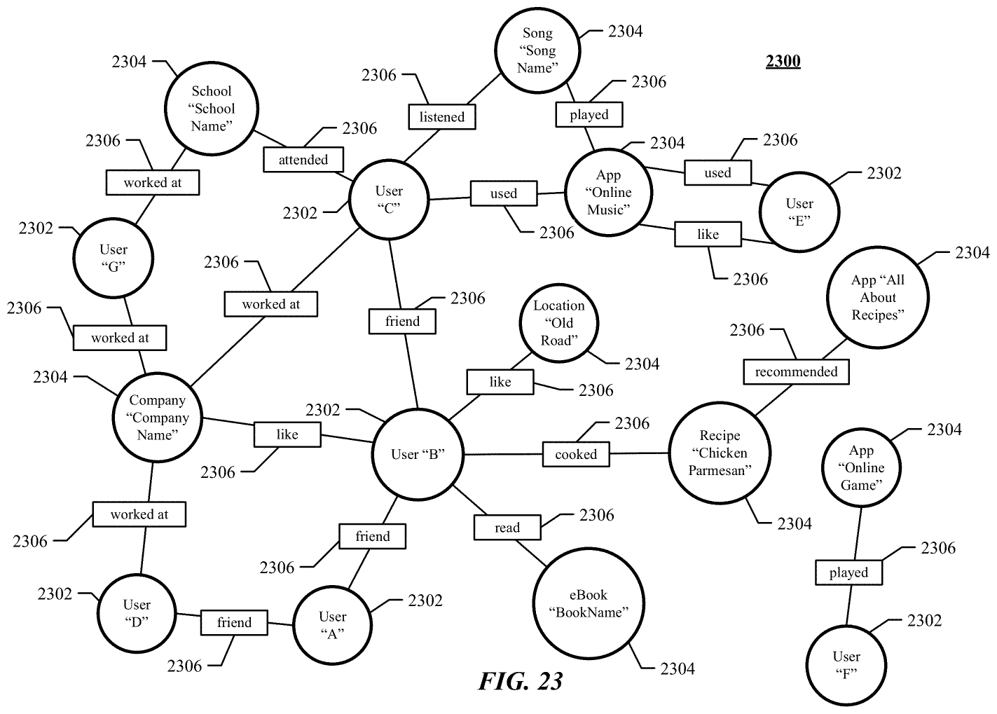

FIG. 23 illustrates an example social graph 2300. In particular embodiments, the social-networking system 160 may store one or more social graphs 2300 in one or more data stores. In particular embodiments, the social graph 2300 may include multiple nodes—which may include multiple user nodes 2302 or multiple concept nodes 2304—and multiple edges 2306 connecting the nodes. Each node may be associated with a unique entity (i.e., user or concept), each of which may have a unique identifier (ID), such as a unique number or username. The example social graph 2300 illustrated in FIG. 23 is shown, for didactic purposes, in a two-dimensional visual map representation. In particular embodiments, a social-networking system 160, a client system 130, an assistant system 140, or a third-party system 170 may access the social graph 2300 and related social-graph information for suitable applications. The nodes and edges of the social graph 2300 may be stored as data objects, for example, in a data store (such as a social-graph database). Such a data store may include one or more searchable or queryable indexes of nodes or edges of the social graph 2300.

In particular embodiments, a user node 2302 may correspond to a user of the social-networking system 160 or the assistant system 140. As an example and not by way of limitation, a user may be an individual (human user), an entity (e.g., an enterprise, business, or third-party application), or a group (e.g., of individuals or entities) that interacts or communicates with or over the social-networking system 160 or the assistant system 140. In particular embodiments, when a user registers for an account with the social-networking system 160, the social-networking system 160 may create a user node 2302 corresponding to the user, and store the user node 2302 in one or more data stores. Users and user nodes 2302 described herein may, where appropriate, refer to registered users and user nodes 2302 associated with registered users. In addition or as an alternative, users and user nodes 2302 described herein may, where appropriate, refer to users that have not registered with the social-networking system 160. In particular embodiments, a user node 2302 may be associated with information provided by a user or information gathered by various systems, including the social-networking system 160. As an example and not by way of limitation, a user may provide his or her name, profile picture, contact information, birth date, sex, marital status, family status, employment, education background, preferences, interests, or other demographic information. In particular embodiments, a user node 2302 may be associated with one or more data objects corresponding to information associated with a user. In particular embodiments, a user node 2302 may correspond to one or more web interfaces.

In particular embodiments, a concept node 2304 may correspond to a concept. As an example and not by way of limitation, a concept may correspond to a place (such as, for example, a movie theater, restaurant, landmark, or city); a website (such as, for example, a website associated with the social-networking system 160 or a third-party website associated with a web-application server); an entity (such as, for example, a person, business, group, sports team, or celebrity); a resource (such as, for example, an audio file, video file, digital photo, text file, structured document, or application) which may be located within the social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 2304 may be associated with information of a concept provided by a user or information gathered by various systems, including the social-networking system 160 and the assistant system 140. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 2304 may be associated with one or more data objects corresponding to information associated with concept node 2304. In particular embodiments, a concept node 2304 may correspond to one or more web interfaces.

In particular embodiments, a node in the social graph 2300 may represent or be represented by a web interface (which may be referred to as a “profile interface”). Profile interfaces may be hosted by or accessible to the social-networking system 160 or the assistant system 140. Profile interfaces may also be hosted on third-party websites associated with a third-party system 170. As an example and not by way of limitation, a profile interface corresponding to a particular external web interface may be the particular external web interface and the profile interface may correspond to a particular concept node 2304. Profile interfaces may be viewable by all or a selected subset of other users. As an example and not by way of limitation, a user node 2302 may have a corresponding user-profile interface in which the corresponding user may add content, make declarations, or otherwise express himself or herself. As another example and not by way of limitation, a concept node 2304 may have a corresponding concept-profile interface in which one or more users may add content, make declarations, or express themselves, particularly in relation to the concept corresponding to concept node 2304.

In particular embodiments, a concept node 2304 may represent a third-party web interface or resource hosted by a third-party system 170. The third-party web interface or resource may include, among other elements, content, a selectable or other icon, or other inter-actable object representing an action or activity. As an example and not by way of limitation, a third-party web interface may include a selectable icon such as “like,” “check-in,” “eat,” “recommend,” or another suitable action or activity. A user viewing the third-party web interface may perform an action by selecting one of the icons (e.g., “check-in”), causing a client system 130 to send to the social-networking system 160 a message indicating the user's action. In response to the message, the social-networking system 160 may create an edge (e.g., a check-in-type edge) between a user node 2302 corresponding to the user and a concept node 2304 corresponding to the third-party web interface or resource and store edge 2306 in one or more data stores.

In particular embodiments, a pair of nodes in the social graph 2300 may be connected to each other by one or more edges 2306. An edge 2306 connecting a pair of nodes may represent a relationship between the pair of nodes. In particular embodiments, an edge 2306 may include or represent one or more data objects or attributes corresponding to the relationship between a pair of nodes. As an example and not by way of limitation, a first user may indicate that a second user is a “friend” of the first user. In response to this indication, the social-networking system 160 may send a “friend request” to the second user. If the second user confirms the “friend request,” the social-networking system 160 may create an edge 2306 connecting the first user's user node 2302 to the second user's user node 2302 in the social graph 2300 and store edge 2306 as social-graph information in one or more of data stores 164. In the example of FIG. 23, the social graph 2300 includes an edge 2306 indicating a friend relation between user nodes 2302 of user “A” and user “B” and an edge indicating a friend relation between user nodes 2302 of user “C” and user “B.” Although this disclosure describes or illustrates particular edges 2306 with particular attributes connecting particular user nodes 2302, this disclosure contemplates any suitable edges 2306 with any suitable attributes connecting user nodes 2302. As an example and not by way of limitation, an edge 2306 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in the social graph 2300 by one or more edges 2306. The degree of separation between two objects represented by two nodes, respectively, is a count of edges in a shortest path connecting the two nodes in the social graph 2300. As an example and not by way of limitation, in the social graph 2300, the user node 2302 of user “C” is connected to the user node 2302 of user “A” via multiple paths including, for example, a first path directly passing through the user node 2302 of user “B,” a second path passing through the concept node 2304 of company “CompanyName” and the user node 2302 of user “D,” and a third path passing through the user nodes 2302 and concept nodes 2304 representing school “SchoolName,” user “G,” company “CompanyName,” and user “D.” User “C” and user “A” have a degree of separation of two because the shortest path connecting their corresponding nodes (i.e., the first path) includes two edges 2306.

In particular embodiments, an edge 2306 between a user node 2302 and a concept node 2304 may represent a particular action or activity performed by a user associated with user node 2302 toward a concept associated with a concept node 2304. As an example and not by way of limitation, as illustrated in FIG. 23, a user may “like,” “attended,” “played,” “listened,” “cooked,” “worked at,” or “read” a concept, each of which may correspond to an edge type or subtype. A concept-profile interface corresponding to a concept node 2304 may include, for example, a selectable “check in” icon (such as, for example, a clickable “check in” icon) or a selectable “add to favorites” icon. Similarly, after a user clicks these icons, the social-networking system 160 may create a “favorite” edge or a “check in” edge in response to a user's action corresponding to a respective action. As another example and not by way of limitation, a user (user “C”) may listen to a particular song (“SongName”) using a particular application (a third-party online music application). In this case, the social-networking system 160 may create a “listened” edge 2306 and a “used” edge (as illustrated in FIG. 23) between user nodes 2302 corresponding to the user and concept nodes 2304 corresponding to the song and application to indicate that the user listened to the song and used the application. Moreover, the social-networking system 160 may create a “played” edge 2306 (as illustrated in FIG. 23) between concept nodes 2304 corresponding to the song and the application to indicate that the particular song was played by the particular application. In this case, “played” edge 2306 corresponds to an action performed by an external application (the third-party online music application) on an external audio file (the song “SongName”). Although this disclosure describes particular edges 2306 with particular attributes connecting user nodes 2302 and concept nodes 2304, this disclosure contemplates any suitable edges 2306 with any suitable attributes connecting user nodes 2302 and concept nodes 2304. Moreover, although this disclosure describes edges between a user node 2302 and a concept node 2304 representing a single relationship, this disclosure contemplates edges between a user node 2302 and a concept node 2304 representing one or more relationships. As an example and not by way of limitation, an edge 2306 may represent both that a user likes and has used at a particular concept. Alternatively, another edge 2306 may represent each type of relationship (or multiples of a single relationship) between a user node 2302 and a concept node 2304 (as illustrated in FIG. 23 between user node 2302 for user “E” and concept node 2304 for “online music application”).

In particular embodiments, the social-networking system 160 may create an edge 2306 between a user node 2302 and a concept node 2304 in the social graph 2300. As an example and not by way of limitation, a user viewing a concept-profile interface (such as, for example, by using a web browser or a special-purpose application hosted by the user's client system 130) may indicate that he or she likes the concept represented by the concept node 2304 by clicking or selecting a “Like” icon, which may cause the user's client system 130 to send to the social-networking system 160 a message indicating the user's liking of the concept associated with the concept-profile interface. In response to the message, the social-networking system 160 may create an edge 2306 between user node 2302 associated with the user and concept node 2304, as illustrated by “like” edge 2306 between the user and concept node 2304. In particular embodiments, the social-networking system 160 may store an edge 2306 in one or more data stores. In particular embodiments, an edge 2306 may be automatically formed by the social-networking system 160 in response to a particular user action. As an example and not by way of limitation, if a first user uploads a picture, reads a book, watches a movie, or listens to a song, an edge 2306 may be formed between user node 2302 corresponding to the first user and concept nodes 2304 corresponding to those concepts. Although this disclosure describes forming particular edges 2306 in particular manners, this disclosure contemplates forming any suitable edges 2306 in any suitable manner.

### Vector Spaces and Embeddings

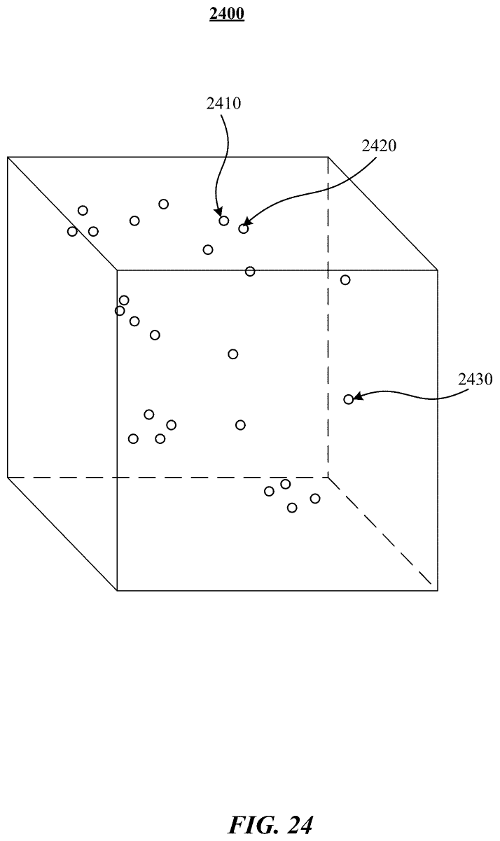

FIG. 24 illustrates an example view of a vector space 2400. In particular embodiments, an object or an n-gram may be represented in a d-dimensional vector space, where d denotes any suitable number of dimensions. Although the vector space 2400 is illustrated as a three-dimensional space, this is for illustrative purposes only, as the vector space 2400 may be of any suitable dimension. In particular embodiments, an n-gram may be represented in the vector space 2400 as a vector referred to as a term embedding. Each vector may comprise coordinates corresponding to a particular point in the vector space 2400 (i.e., the terminal point of the vector). As an example and not by way of limitation, vectors 2410, 2420, and 2430 may be represented as points in the vector space 2400, as illustrated in FIG. 24. An n-gram may be mapped to a respective vector representation. As an example and not by way of limitation, n-grams t₁ and t₂ may be mapped to vectors [symbol] and [symbol] in t veor space 2400, respectively, by applying a function [symbol] defined by a dictionary, such that [symbol] = [symbol] (t₁) and [symbol] = [symbol] (t₂). As another example and not by way of limitation, a dictionary trained to map text to a vector representation may be utilized, or such a dictionary may be itself generated via training. As another example and not by way of limitation, a word-embeddings model may be used to map an n-gram to a vector representation in the vector space 2400. In particular embodiments, an n-gram may be mapped to a vector representation in the vector space 2400 by using a machine leaning model (e.g., a neural network). The machine learning model may have been trained using a sequence of training data (e.g., a corpus of objects each comprising n-grams).

In particular embodiments, an object may be represented in the vector space 2400 as a vector referred to as a feature vector or an object embedding. As an example and not by way of limitation, objects e₁ and e₂ may be mapped to vectors [symbol] and [symbol] in the vector space 2400, respectively, by applying a function [symbol] , such that [symbol] = [symbol] (e₁) and [symbol] = [symbol] (e₂). In particular embodiments, an object may be mapped to a vector based on one or more properties, attributes, or features of the object, relationships of the object with other objects, or any other suitable information associated with the object. As an example and not by way of limitation, a function n may map objects to vectors by feature extraction, which may start from an initial set of measured data and build derived values (e.g., features). As an example and not by way of limitation, an object comprising a video or an image may be mapped to a vector by using an algorithm to detect or isolate various desired portions or shapes of the object. Features used to calculate the vector may be based on information obtained from edge detection, corner detection, blob detection, ridge detection, scale-invariant feature transformation, edge direction, changing intensity, autocorrelation, motion detection, optical flow, thresholding, blob extraction, template matching, Hough transformation (e.g., lines, circles, ellipses, arbitrary shapes), or any other suitable information. As another example and not by way of limitation, an object comprising audio data may be mapped to a vector based on features such as a spectral slope, a tonality coefficient, an audio spectrum centroid, an audio spectrum envelope, a Mel-frequency cepstrum, or any other suitable information. In particular embodiments, when an object has data that is either too large to be efficiently processed or comprises redundant data, a function [symbol] may map the object to a vector using a transformed reduced set of features (e.g., feature selection). In particular embodiments, a function [symbol] may map an object e to a vector [symbol] (e) based on one or more n-grams associated with object e. Although this disclosure describes representing an n-gram or an object in a vector space in a particular manner, this disclosure contemplates representing an n-gram or an object in a vector space in any suitable manner.

In particular embodiments, the social-networking system 160 may calculate a similarity metric of vectors in vector space 2400. A similarity metric may be a cosine similarity, a Minkowski distance, a Mahalanobis distance, a Jaccard similarity coefficient, or any suitable similarity metric. As an example and not a of limitation, a similarity metric of [symbol] and [symbol] may be a cosine similarity

$$\frac{\vec{{v}_{1}} \cdot \vec{{v}_{2}}}{‖ \vec{{v}_{1}} ‖ ‖ \vec{{v}_{2}} ‖} .$$

As another example and not by way of limitation, a similarity metric [symbol] and [symbol] may be a Euclidean distance ∥ [symbol] − [symbol] ∥. A similarity metric of two vectors may represent how similar the two objects or n-grams corresponding to the two vectors, respectively, are to one another, as measured by the distance between the two vectors in the vector space 2400. As an example and not by way of limitation, vector 2410 and vector 2420 may correspond to objects that are more similar to one another than the objects corresponding to vector 2410 and vector 2430, based on the distance between the respective vectors. Although this disclosure describes calculating a similarity metric between vectors in a particular manner, this disclosure contemplates calculating a similarity metric between vectors in any suitable manner.

More information on vector spaces, embeddings, feature vectors, and similarity metrics may be found in U.S. patent application Ser. No. 14/949,436, filed 23 Nov. 2015, U.S. patent application Ser. No. 15/286,315, filed 5 Oct. 2016, and U.S. patent application Ser. No. 15/365,789, filed 30 Nov. 2016, each of which is incorporated by reference.

### Artificial Neural Networks

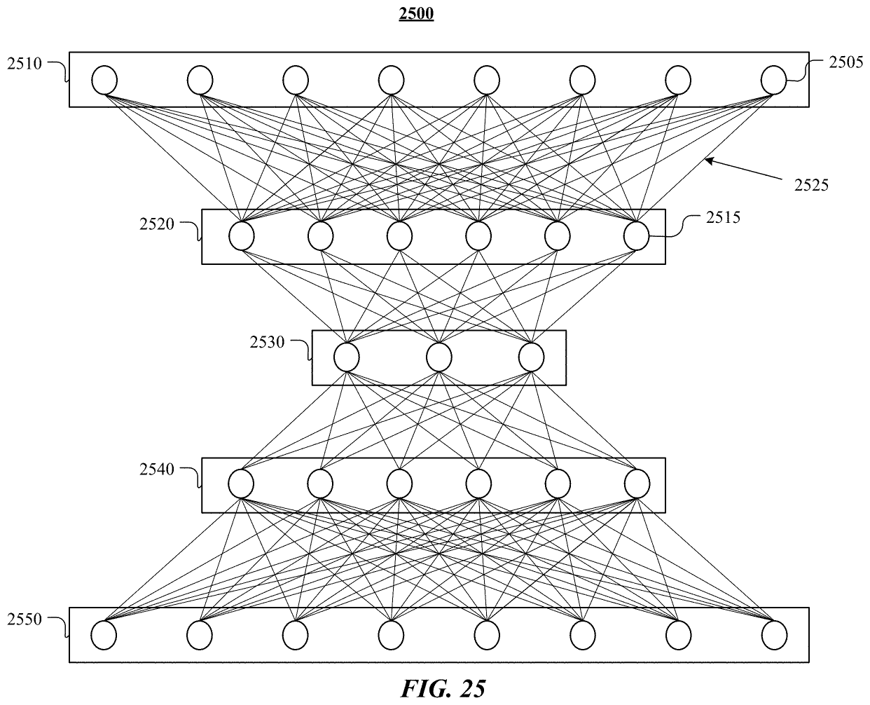

FIG. 25 illustrates an example artificial neural network (“ANN”) 2500. In particular embodiments, an ANN may refer to a computational model comprising one or more nodes. Example ANN 2500 may comprise an input layer 2510, hidden layers 2520, 2530, 2540, and an output layer 2550. Each layer of the ANN 2500 may comprise one or more nodes, such as a node 2505 or a node 2515. In particular embodiments, each node of an ANN may be connected to another node of the ANN. As an example and not by way of limitation, each node of the input layer 2510 may be connected to one of more nodes of the hidden layer 2520. In particular embodiments, one or more nodes may be a bias node (e.g., a node in a layer that is not connected to and does not receive input from any node in a previous layer). In particular embodiments, each node in each layer may be connected to one or more nodes of a previous or subsequent layer. Although FIG. 25 depicts a particular ANN with a particular number of layers, a particular number of nodes, and particular connections between nodes, this disclosure contemplates any suitable ANN with any suitable number of layers, any suitable number of nodes, and any suitable connections between nodes. As an example and not by way of limitation, although FIG. 25 depicts a connection between each node of the input layer 2510 and each node of the hidden layer 2520, one or more nodes of the input layer 2510 may not be connected to one or more nodes of the hidden layer 2520.

In particular embodiments, an ANN may be a feedforward ANN (e.g., an ANN with no cycles or loops where communication between nodes flows in one direction beginning with the input layer and proceeding to successive layers). As an example and not by way of limitation, the input to each node of the hidden layer 2520 may comprise the output of one or more nodes of the input layer 2510. As another example and not by way of limitation, the input to each node of the output layer 2550 may comprise the output of one or more nodes of the hidden layer 2540. In particular embodiments, an ANN may be a deep neural network (e.g., a neural network comprising at least two hidden layers). In particular embodiments, an ANN may be a deep residual network. A deep residual network may be a feedforward ANN comprising hidden layers organized into residual blocks. The input into each residual block after the first residual block may be a function of the output of the previous residual block and the input of the previous residual block. As an example and not by way of limitation, the input into residual block N may be F(x)+x, where F(x) may be the output of residual block N −1, x may be the input into residual block N −1. Although this disclosure describes a particular ANN, this disclosure contemplates any suitable ANN.

In particular embodiments, an activation function may correspond to each node of an ANN. An activation function of a node may define the output of a node for a given input. In particular embodiments, an input to a node may comprise a set of inputs. As an example and not by way of limitation, an activation function may be an identity function, a binary step function, a logistic function, or any other suitable function. As another example and not by way of limitation, an activation function for a node k may be the sigmoid function

$${F}_{k} ( {s}_{k} ) = \frac{1}{1 + {e}^{- {s}_{k}}} ,$$

the hyperbolic tangent function

$${F}_{k} ( {s}_{k} ) = \frac{{e}^{{s}_{k}} - {e}^{- {s}_{k}}}{{e}^{{s}_{k}} + {e}^{- {s}_{k}}} ,$$

the rectifier Fₖ(sₖ)=max (0,sₖ), or any other suitable function Fₖ(sₖ), where sₖ may be the effective input to node k. In particular embodiments, the input of an activation function corresponding to a node may be weighted. Each node may generate output using a corresponding activation function based on weighted inputs. In particular embodiments, each connection between nodes may be associated with a weight. As an example and not by way of limitation, a connection 2525 between the node 2505 and the node 2515 may have a weighting coefficient of 0.4, which may indicate that 0.4 multiplied by the output of the node 2505 is used as an input to the node 2515. As another example and not by way of limitation, the output yₖ of node k may be yₖ=Fₖ(sₖ), where Fₖ may be the activation function corresponding to node k, sₖ=Σⱼ(wⱼₖxⱼ) may be the effective input to node k, xⱼ may be the output of a node j connected to node k, and wⱼₖ may be the weighting coefficient between node j and node k. In particular embodiments, the input to nodes of the input layer may be based on a vector representing an object. Although this disclosure describes particular inputs to and outputs of nodes, this disclosure contemplates any suitable inputs to and outputs of nodes. Moreover, although this disclosure may describe particular connections and weights between nodes, this disclosure contemplates any suitable connections and weights between nodes.

In particular embodiments, an ANN may be trained using training data. As an example and not by way of limitation, training data may comprise inputs to the ANN 2500 and an expected output. As another example and not by way of limitation, training data may comprise vectors each representing a training object and an expected label for each training object. In particular embodiments, training an ANN may comprise modifying the weights associated with the connections between nodes of the ANN by optimizing an objective function. As an example and not by way of limitation, a training method may be used (e.g., the conjugate gradient method, the gradient descent method, the stochastic gradient descent) to backpropagate the sum-of-squares error measured as a distances between each vector representing a training object (e.g., using a cost function that minimizes the sum-of-squares error). In particular embodiments, an ANN may be trained using a dropout technique. As an example and not by way of limitation, one or more nodes may be temporarily omitted (e.g., receive no input and generate no output) while training. For each training object, one or more nodes of the ANN may have some probability of being omitted. The nodes that are omitted for a particular training object may be different than the nodes omitted for other training objects (e.g., the nodes may be temporarily omitted on an object-by-object basis). Although this disclosure describes training an ANN in a particular manner, this disclosure contemplates training an ANN in any suitable manner.

### Privacy

In particular embodiments, one or more objects (e.g., content or other types of objects) of a computing system may be associated with one or more privacy settings. The one or more objects may be stored on or otherwise associated with any suitable computing system or application, such as, for example, a social-networking system 160, a client system 130, an assistant system 140, a third-party system 170, a social-networking application, an assistant application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system 160 or assistant system 140 or shared with other systems (e.g., a third-party system 170). Although this disclosure describes using particular privacy settings in a particular manner, this disclosure contemplates using any suitable privacy settings in any suitable manner.

In particular embodiments, privacy settings may be based on one or more nodes or edges of a social graph 2300. A privacy setting may be specified for one or more edges 2306 or edge-types of the social graph 2300, or with respect to one or more nodes 2302, 2304 or node-types of the social graph 2300. The privacy settings applied to a particular edge 2306 connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a first user may share an object to the social-networking system 160. The object may be associated with a concept node 2304 connected to a user node 2302 of the first user by an edge 2306. The first user may specify privacy settings that apply to a particular edge 2306 connecting to the concept node 2304 of the object, or may specify privacy settings that apply to all edges 2306 connecting to the concept node 2304. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In particular embodiments, the social-networking system 160 may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system 160 may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems 170, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers 162 may be authorization/privacy servers for enforcing privacy settings. In response to a request from a user (or other entity) for a particular object stored in a data store 164, the social-networking system 160 may send a request to the data store 164 for the object. The request may identify the user associated with the request and the object may be sent only to the user (or a client system 130 of the user) if the authorization server determines that the user is authorized to access the object based on the privacy settings associated with the object. If the requesting user is not authorized to access the object, the authorization server may prevent the requested object from being retrieved from the data store 164 or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example and not by way of limitation, one or more objects may be visible to a user's “Trending” page. In particular embodiments, an object may correspond to a particular user. The object may be content associated with the particular user, or may be the particular user's account or information stored on the social-networking system 160, or other computing system. As an example and not by way of limitation, a first user may view one or more second users of an online social network through a “People You May Know” function of the online social network, or by viewing a list of friends of the first user. As an example and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular embodiments, different privacy settings may be provided for different user groups or user demographics. As an example and not by way of limitation, a first user may specify that other users who attend the same university as the first user may view the first user's pictures, but that other users who are family members of the first user may not view those same pictures.

In particular embodiments, the social-networking system 160 may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social-networking system 160 or assistant system 140 may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system 160 or assistant system 140 may access such information in order to provide a particular function or service to the first user, without the social-networking system 160 or assistant system 140 having access to that information for any other purposes. Before accessing, storing, or using such objects or information, the social-networking system 160 or assistant system 140 may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the social-networking system 160 or assistant system 140.

In particular embodiments, a user may specify whether particular types of objects or information associated with the first user may be accessed, stored, or used by the social-networking system 160 or assistant system 140. As an example and not by way of limitation, the first user may specify that images sent by the first user through the social-networking system 160 or assistant system 140 may not be stored by the social-networking system 160 or assistant system 140. As another example and not by way of limitation, a first user may specify that messages sent from the first user to a particular second user may not be stored by the social-networking system 160 or assistant system 140. As yet another example and not by way of limitation, a first user may specify that all objects sent via a particular application may be saved by the social-networking system 160 or assistant system 140.

In particular embodiments, privacy settings may allow a first user to specify whether particular objects or information associated with the first user may be accessed from particular client systems 130 or third-party systems 170. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system 160 or assistant system 140 may provide default privacy settings with respect to each device, system, or application, and/or the first user may be prompted to specify a particular privacy setting for each context. As an example and not by way of limitation, the first user may utilize a location-services feature of the social-networking system 160 or assistant system 140 to provide recommendations for restaurants or other places in proximity to the user. The first user's default privacy settings may specify that the social-networking system 160 or assistant system 140 may use location information provided from a client system 130 of the first user to provide the location-based services, but that the social-networking system 160 or assistant system 140 may not store the location information of the first user or provide it to any third-party system 170. The first user may then update the privacy settings to allow location information to be used by a third-party image-sharing application in order to geo-tag photos.

In particular embodiments, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular embodiments, the social-networking system 160 or assistant system 140 may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the social-networking system 160 or assistant system 140. The user's privacy settings may specify that such information may be used only for particular processes, such as authentication, and further specify that such information may not be shared with any third-party system 170 or used for other processes or applications associated with the social-networking system 160 or assistant system 140. As another example and not by way of limitation, the social-networking system 160 may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any third-party system 170 or used by other processes or applications associated with the social-networking system 160.

### Systems and Methods

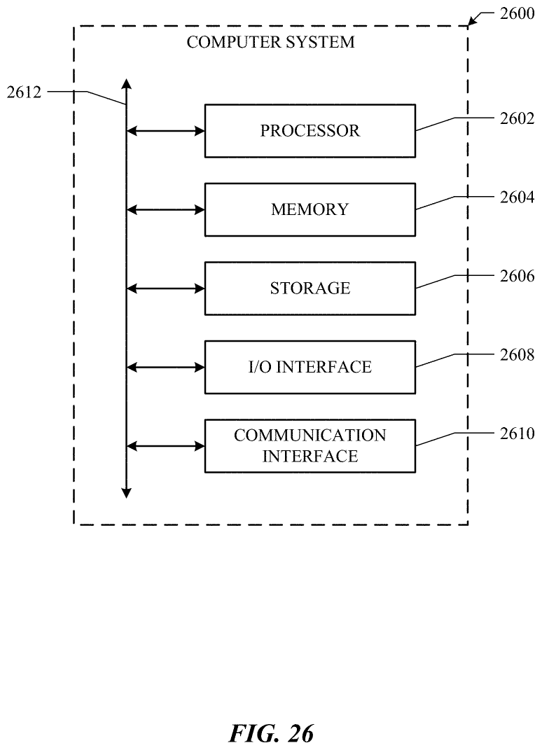

FIG. 26 illustrates an example computer system 2600. In particular embodiments, one or more computer systems 2600 perform one or more steps of one or more methods described or illustrated herein. In particular embodiments, one or more computer systems 2600 provide functionality described or illustrated herein. In particular embodiments, software running on one or more computer systems 2600 performs one or more steps of one or more methods described or illustrated herein or provides functionality described or illustrated herein. Particular embodiments include one or more portions of one or more computer systems 2600. Herein, reference to a computer system may encompass a computing device, and vice versa, where appropriate. Moreover, reference to a computer system may encompass one or more computer systems, where appropriate.

This disclosure contemplates any suitable number of computer systems 2600. This disclosure contemplates computer system 2600 taking any suitable physical form. As example and not by way of limitation, computer system 2600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 2600 may include one or more computer systems 2600; be unitary or distributed; span multiple locations; span multiple machines; span multiple data centers; or reside in a cloud, which may include one or more cloud components in one or more networks. Where appropriate, one or more computer systems 2600 may perform without substantial spatial or temporal limitation one or more steps of one or more methods described or illustrated herein. As an example and not by way of limitation, one or more computer systems 2600 may perform in real time or in batch mode one or more steps of one or more methods described or illustrated herein. One or more computer systems 2600 may perform at different times or at different locations one or more steps of one or more methods described or illustrated herein, where appropriate.

In particular embodiments, computer system 2600 includes a processor 2602, memory 2604, storage 2606, an input/output (I/O) interface 2608, a communication interface 2610, and a bus 2612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 2602 includes hardware for executing instructions, such as those making up a computer program. As an example and not by way of limitation, to execute instructions, processor 2602 may retrieve (or fetch) the instructions from an internal register, an internal cache, memory 2604, or storage 2606; decode and execute them; and then write one or more results to an internal register, an internal cache, memory 2604, or storage 2606. In particular embodiments, processor 2602 may include one or more internal caches for data, instructions, or addresses. This disclosure contemplates processor 2602 including any suitable number of any suitable internal caches, where appropriate. As an example and not by way of limitation, processor 2602 may include one or more instruction caches, one or more data caches, and one or more translation lookaside buffers (TLBs). Instructions in the instruction caches may be copies of instructions in memory 2604 or storage 2606, and the instruction caches may speed up retrieval of those instructions by processor 2602. Data in the data caches may be copies of data in memory 2604 or storage 2606 for instructions executing at processor 2602 to operate on; the results of previous instructions executed at processor 2602 for access by subsequent instructions executing at processor 2602 or for writing to memory 2604 or storage 2606; or other suitable data. The data caches may speed up read or write operations by processor 2602. The TLBs may speed up virtual-address translation for processor 2602. In particular embodiments, processor 2602 may include one or more internal registers for data, instructions, or addresses. This disclosure contemplates processor 2602 including any suitable number of any suitable internal registers, where appropriate. Where appropriate, processor 2602 may include one or more arithmetic logic units (ALUs); be a multi-core processor; or include one or more processors 2602. Although this disclosure describes and illustrates a particular processor, this disclosure contemplates any suitable processor.

In particular embodiments, memory 2604 includes main memory for storing instructions for processor 2602 to execute or data for processor 2602 to operate on. As an example and not by way of limitation, computer system 2600 may load instructions from storage 2606 or another source (such as, for example, another computer system 2600) to memory 2604. Processor 2602 may then load the instructions from memory 2604 to an internal register or internal cache. To execute the instructions, processor 2602 may retrieve the instructions from the internal register or internal cache and decode them. During or after execution of the instructions, processor 2602 may write one or more results (which may be intermediate or final results) to the internal register or internal cache. Processor 2602 may then write one or more of those results to memory 2604. In particular embodiments, processor 2602 executes only instructions in one or more internal registers or internal caches or in memory 2604 (as opposed to storage 2606 or elsewhere) and operates only on data in one or more internal registers or internal caches or in memory 2604 (as opposed to storage 2606 or elsewhere). One or more memory buses (which may each include an address bus and a data bus) may couple processor 2602 to memory 2604. Bus 2612 may include one or more memory buses, as described below. In particular embodiments, one or more memory management units (MMUs) reside between processor 2602 and memory 2604 and facilitate accesses to memory 2604 requested by processor 2602. In particular embodiments, memory 2604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 2604 may include one or more memories 2604, where appropriate. Although this disclosure describes and illustrates particular memory, this disclosure contemplates any suitable memory.

In particular embodiments, storage 2606 includes mass storage for data or instructions. As an example and not by way of limitation, storage 2606 may include a hard disk drive (HDD), a floppy disk drive, flash memory, an optical disc, a magneto-optical disc, magnetic tape, or a Universal Serial Bus (USB) drive or a combination of two or more of these. Storage 2606 may include removable or non-removable (or fixed) media, where appropriate. Storage 2606 may be internal or external to computer system 2600, where appropriate. In particular embodiments, storage 2606 is non-volatile, solid-state memory. In particular embodiments, storage 2606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 2606 taking any suitable physical form. Storage 2606 may include one or more storage control units facilitating communication between processor 2602 and storage 2606, where appropriate. Where appropriate, storage 2606 may include one or more storages 2606. Although this disclosure describes and illustrates particular storage, this disclosure contemplates any suitable storage.

In particular embodiments, I/O interface 2608 includes hardware, software, or both, providing one or more interfaces for communication between computer system 2600 and one or more I/O devices. Computer system 2600 may include one or more of these I/O devices, where appropriate. One or more of these I/O devices may enable communication between a person and computer system 2600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 2608 for them. Where appropriate, I/O interface 2608 may include one or more device or software drivers enabling processor 2602 to drive one or more of these I/O devices. I/O interface 2608 may include one or more I/O interfaces 2608, where appropriate. Although this disclosure describes and illustrates a particular I/O interface, this disclosure contemplates any suitable I/O interface.

In particular embodiments, communication interface 2610 includes hardware, software, or both providing one or more interfaces for communication (such as, for example, packet-based communication) between computer system 2600 and one or more other computer systems 2600 or one or more networks. As an example and not by way of limitation, communication interface 2610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 2610 for it. As an example and not by way of limitation, computer system 2600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 2600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 2600 may include any suitable communication interface 2610 for any of these networks, where appropriate. Communication interface 2610 may include one or more communication interfaces 2610, where appropriate. Although this disclosure describes and illustrates a particular communication interface, this disclosure contemplates any suitable communication interface.

In particular embodiments, bus 2612 includes hardware, software, or both coupling components of computer system 2600 to each other. As an example and not by way of limitation, bus 2612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 2612 may include one or more buses 2612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### MISCELLANEOUS

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing systems:
receiving, from a client system associated with a user, a user query;
generating, by an agent, an initial response for the user query;
determining, based on a machine-learning model, a confidence of the agent for generating the initial response;
modifying the initial response based on a comparison between the confidence of the agent and a factual correctness of the initial response; and
sending, to the client system, instructions for presenting the modified response.

2. A method comprising, by one or more computing systems:
accessing a programming code generated by a user, wherein the programming code is associated with one or more user annotations, each user annotation comprising one or more of an entity, an action, or a parameter associated with a new language domain;
generating a structured representation based on an analysis of the one or more user annotations;
generating a natural-language understanding (NLU) ontology based on the structured representation; and
upon receiving a user utterance associated with the new domain, executing one or more tasks determined based on a comparison between the user utterance and the NLU ontology.

3. A method comprising, by an assistant system:
accessing one or more example dialogues between one or more users and the assistant system;
inputting the example dialogues to a language model to generate a user turn;
generating, responsive to the user turn by the assistant system, a system response;
adding the user turn and the system response to the example dialogues; and
determining, based on the example dialogues, one or more metrics regarding natural-language conversation for the assistant system.

4. A method comprising, by one or more computing systems:
accessing a plurality of utterances;
generating, based on a natural-language understanding (NLU) model, a plurality of embeddings for the plurality of utterances, respectively;
generating, based on one or more NLU rules, a plurality of intent or slot representations for the plurality of utterances, respectively; and
training a hybrid end-to-end model based on the plurality of embeddings, the plurality of intent or slot representation, dialog states associated with the plurality of utterances, and one or more dialog policies.

5. A method comprising, by a client system:
receiving, at the client system, a first speech input from a user;
determining, a stateful convolution model, that the first speech input comprises a wake-word, wherein the wake-word is associated with a function of activating an assistant system, wherein the determining comprises:
processing the first speech input at a first time-step based on a first sliding window by the stateful convolution model, wherein the processing generates a first hidden state corresponding to information associated with the first time-step, and
inputting the first hidden state and a second sliding window to the stateful convolution model for processing the first speech input at a second time-step;
receiving, at the client system, a second speech input from the user; and
presenting, by the client system, a response generated by the assistant system, wherein the response corresponds to the second speech input.
